(19) United States
(12) Patent Application Publication
(10) Pub. No.: US 2006/0166150 A1
(43) Pub. Date: Jul. 27, 2006

(54) Photothermographic material

(76) Inventors: Rie Sakuragi, Tokyo (JP); Osamu Ishige, Kawasaki-shi (JP); Kiyoshi Fukusaka, Tokyo (JP)

Correspondence Address: CANTOR COLBURN, LLP, 55 GRIFFIN ROAD SOUTH, BLOOMFIELD, CT, 06002, US

(21) Appl. No.: 11/334,090

(22) Filed: Jan. 18, 2006

(30) Foreign Application Priority Data
Jan. 24, 2005 (JP) JP2005-015259
Mar. 22, 2005 (JP) JP2005-081887

(51) Int. Cl. G03C 1/00

(52) U.S. Cl. 430/619

(57) ABSTRACT

A photothermographic materials, containing a support having thereon an image forming layer containing, light photosensitive silver halide grains; a binder; a reducing agent for silver ions represented by Formula (1); and a leuco dye represented by Formula (2):

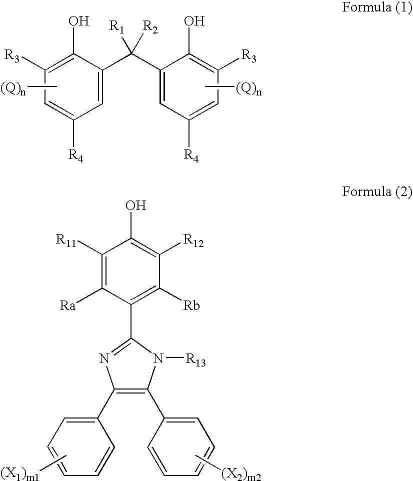

This application is based on Japanese Patent Application Nos. 2005-015259 filed on Jan. 24, 2005 and 2005-081887 filed on Mar. 22, 2005 both in Japanese Patent Office, the entire content of which is hereby incorporated by reference.

### TECHNICAL FIELD

The present invention relates to a photothermographic material and in more detail to a photothermographic material which exhibits high photographic speed, desirable silver tone, and excellent image retention property.

### BACKGROUND

In recent years, in medical and printing fields, highly demanded are photosensitive materials which result in no processing effluent from the aspect of environmental protection and workability. Well known as techniques to meet the above demand are methods described, for example, in U.S. Pat. Nos. 3,152,904 and 3,487,075, as well as Morgan, Dry Silver Photographic Materials (Handbook of Imaging Materials, Marcel Dekker, Inc. page 48, 1991). Since these photosensitive materials are developed at a temperature of at least 80° C., they are also called photothermographic materials.

Compared to conventional liquid-processed photosensitive materials, photothermographic materials incorporate many types of chemical substances in larger amounts, whereby the thickness of photosensitive layers and photo-insensitive layers tend to increase. Consequently, drawbacks have occurred in which much more time is needed for the coating process or the drying process during production of the above photosensitive materials, resulting in a decrease of productivity.

It is generally known that a decrease in silver amount is effective to decrease the thickness of a layer. However, a mere decrease in the silver amount is not preferred since it results in a decrease in image density. In order to maintain the image density even with a decreased silver amount, it is effective to enhance covering power by increasing the number of developing points per area. Heretofore, in photosensitive materials for printing, a technique has been established in which the covering power is enhanced employing “infectious development”, employing nucleating agents which result in high image density even at a decreased silver amount (refer to Patent Documents 1 and 2).

However, photosensitive materials incorporating prior art nucleating agents are not preferred due to the following reasons. Retention properties of most of them are insufficient, and specifically, in medical usage, they result in inferior diagnosis due to the fact that the tone of the resulting silver images is yellowish.

Photothermographic materials have been frequently employed for medial diagnosis due to their convenience. Since highly detailed images are required for medical diagnosis, high quality images exhibiting excellent sharpness and graininess are essential. In addition, in view of ease of diagnosis, it is characterized that blue-black tone images tend to be accepted. However, in a photothermographic image forming system, it has been difficult to achieve a pure black tone, and such tone is controlled employing toners. However, the resulting tone control is insufficient, whereby improvements are still being sought.

In order to overcome the above drawbacks, combinations of specified reducing agents and specified compounds are disclosed (refer to Patent Documents 3 and 4). However, it must be is mentioned that the resulting effects tend to be insufficient, and critical problems occur-such that during storage, density tends to vary, due to which further improvements have been sought.

(Patent Document 1) Japanese Patent Publication for Public Inspection (SEC Application) No. 10-512061

(Patent Document 2) Japanese Patent Publication for Public Inspection (SEC Application) No. 11-511571

(Patent Document 3) Japanese Patent Publication for Public Inspection (herein after referred to as JP-A) No. 2002-169249

(Patent Document 4) JP-A No. 2002-236334

### SUMMARY

In view of the above problems, the present invention was achieved. An object of the present invention is to provide a photothermographic material which results in high maximum density, minimal fog, desired blue-black silver tone, and excellent image stability during storage.

The object of the present invention was achieved employing the following embodiments.

(1) An aspect of the present invention includes an embodiment of a photothermographic materials,

comprising a support having thereon an image forming layer comprising:

light-insensitive organic silver salt grains;

photosensitive silver halide grains;

a binder;

a reducing agent for silver ions represented by Formula (1); and

a leuco dye represented by Formula (2):

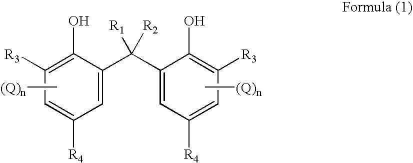

wherein R₁ and R₂ each respectively represents a hydrogen atom, an aliphatic group or an aryl group; R₃ and R₄ each respectively represents a hydrogen atom, an aliphatic group, an aryl group or a heterocylic group; Q represents a group capable of substituting a hydrogen atom on a benzene ring; and n represents an integer of 0 to 2, provided that when n is 2, a plurality of Q may be the same or different,

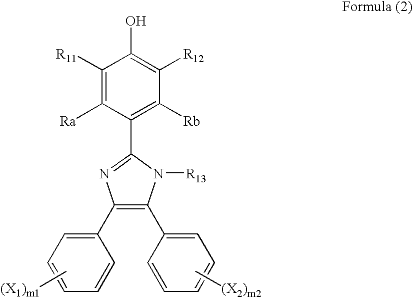

wherein R₁₁, R₁₂, Ra and Rb each respectively represents a hydrogen atom, an aliphatic group, an aryl group, an alkoxy group, an aryloxy group, an acylamino group, a sulfonamide group, a carbamoyl group or a hydrogen atom; R₁₃ represents a hydrogen atom, an aliphatic group, an aryl group, an acyl group, an alkoxycarbonyl group, an aryloxycarbonyl group, a carbamoyl group, a sulfamoyl group or a sulfonyl group; X₁ and X₂ each represents a group capable of substituting a hydrogen atom on a benzene ring; m1 and m2 each respectively represents an integer of 0 to 5, provided that when m1 or m2 is 2 or more, a plurality of X₁ or X₂ each respectively may be the same or different.
(2) Another aspect of the present invention includes a photothermographic materials of the above-described item 1, wherein the leuco dye represented by Formula (2) is further represented by Formula (3):

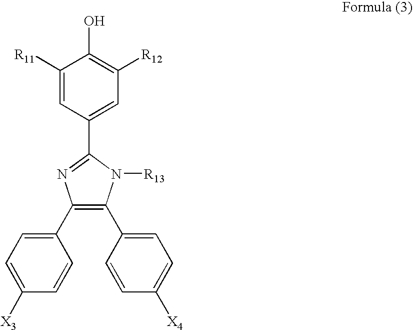

wherein X₃ and X₄ each respectively represents an aliphatic group, an aryl group, an amino group, an alkoxy group or an aryloxy group; and R₁₁, R₁₂ and R₁₃ each respectively represents the same as R₁₁, R₁₂ and R₁₃ in Formula (2).
(3). Another aspect of the present invention includes a photothermographic materials of the above-described item 1, wherein the leuco dye represented by Formula (2) is further represented by Formula (4):

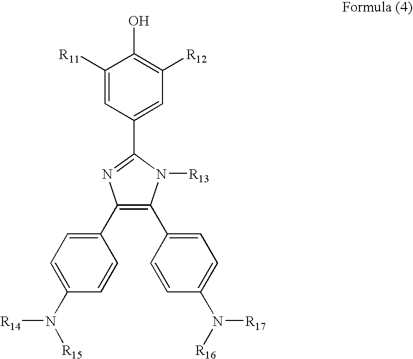

wherein R₁₄, R₁₅, R₁₆ and R₁₇ each respectively represents a hydrogen atom, an alkyl group; and R₁₂ and R₁₃ each respectively represents the same as R₁₁, R₁₂ and R₁₃ in Formula (2).

(4) Another aspect of the present invention includes a photothermographic materials of the above-described item 1, wherein R₁₁ and R₁₂ in Formula (2) each respectively represents an aliphatic group or an alkoxy group.

(5) Another aspect of the present invention includes a photothermographic materials of the above-described items 1 to 4, wherein a molar ratio of the leuco dye represented by Formulas (2) (3) or (4) to the reducing agent represented by Formula (1) is between 0.001:1 and 0.15:1.

(6) Another aspect of the present invention includes a photothermographic materials of the above-described item 5, wherein a molar ratio of the leuco dye represented by Formula (2) to the reducing agent represented by Formula (1) is between 0.005:1 and 0.1:1.

(7) Another aspect of the present invention includes a photothermographic materials of the above-described items 1 to 6, wherein R₃ in Formula (1) represents a secondary alkyl group or a tertiary alkyl group.

(8) Another aspect of the present invention includes a photothermographic materials of the above-described items 1 to 6, wherein R₄ in Formula (1) represents an alkyl group of 2 or more carbon atoms.

(9) Another aspect of the present invention includes a photothermographic materials of the above-described items 1 to 8, wherein the photosensitive silver halide grains contain silver iodide in an amount of 5 to 100 mol %.

(10) Another aspect of the present invention includes a photothermographic materials of the above-described items 1 to 9, wherein the light-insensitive organic silver salt grains contain silver behenate in an amount of not less than 70 to less than 100 weight % based on the total weight of the light-insensitive organic silver salt grains.

According to the present invention, it is possible to output images suitable for diagnosis, which exhibit minimal degradation of maximum density and fogging due to light and heat during storage, exhibit blue-black image tone, and exhibit minimal degradation of image tone due to light and heat.

### DESCRIPTION OF THE PREFERRED EMBODIMENTS

The present invention will now be detailed below.

In the present invention, at least one type of silver ion reducing agent is the compound represented by Formula (1), which are specified bisphenol derivatives. The above silver ion reducing agents, which are employed individually or in combination of reducing agents having different chemical structures and the compounds represented by Formula (2) are simultaneously employed. By doing so, the resulting image tone is the preferred blue-black one, and it is possible to unexpectedly retard tone degradation during storage of silver images after development. Further, it is possible to result in surprising effects, such that it is possible to produce images which exhibit excellent processing variation resistance.

Firstly, the compounds represented by Formula (1) will be described.

In above Formula (1), R₁ and R₂ each represent a hydrogen atom, and an aliphatic or aromatic group. “Aliphatic group”, as described in the present invention, refers to an alkyl group, a cycloalkyl group, an alkenyl group, a cycloalkenyl group, an alkynyl group, or an aralkyl group, each of which may be substituted or unsubstituted.

Specific examples of the above aliphatic groups include a methyl, ethyl, propyl, i-propyl, butyl, t-butyl, pentyl, hexyl, decyl, dodecyl or pentadecyl group, a vinyl group, an allyl, ethynyl, propagyl, cyclopropyl, cyclobutyl, cyclobutenyl, cyclopentyl, cyclopentenyl, cyclopentadienyl, cyclohexyl, cyclohexenyl, cyclohexadienyl, cycloheptyl, cycloheptinyl, cycloheptadienyl, cyclooctanyl, cyclooctenyl, cyclooctadienyl, cyclooctatrienyl, cyclonanyl, cyclononenyl, or cyclonadienyl group, as well as a cyclonanotrienylcyclodecanyl, cyclodecanyl, cyclodecadienyl, or cyclodecatrienyl group. These groups may have a substituent at any position. Specific examples of the above substituents include an alkyl group, a halogenated alkyl group, a halogen atom, a cyano group, an alkoxy group, a hydroxyl group, an amino group, a carboxyl group, an aryl group, a heterocyclyl group, an aryloxy group, an acyloxy group, a carbamoyloxy group, an alkoxycarbonyloxy group, and an aryloxycarbonyloxy group.

The aromatic group may be in the form of a single ring or a condensed ring, examples of which include a phenyl, naphthyl, anthracenyl, phenantolenyl, naphthacenyl, or triphenylenyl group. These rings may have various substituents at any position. Listed as preferred substituents are a straight or branched alkyl group (being preferably methyl, ethyl, i-propyl or dodecyl, having 1-20 carbon atoms), an alkoxy group (being preferably methoxy, ethoxy, propoxy, i-propoxy, or dodecyloxy, having 1-20 carbon atoms), and an aliphatic acylamino group (being preferably those having 1-21 carbon atoms, such as acetylamino or heptylamino), and an aromatic acylamino group.

R₁ is preferably a substituted or unsubstituted alkyl group having 1-20 carbon atoms, is more preferably a substituted or unsubstituted alkyl group having 1-10 carbon atoms, but is still more preferably methyl, ethyl, i-propyl, or cyclohexyl. R₂ is preferably a hydrogen atom.

R₃ and R₄ each represent a hydrogen atom, an aliphatic group, an aromatic group, or a heterocyclic ring group. Specific examples of aliphatic and aromatic groups represented by R₃ and R₄ include the same aliphatic and aromatic groups as those represented by above R₁ and R₂.

Specific examples of the heterocyclyl groups represented by R₃ and R₄ include aromatic heterocyclyl groups such as piridyl, quinolyl, isoquinolyl, imidazolyl, pyrazolyl, triazolyl, oxazolyl, thiazolyl, oxadiazolyl, thiadiazolyl, or tetrazolyl, as well as non-aromatic heterocyclyl groups such as piperidinyl, morpholynyl, tetrahydrofuryl, tetrahydrothienyl, or tetrahydropyranyl. These groups may further have a substituent, and listed as such substituents may be those on the ring, which were previously described.

R₃ is preferably an alkyl group, or a cycloalkyl group, but is more preferably a secondary or tertiary alkyl or cycloalkyl group. R₄ is preferably an alkyl group, but is more preferably an alkyl group having at least two carbon atoms.

Q represents a group capable of being substituted on a benzene ring, and specific examples include an alkyl group having 1-25 carbon atoms (such as methyl, ethyl, propyl, i-propyl, t-butyl, pentyl, hexyl, or cyclohexyl), a halogenated alkyl group (such as trifluoromethyl or perfluoromethyl), a cycloalkyl group (such as cyclohexyl or cyclopentyl), an alkynyl group (such as propagyl), a glycidyl group, an acrylate group, a methacrylate group, an aryl group (such as phenyl), a heterocyclyl group (such as pyridyl, thiazolyl, oxazolyl, imidazolyl, furyl, pyrrolyl, piradinyl, pyrimidinyl, pyridadinyl, selenazolyl, sulforanyl, piperidinyl, pyrazolyl, or tetrazolyl), a halogen atom (such as chlorine, bromine, iodine, or fluorine), an alkoxy group (such as methoxy, ethoxy, propoxy, pentyloxy, cyclopentyloxy, hexyloxy, or cyclohexyloxy), an aryloxy group (such as phenoxy), an alkoxycarbonyl group (such as methyloxycarbonyl, ethyloxycarbonyl, or butyloxycarbonyl), an aryloxycarbonyl group (such as a phenyloxycarbonyl group), a sulfonamido group (such as methanesulfonamido, ethanesulfonamido, butanesulfonamido, hexanesulfonamido, cyclohexanesulfonamido, or benzenesulfonamido), a sulfamoyl group (such as aminosulfonyl, methylaminosulfonyl, dimethylaminosulfonyl, butylaminosulfonyl, hexylaminosulfonyl, cyclohexylaminosulfonyl, phenylaminosulfonyl, or 2-pyridylaminosulfonyl), an urethane group (such as methylureido, ethylureido, pentylureido, cyclohexylureido, phenylureido, or 2-pyridylureido), an acyl group (such as acetyl, propionyl, butanoyl, hexanoyl, cyclohexanoyl, benzoyl, or pyridinoyl), a carbamoyl group (such as aminocarbonyl, methylaminocarbonyl, dimethylaminocarbonyl, propylaminocarbonyl, pentylaminocarbonyl, cyclohexylaminocarbonyl, phenylaminocarbonyl, or 2-pyridylaminocarbonyl), an amido group (such as acetoamido, propionamido, butaneamido, hexaneamido, or benzamido), a sulfonyl group (such as methylsulfonyl, ethylsulfonyl, butylsulfonyl, cyclohexylsulfonyl, phenylsulfonyl, or 2-pyridylsulfonyl), a sulfonamido group (such as methylsulfonamido, octylsulfonamido, phenylsulfonamido, or naphthylsulfonamido), an amino group (such as amino, ethylamino, dimethylamino, butylamino, cyclopentylamino, anilino, or 2-pyridinylamino), a cyano group, a nitro group, a sulfo group, a carboxyl group, a hydroxyl group, and an oxamoyl group. Further, these groups may be substituted with these groups.

“n” represents an integer of 0-2. The most preferred case is one in which n is 0. When a plurality of Qs is present, each Q may be the same or different.

It is possible to synthesize the silver ion reducing agents (also called reducing agents of the present invention), represented by Formula (1), employing various methods. A representative scheme is shown below.

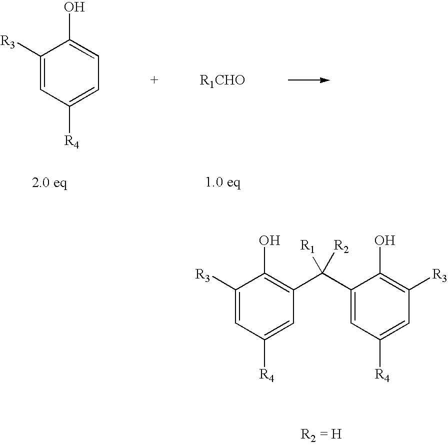

Two-equivalent phenol (in the above scheme, R₁, R₃, and R₄ are as defined for R₁, R₃, and R₄ in Formula (1), and the case is shown in which R₂ represents H) and one-equivalent aldehyde are dissolved or dispersed in the absence of solvents or in the presence of organic solvents. Subsequently, acids or alkalis in a catalyst amount are added and the resulting mixture undergoes reaction preferably at a temperature of −20-180° C. for 40 minutes-60 hours, whereby it is possible to achieve the preferred yield.

Preferred as the above organic solvents are hydrocarbon based organic solvents. Specifically listed are benzene, toluene, xylene, dichloromethane, and chloroform. Of these, preferred are toluene and xylene. Further, in terms of yield, it is most preferable that the reaction is performed in the absence of solvents. Employed as the acid catalysts may be any of inorganic or organic acids, and concentrated hydrochloric acid, p-toluenesulfonic acid, and phosphoric acid are preferably employed. Preferably employed as the alkali catalysts are sodium hydroxide, potassium hydroxide, triethylamine, DBU (1,8-diazabicyclo[5.4.0]undeca-7-ene), and sodium methylate. The amount of employed catalysts is preferably 0.0001-1.5 equivalents with respect to the corresponding aldehyde. The reaction temperature is preferably 15-150° C., and the reaction time is preferably 3-20 hours.

Specific representative examples of the reducing agents of the present invention will now be described below, however the present invention is not limited thereto.

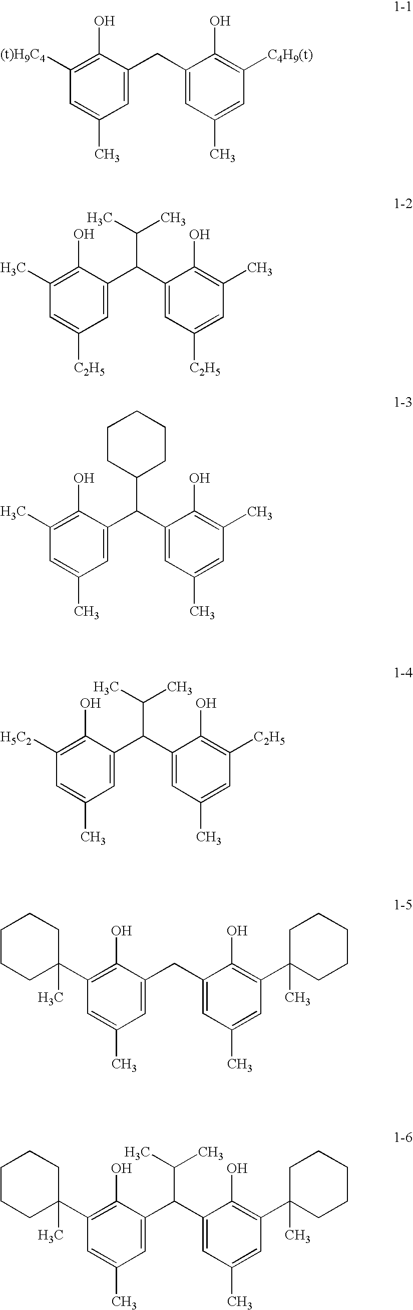

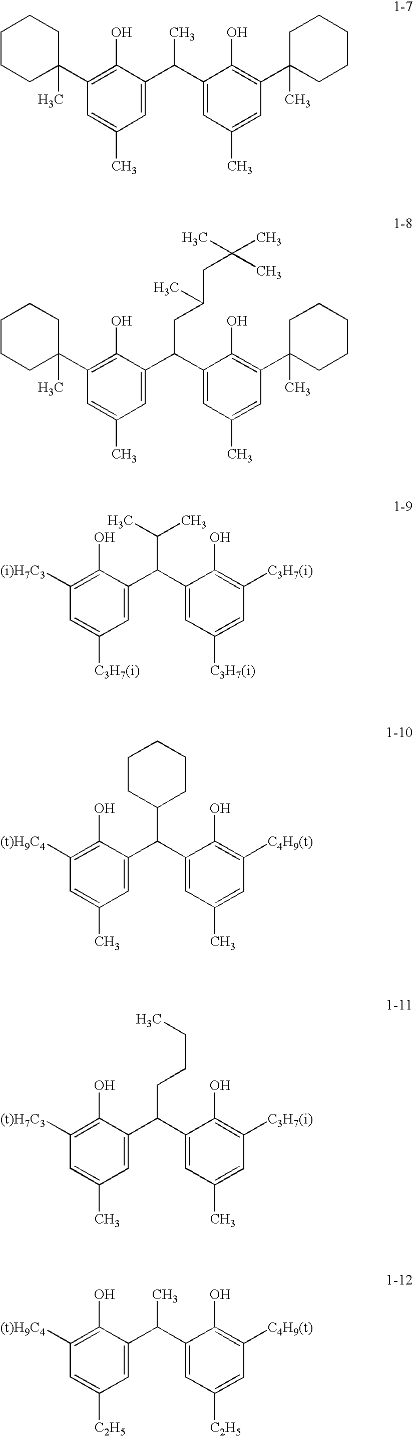

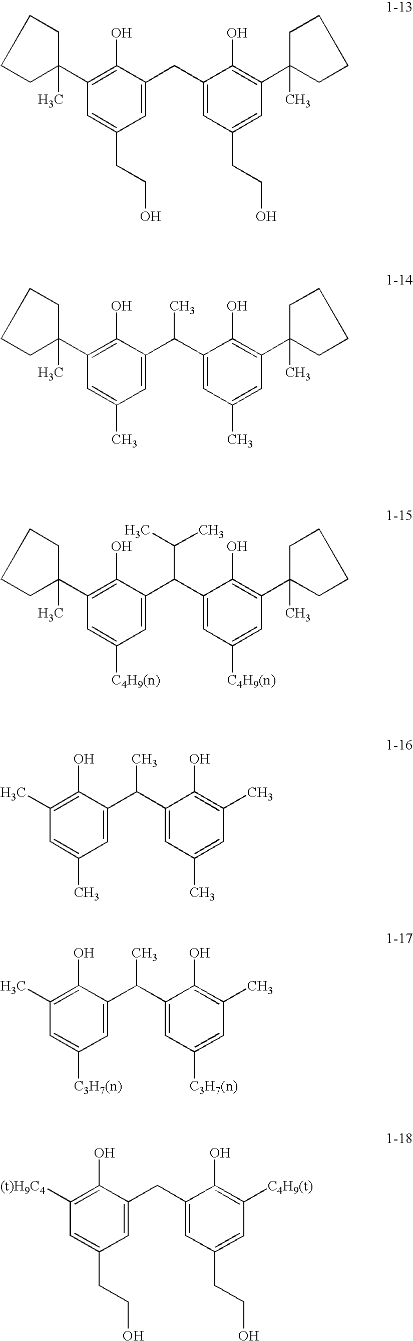

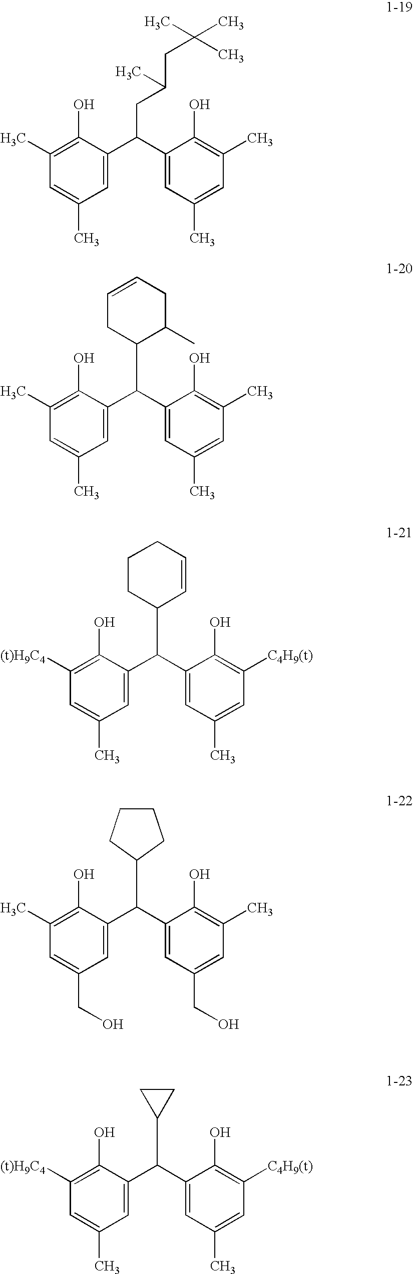

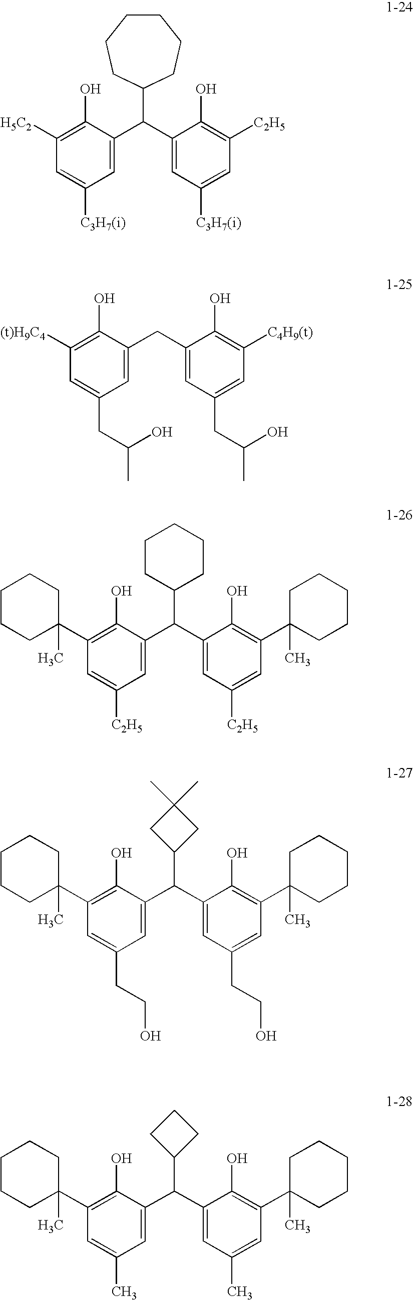

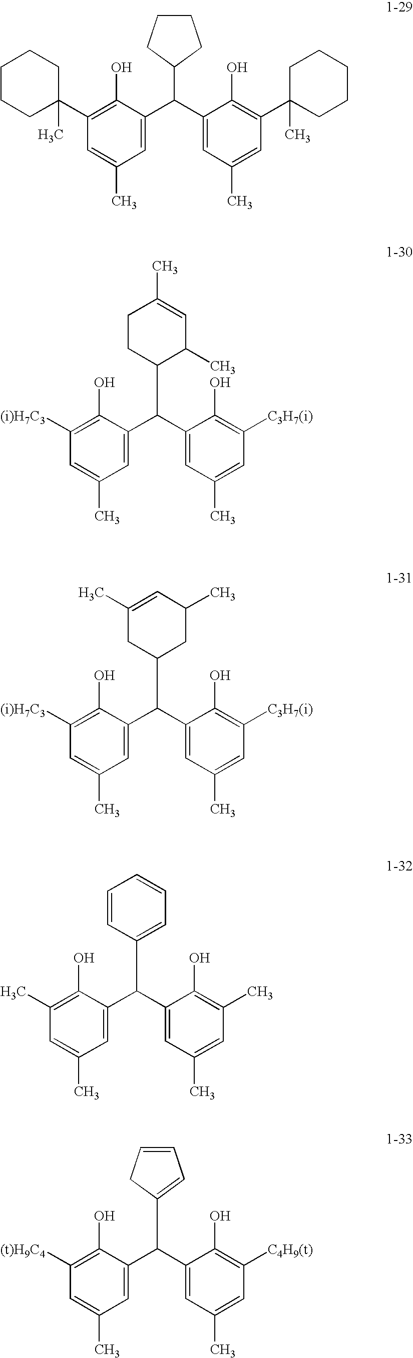

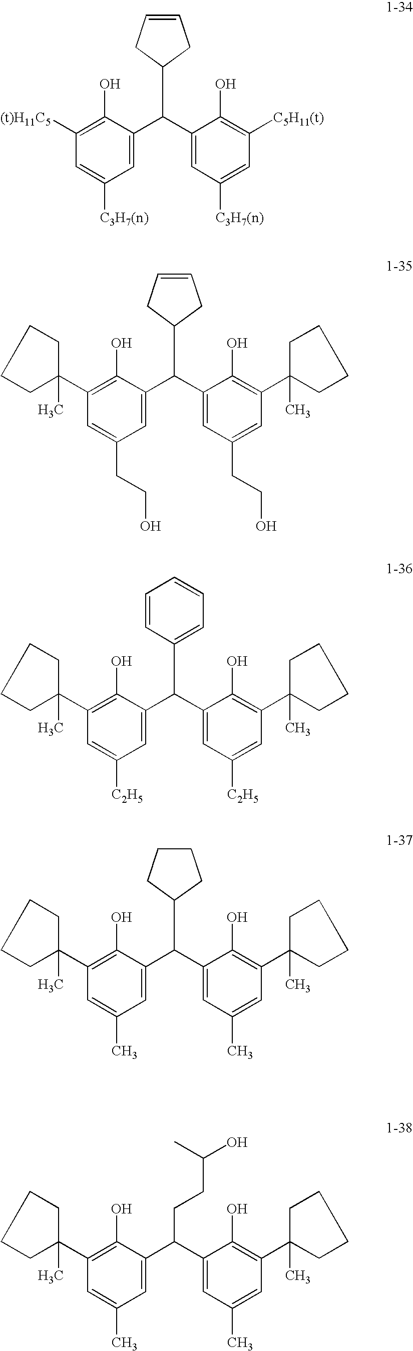

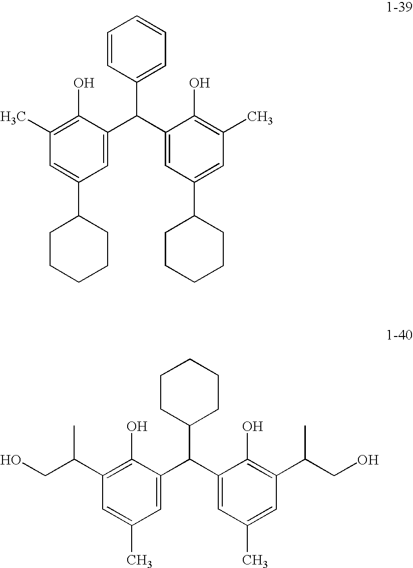

The compounds (leuco dyes) represented by Formula (2) will now be detailed.

In Formula (2), R₁₁, R₁₂, Ra, and Rb each represents a hydrogen atom, an aliphatic group, an aromatic group, an alkoxy group, an aryloxy group, an acylamino group, a sulfonamido group, a carbamoyl group, or a halogen atom. R₁₃ represents a hydrogen atom, an aliphatic group, an aromatic group, an acyl group, an alkoxycarbonyl group, an aryloxycarboxynyl group, a carbamoyl group, a sulfamoyl group or a sulfonyl group. X₁ and X₂ each represent a group capable of being substituted on a benzene ring, and m₁ and m₂ each represents an integer of 0-5. In cases in which a plurality of X₁s or X₂s is present, X₁ and X₂ may be the same or different.

Listed as specific examples of aliphatic and aromatic groups represented by R₁₁, R₁₂, Ra and Rb are the groups which are listed as examples of aliphatic and aromatic groups represented by R₁ and R₂ in above Formula (1).

Listed as the specific examples of the alkoxy group represented by R₁₁, R₁₂, Ra, and Rb are a methoxy group, an ethoxy group, an i-propoxy group and a t-butoxy group. Listed as the specific examples of the aryloxy group are a phenoxy group and a naphthyloxy group. Cited as the acylamino group are an acetylamino group and benzoylamino group. Noted as the specific examples of the sulfonamido group are methanesulfonamido group, a butanesulfonamido group, an octanesulfonamido group, and a benzenesulfonamido group. Listed as the carbamoyl group are an aminocarbonyl group, a methylaminocarbonyl group, dimethylaminocarbonyl group, a propylaminocarbonyl group, a pentylaminocarbonyl group, a cyclohexylaminocarbonyl group, a phenylaminocarbonyl group, and a 2-pyridylaminocarbonyl group. Further, the halogen atoms represented by R₁₁, R₁₂, Ra and Rb include chlorine, bromine and iodine.

Each of R₁₁ and R₁₂ is preferably an aliphatic group, an alkoxy group, or a aryloxy group, is more preferably an alkyl group, or an alkoxy group, but is more preferably a secondary or tertiary alkyl group, or an alkoxy group. Each of Ra and Rb is preferably a hydrogen atom or an aliphatic group, but is more preferably a hydrogen atom.

Listed examples of the aliphatic group, aromatic group, alkoxy group, and aryloxy group are the groups listed as specific examples of the aliphatic group, aromatic group, alkoxy group, and aryloxy groups represented by R₁ and R₂ of above Formula (1).

Listed as specific examples of the acyl group represented by R₁₃ are an acetyl group, a propionyl group, a butanoyl group, a hexanoyl group, a cyclohexanoyl group, a benzoyl group, and a pyridinoyl group. Listed as specific examples of the alkoxycarbonyl group are a methoxycarbonyl group, an ethoxycarbonyl group, and a t-butoxycarbonyl group. Cited as specific examples of the aryloxycarboxynyl group are a phenoxycarbonyl group and the like. Noted as the carbamoyl group are an aminocarbonyl group, a methbylaminocarbonyl group, a dimethylaminocarbonyl group, a propylaminocarbonyl group, a pentylaminocarbonyl group, a cyclohexylaminocarbonyl group, a phenylaminocarbonyl group, and a 2-pyridylaminocarbonyl group. Listed as the sulfamoyl group are a methylsulfamoyl group, a dimethylsulfamoyl group, and a phenylsulfamoyl group. Listed as the sulfonyl group are methylsulfonyl group, a butylsulfonyl group, and an octylsulfonyl group.

R₁₃ is preferably a hydrogen atom, an alkyl group, or an acyl group, but is more preferably a hydrogen atom, an alkyl group having 1-10 carbon atoms, or an acyl group.

Specifically listed as the groups represented by X₁ and X₂, capable of being substituted on a benzene ring, are an alkyl group having 1-25 carbon atoms (such as methyl, ethyl, propyl, i-propyl, t-butyl, pentyl, hexyl, or cyclohexyl), a cycloalkyl group (such as cyclohexyl or cyclopentyl), an alkynyl group (such as propagyl), a glycidyl group, an acrylate group, a methacrylate group, an aryl group (such as phenyl), a heterocyclyl group (such as pyridyl, thiazolyl, oxazolyl, imidazolyl, furyl, pyrrolyl, piradinyl, pyrimidinyl, pyridadinyl, selenazolyl, sulforanyl, piperidinyl, pyrazolyl, or tetrazolyl), a halogen atom (such as chlorine, bromine, iodine, or fluorine), an alkoxy group (such as a methoxy group, an ethoxy group, a propyloxy group, a pentyloxy group, a cyclopentyloxy group, a hexyloxy group, or a cyclohexyloxy group), an aryloxy group (such as a phenoxy group), an alkoxycarbonyl group (such as methyloxycarbonyl, ethyloxycarbonyl, or butyloxycarbonyl), an aryloxycarbonyl group (such as a phenyloxycarbonyl group), a sulfonamido group (such as methanesulfonamido, ethanesulfonamido, butanesulfonamido, hexanesulfonamido, cyclohexanesulfonamido, or benzenesulfonamido), a sulfamoyl group (aminosulfonyl, methylaminosulfonyl, dimethylaminosulfonyl, butylaminosulfonyl, hexylaminosulfonyl, cyclohexylaminosulfonyl, phenylaminosulfonyl, or 2-pyridylaminosulfonyl), a urethane group (such as methylureido, ethylureido, pentylureido, cyclohexylureido, phenylureido, or 2-pyridylureido), an acyl group (such as acetyl, propionyl, butanoyl, hexanoyl, cyclohexanoyl, benzoyl, or pyridinoyl), a carbamoyl group (such as aminocarbonyl, methylaminocarbonyl, dimethylaminocarbonyl, propylaminocarbonyl, pentylaminocarbonyl, cyclohexylaminocarbonyl, phenylaminocarbonyl, or 2-pyridylaminocarbonyl), an amido group (such as acetoamido, propionamido, butaneamido, hexaneamido, or benzamido), a sulfonyl group (such as methylsulfonyl, ethylsulfonyl, butylsulfonyl, cyclohexylsulfonyl, phenylsulfonyl, or 2-pyridylsulfonyl), an amino group (such as amino, ethylamino, dimethylamino, butylamino, cyclopentylamino, anilino, or 2-pyridinylamino), a cyano group, a nitro group, a sulfo group, a carboxyl group, a hydroxyl group, and an oxamoyl group. Further, these groups may be substituted with these groups.

Each of X₁ and X₂ is preferably an alkoxy group, an aryloxy group, a carbamoyl group, an amido group, a sulfonamido group, or an amino group, but is more preferably an alkoxy group, an amino group, while m1 and m2 each represent an integer of 0-4, both being preferably 1-3, but more preferably 1.

In above Formula (3), X₃ and X₄ each represent an aliphatic group, an aromatic group, an amino group, an alkoxy group, or an aryloxy group. R₁₁, R₁₂, and R₁₃ each are as defined for R₁₁, R₁₂, and R₁₃ in above Forum (2).

Listed as examples of the aliphatic group, aromatic group, amino group, alkoxy group, and aryloxy group, represented by X₃ and X₄, are the same as the specific examples of the aliphatic group, aromatic group, amino group, alkoxy group, and aryloxy group represented by X₁ and X₂ of above Formula (2). Each of X₃ and X₄ is preferably an alkoxy group, an aryloxy group, or an amino group, but is more preferably an alkoxy group or an amino group.

Formula (4), R₁₁, R₁₂, and R₁₃ each are as defined for R₁₁, R₁₂, and R₁₃ in above Formula (2). R₁₄, R₁₅, R₁₆, and R₁₇ each represent a hydrogen atom or an alkyl group.

Listed as specific examples of the alkyl group represented by R₁₄, R₁₅, R₁₆, and R₁₇ are a methyl group, an ethyl group, a propyl group, an i-propyl group, a t-butyl group, a pentyl group, and a hexyl group. These groups may have substituent(s) at any position. Listed as examples of the substituents are the groups which are listed as the examples of substituents represented by Q in above Formula (1). Each of R₁₄, R₁₅, R₁₆, and R₁₇ is preferably an alkyl group having 1-10 carbon atoms, but is more preferably a methyl or ethyl group.

It is easy to synthesize the compounds represented by Formulas (2)-(4), employing prior art methods such as the one described, for example, in Japanese Patent Publication 7-45477. Specific examples of leuco dyes represented by Formula (2) will now be shown below, but the present invention is not limited thereto.

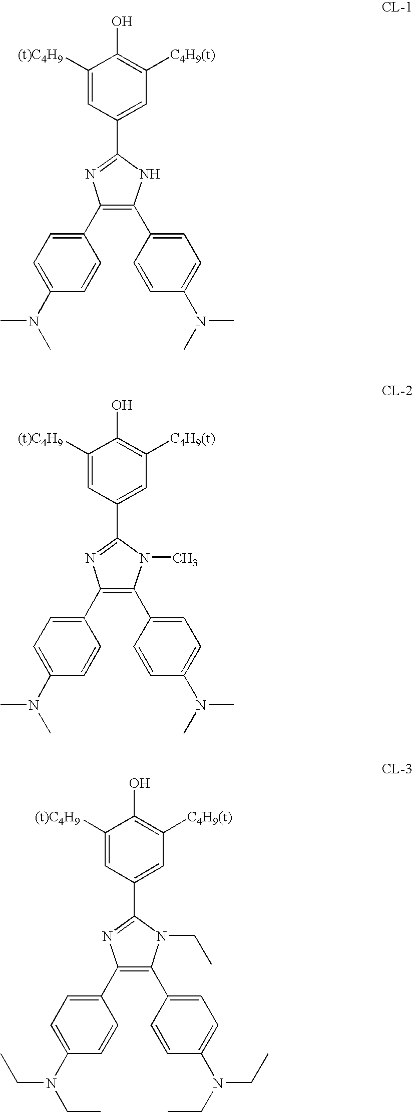

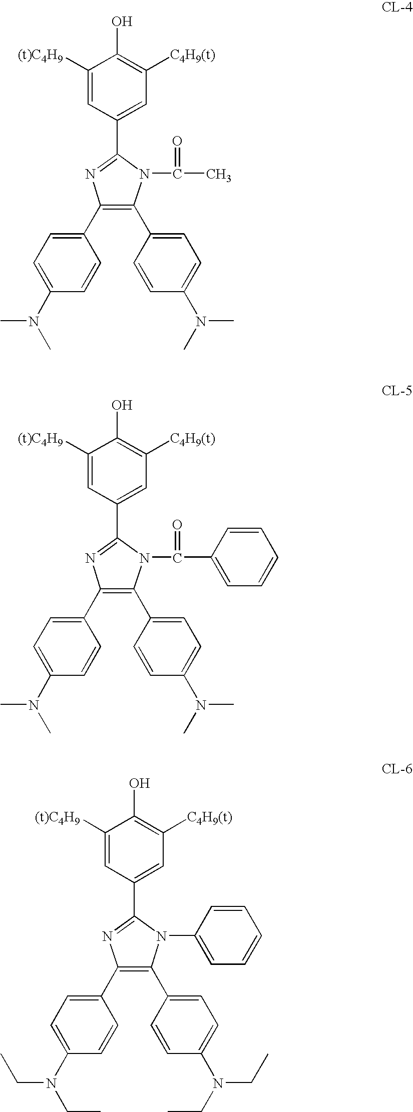

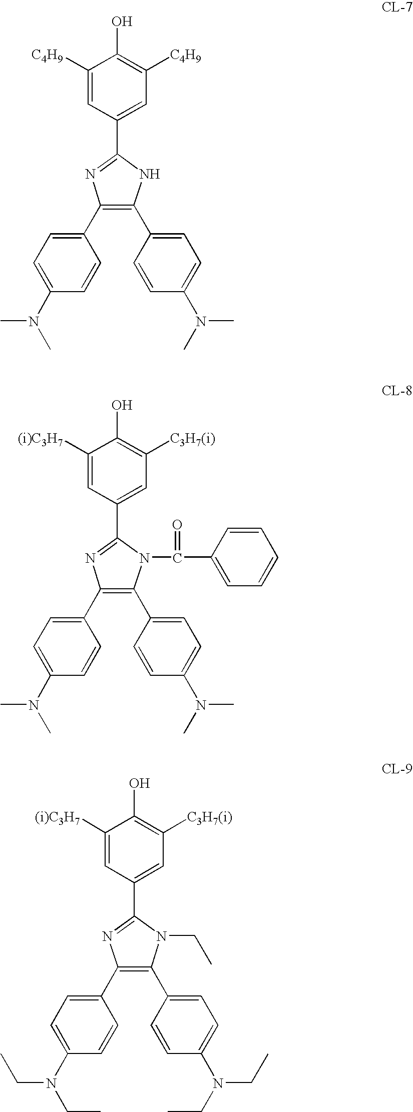

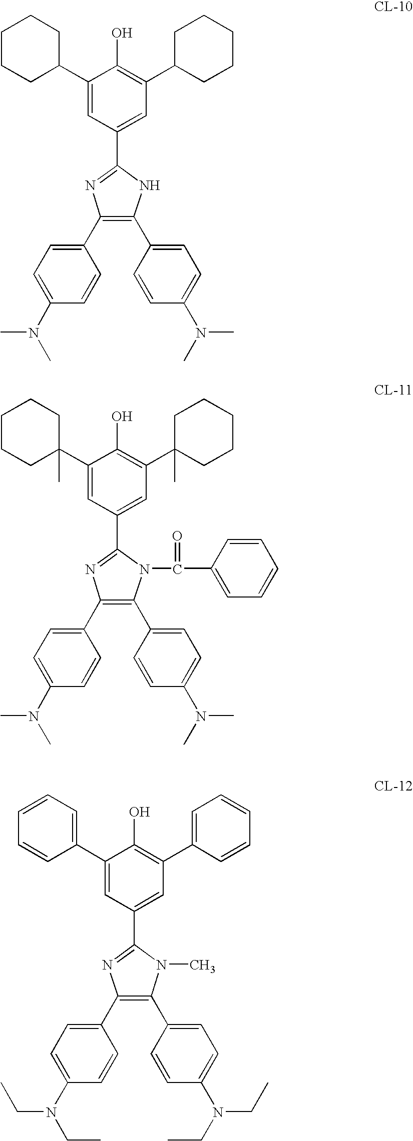

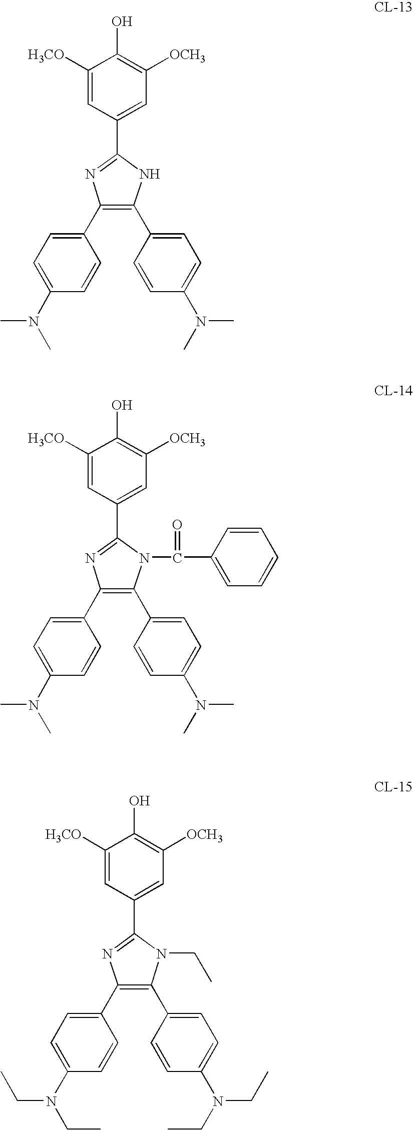

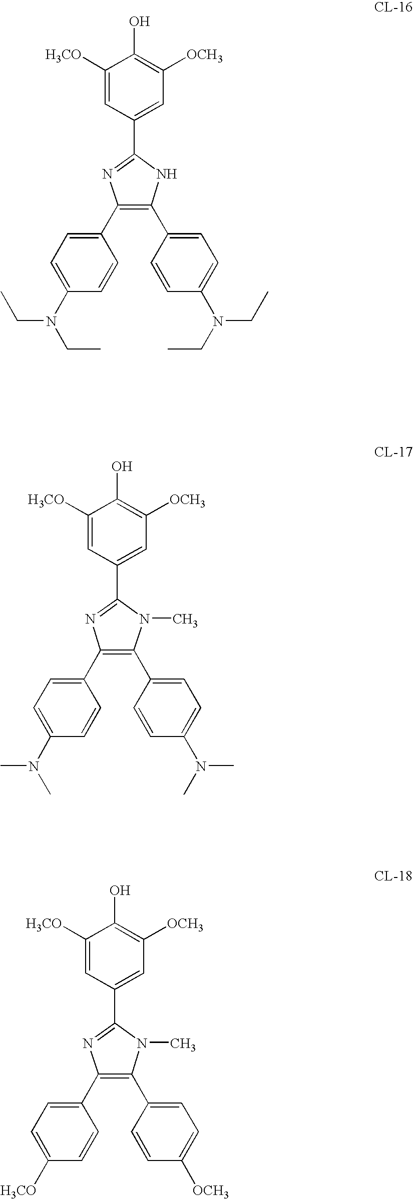

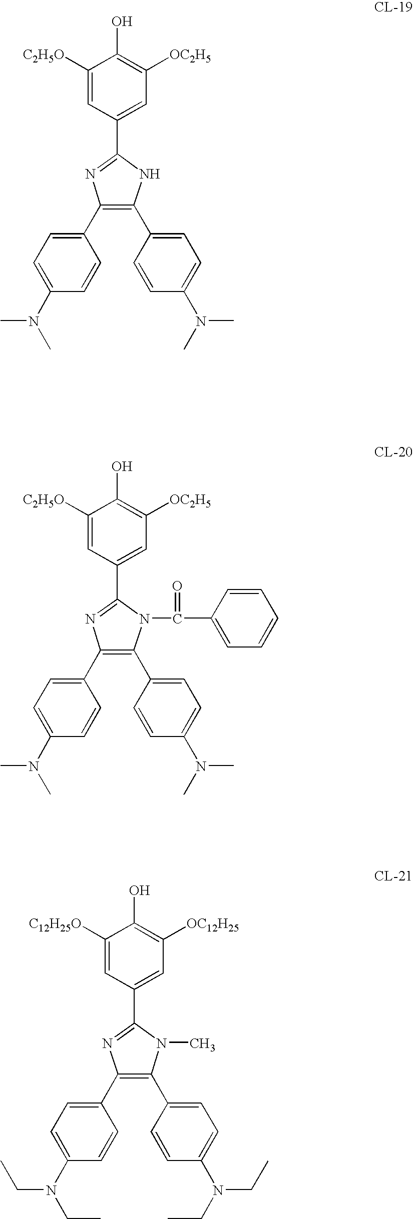

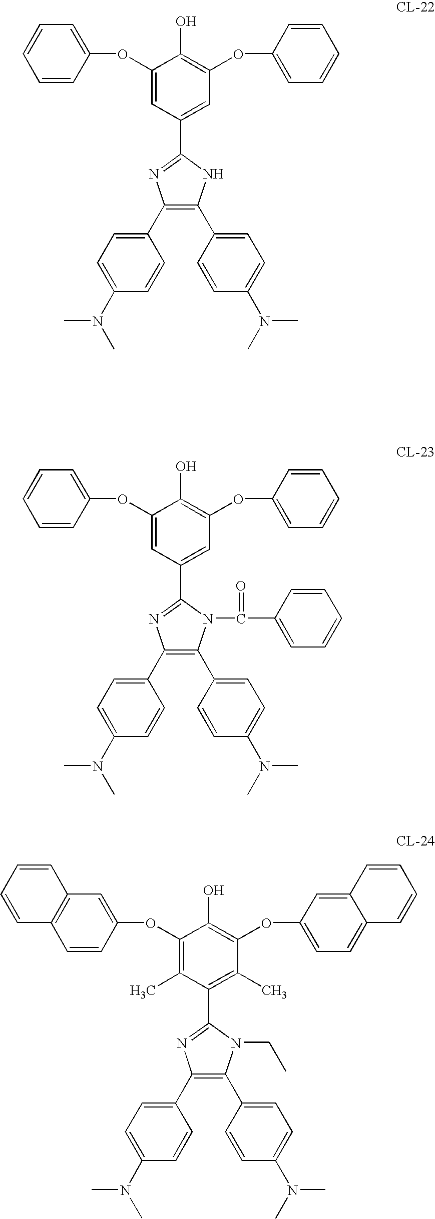

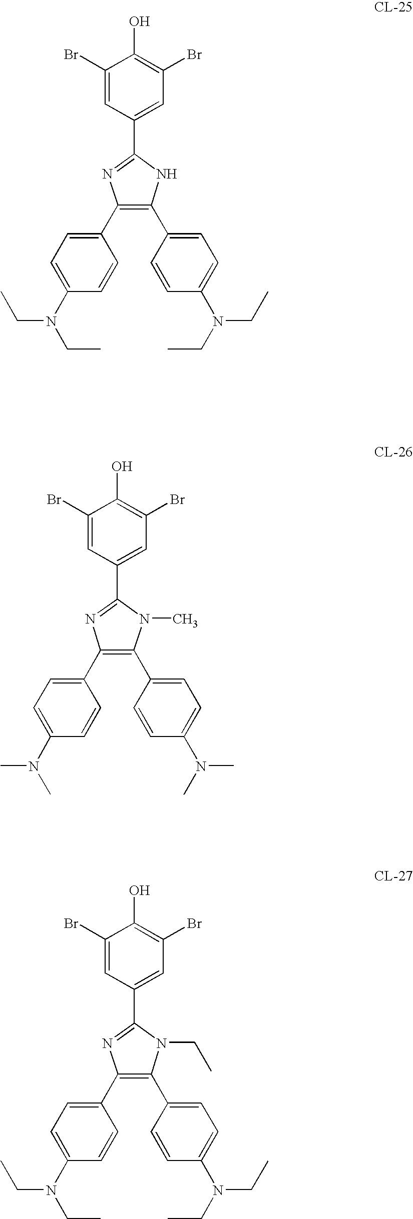

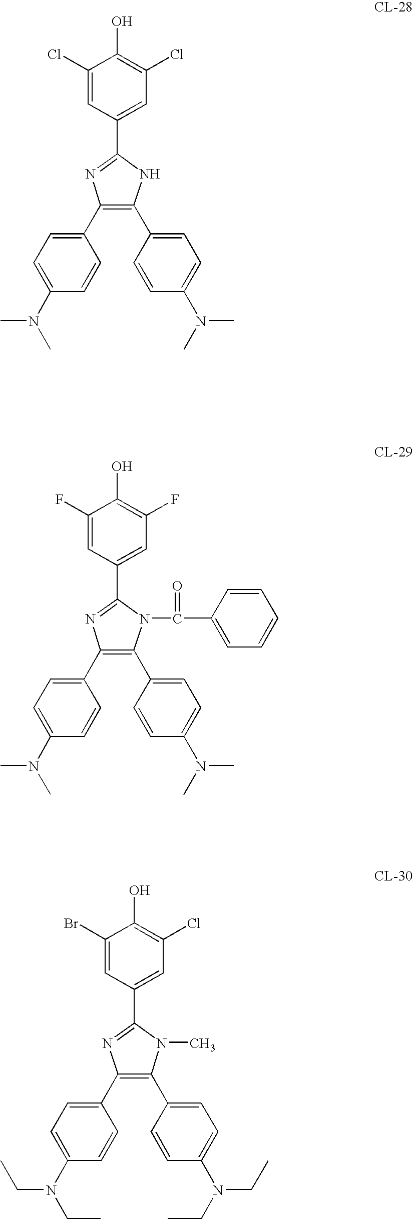

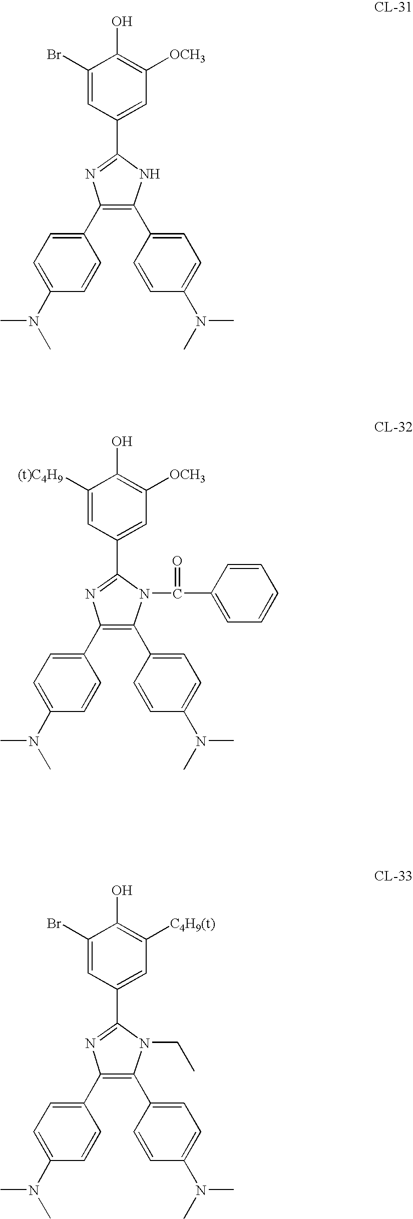

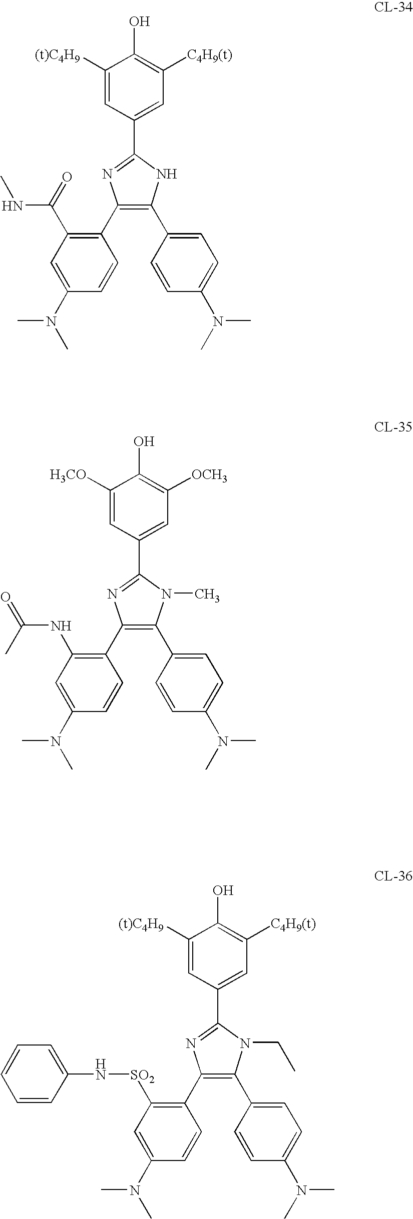

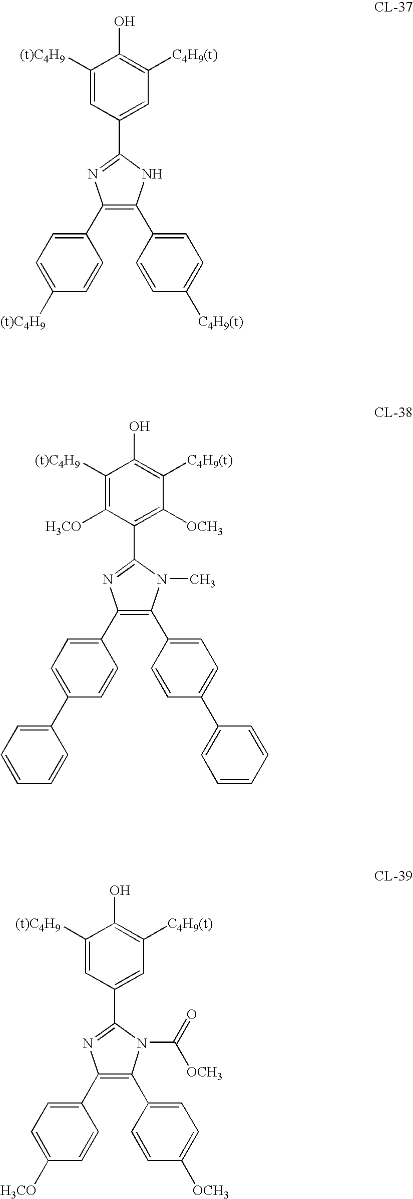

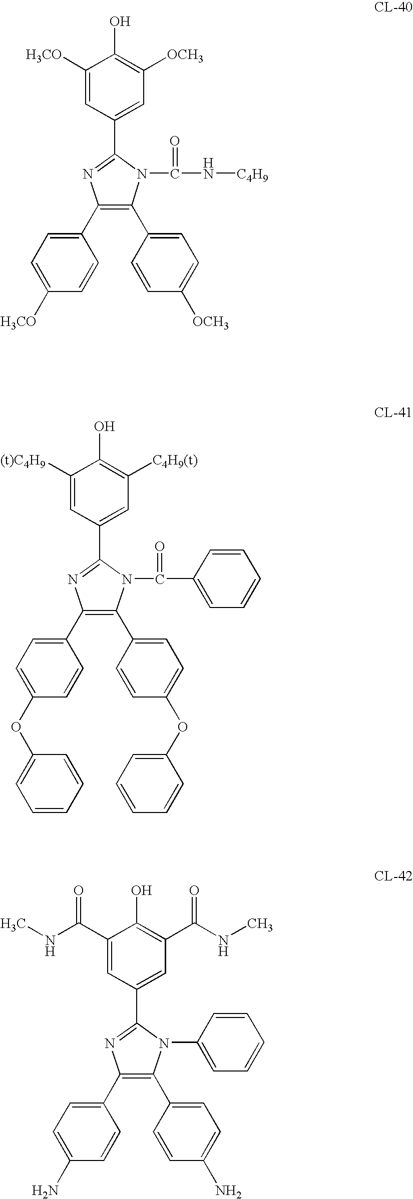

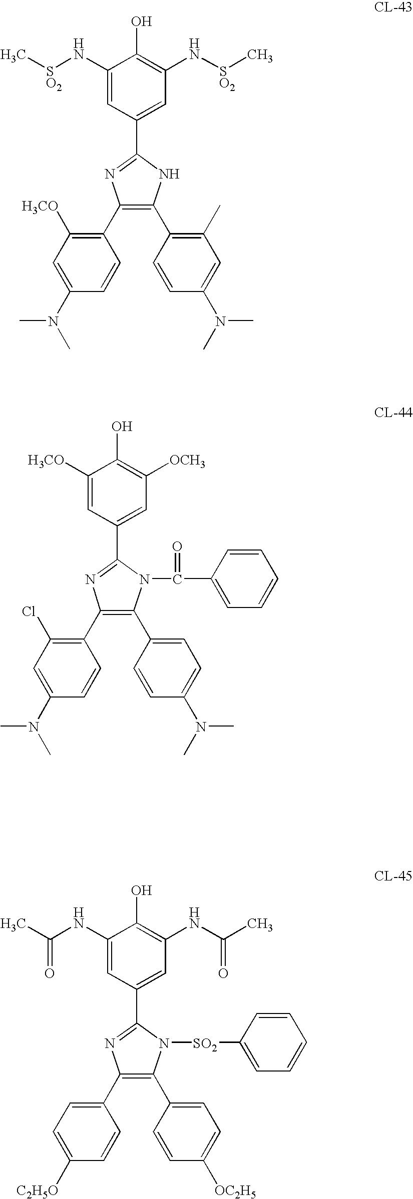

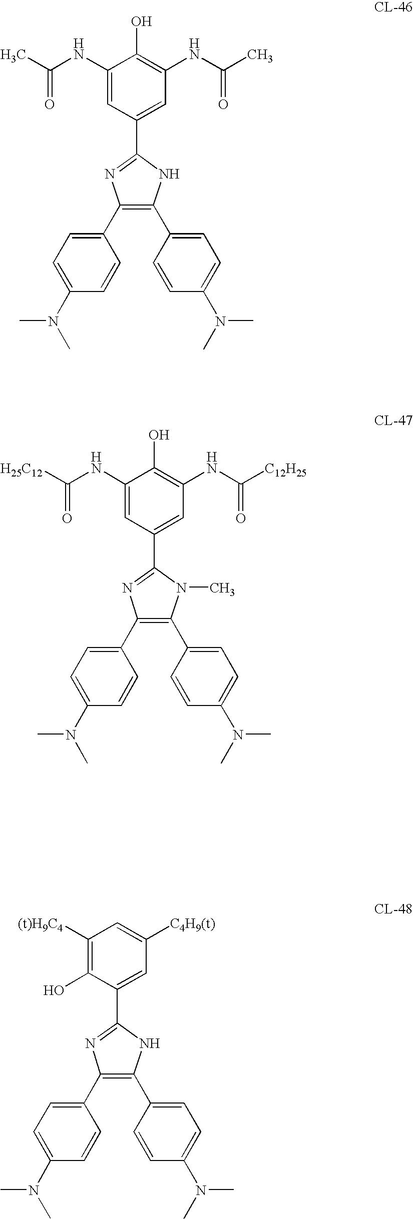

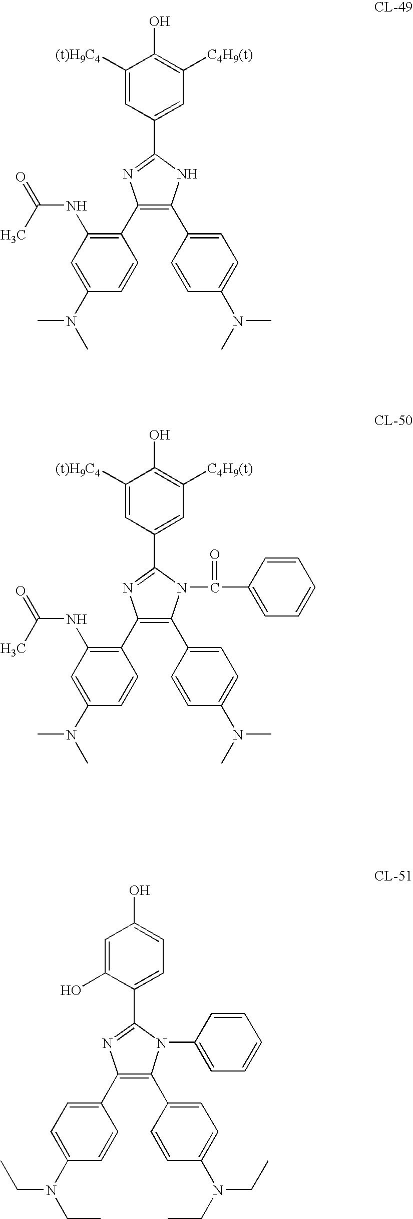

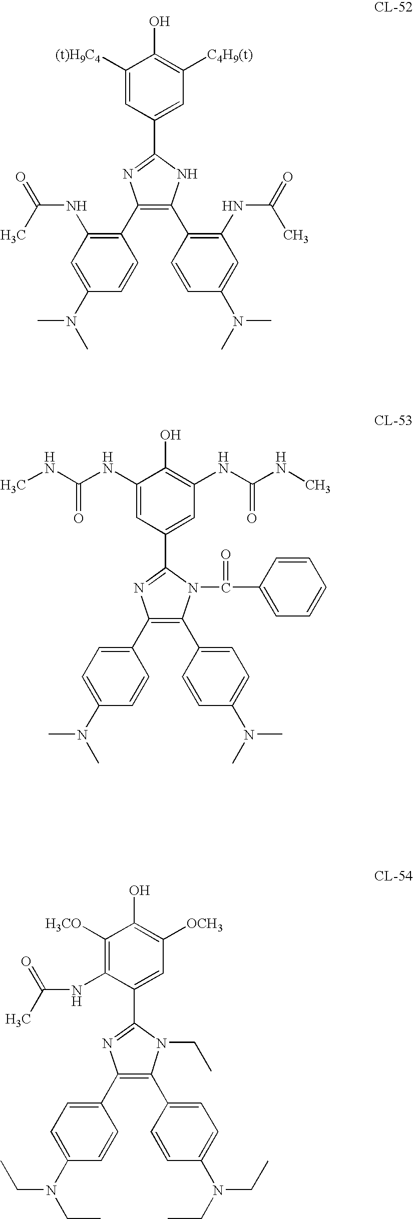

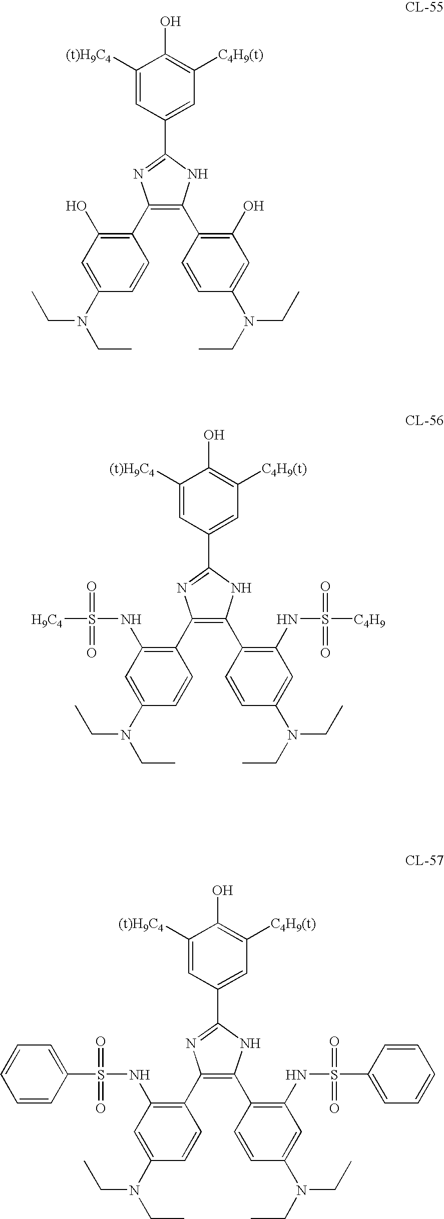

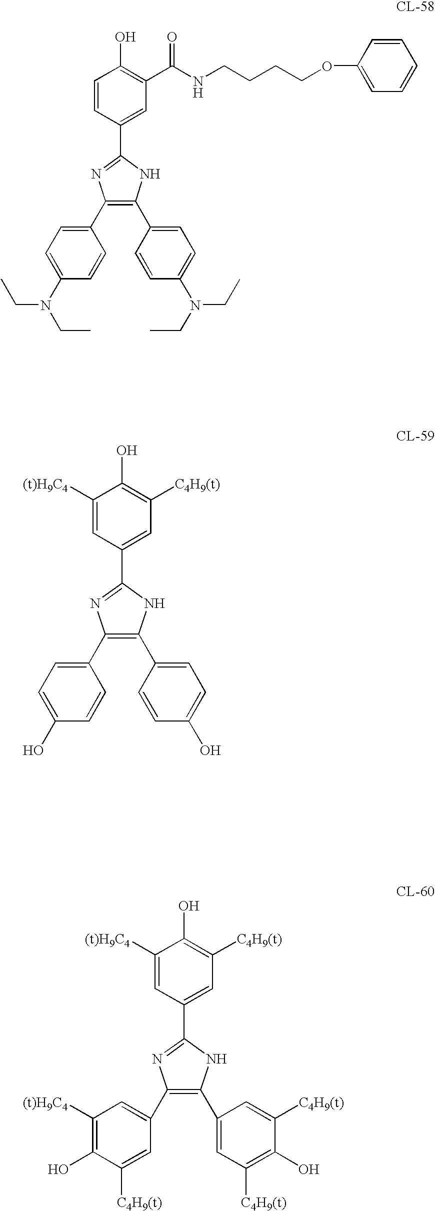

The photosensitive silver halide grains, as described in the present invention, refer to silver halide crystalline grains which can originally absorb light as an inherent quality of silver halide crystals, can absorb visible light or infrared radiation through artificial physicochemical methods and are treatment-produced so that physicochemical changes occur in the interior of the silver halide crystal and/or on the crystal surface, when the crystals absorb any radiation from ultraviolet to infrared.

Silver halide grains employed in the present invention can be prepared in the form of silver halide grain emulsions, employing methods described in P. Glafkides, “Chimie et Physique Photographiques” (published by Paul Montel Co., 1967), G. F. Duffin, “Photographic Emulsion Chemistry” (published by The Focal Press, 1955), and V. L. Zelikman et al., “Making and Coating Photographic Emulsion”, published by The Focal Press, 1964). Namely, any of an acidic method, a neutral method, or an ammonia method may be employed. Further, employed as methods to allow water-soluble silver salts to react with water-soluble halides may be any of a single-jet precipitation method, a double-jet precipitation method, or combinations thereof. However, of these methods, the so-called controlled double-jet precipitation method is preferably employed in which silver halide grains are prepared while controlling formation conditions.

Halogen compositions are not particularly limited. Any of silver chloride, silver chlorobromide, silver chloroiodobromide, silver bromide, silver iodobromide, or silver iodide may be employed. Of these, silver bromide or silver iodobromide is particularly preferred.

Grain formation is commonly divided into two stages, that is, the formation of silver halide seed grains (being nuclei) and the growth of the grains. Either method may be employed in which two stages are continually carried out, or in which the formation of nuclei (seed grains) and the growth of grains are carried out separately. A controlled double-jet precipitation method, in which grains are formed while controlling the pAg and pH which are grain forming conditions, is preferred, since thereby it is possible to control grain shape as well as grain size. For example, when the method, in which nucleus formation and grain growth are separately carried out, is employed, initially, nuclei (being seed grains) are formed by uniformly and quickly mixing water-soluble silver salts with water-soluble halides in an aqueous gelatin solution. Subsequently, under the controlled pAg and pH, silver halide grains are prepared through a grain growing process which grows the grains while supplying water-soluble silver salts as well as water-soluble halides. After formation of the silver halide particles, the prepared photosensitive silver halide particles are subjected to desalting employing desalting methods known in the photographic art, such as a noodle method, a flocculation method, an ultrafiltration method, and an electrophoresis method.

In order to minimize milkiness (or white turbidity) as well as coloration (yellowing) after image formation and to obtain excellent image quality, the average grain diameter of the silver halide grains, employed in the present invention, is preferably rather small. The average grain diameter, when grains having a grain diameter of less than 0.02 μm is beyond practical measurement, is preferably 0.035 to 0.055 μm.

Incidentally, grain diameter, as described herein, refers to the edge length of silver halide grains which are so-called regular crystals such as a cube or an octahedron. Further, when silver halide gains are planar, the grain diameter refers to the diameter of the circle which has the same area as the projection area of the main surface.

In the present invention, silver halide grains are preferably in a state of monodispersion. Monodispersion, as described herein, means that the variation coefficient, obtained by the formula described below, is less than or equal to 30 percent. The aforesaid variation coefficient is preferably less than or equal to 20 percent, and is more preferably less than or equal to 15 percent.
Variation coefficient (in percent) of grain diameter=standard deviation of grain diameter/average of grain diameter×100

Cited as shapes of silver halide grains may be cubic, octahedral and tetradecahedral grains, planar grains, spherical grains, rod-shaped grains, and roughly elliptical-shaped grains. Of these, cubic, octahedral, tetradecahedral, and planar silver halide grains are particularly preferred.

When the aforesaid planar silver halide grains are employed, their average aspect ratio is preferably 1.5 to 100, and is more preferably 2 to 50. These are described in U.S. Pat. Nos. 5,264,337, 5,314,798, and 5,320,958, and incidentally it is possible to easily prepare the aforesaid target planar grains. Further, it is possible to preferably employ silver halide grains having rounded corners.

The crystal habit of the external surface of silver halide grains is not particularly limited. However, when spectral sensitizing dyes, which exhibit crystal habit (surface) selectiveness are employed, it is preferable that silver halide grains are employed which have the crystal habit matching their selectiveness in a relatively high ratio. For example, when sensitizing dyes, which are selectively adsorbed onto a crystal plane having a Miller index of (100), it is preferable that the ratio of the (100) surface on the external surface of silver halide grains is high. The ratio is preferably at least 50 percent, is more preferably at least 70 percent, and is most preferably at least 80 percent. Incidentally, it is possible to obtain a ratio of the surface having a Miller index of (100), based on T. Tani, J. Imaging Sci., 29, 165 (1985), utilizing adsorption dependence of sensitizing dye in a (111) plane as well as a (100) surface.

The silver halide grains, employed in the present invention, are preferably prepared employing low molecular weight gelatin, having an average molecular weight of less than or equal to 50,000 during the formation of the grains, which are preferably employed during formation of nuclei. The low molecular weight gelatin refers to gelatin having an average molecular weight of less than or equal to 50,000. The molecular weight is preferably from 2,000 to 40,000, and is more preferably from 5,000 to 25,000. It is possible to measure the molecular weight of gelatin employing gel filtration chromatography.

It is possible to produce low molecular weight gelatin in the following manner. Gelatin decomposition enzymes are added to an aqueous solution of common gelatin of an average molecular weight of approximately 100,000, and the resulting mixture undergoes enzymolysis. Acids or alkalis are added to the above gelatin solution and the resulting mixture undergoes hydrolysis while heated. Gelatin undergoes heat decomposition under atmospheric pressure or pressurized conditions. Gelatin is exposed to ultrasonic waves to result in decomposition. Desired gelatin may also be produced employing a method in which these methods are combined.

The concentration of dispersion media during the formation of nuclei is preferably less than or equal to 5 percent by weight. It is more effective to carry out the formation at a low concentration of 0.05 to 3.00 percent by weight.

During formation of the silver halide grains employed in the present invention, it is possible to use polyethylene oxides represented by the Formula described below.

Formula
YO(CH₂CH₂O)ₘ(CH(CH₃)CH₂O)ₚ(CH₂CH₂O)ₙY
wherein Y represents a hydrogen atom, —SO₃M, or —CO—B—COOM; M represents a hydrogen atom, an alkali metal atom, an ammonium group, or an ammonium group substituted with an alkyl group having less than or equal to 5 carbon atoms; B represents a chained or cyclic group which forms an organic dibasic acid; m and n each represents 0 through 50; and p represents 1 through 100.

When silver halide photosensitive photographic materials are produced, polyethylene oxides, represented by the above Formula, have been preferably employed as anti-foaming agents to counter marked foaming which occurs while stirring and transporting emulsion raw materials in a process in which an aqueous gelatin solution is prepared, in the process in which water-soluble halides as well as water-soluble silver salts are added to the gelatin solution, and in a process in which the resultant emulsion is applied onto a support. Techniques to employ polyethylene oxides as an anti-foaming agent are disclosed in, for example, JP-A No. 44-9497. The polyethylene oxides represented by the above Formula function as an anti-foaming agent during nuclei formation.

The content ratio of polyethylene oxides, represented by the above Formula, is preferably less than or equal to 1 percent by weight with respect to silver, and is more preferably from 0.01 to 0.10 percent by weight.

It is desired that polyethylene oxides, represented by the above Formula, are present during nuclei formation. It is preferable that they are previously added to the dispersion media prior to nuclei formation. However, they may also be added during nuclei formation, or they may be employed by adding them to an aqueous silver salt solution or an aqueous halide solution which is employed during nuclei formation. However, they are preferably employed by adding them to an aqueous halide solution, or to both aqueous solutions in an amount of 0.01 to 2.00 percent by weight. Further, it is preferable that they are present during at least 50 percent of the time of the nuclei formation process, and it is more preferable that they are present during at least 70 percent of the time of the same. The polyethylene oxides, represented by the above Formula, may be added in the form of powder or they may be dissolved in a solvent such as methanol and then added.

Incidentally, temperature during nuclei formation is commonly from 5 to 60° C., and is preferably from 15 to 50° C. It is preferable that the temperature is controlled within the range, even when a constant temperature, a temperature increasing pattern (for example, a case in which temperature at the initiation of nuclei formation is 25° C., subsequently, temperature is gradually increased during nuclei formation and the temperature at the completion of nuclei formation is 40° C.), or a reverse sequence may be employed.

The concentration of an aqueous silver salt solution and an aqueous halide solution, employed for nuclei formation, is preferably less than or equal to 3.5 M, and is more preferably in the lower range of 0.01 to 2.50 M. The silver ion addition rate during nuclei formation is preferably from 1.5×10⁻³ to 3.0×10⁻¹ mol/minute, and is more preferably from 3.0×10⁻³ to 8.0×10⁻² mol/minute.

The pH during nuclei formation can be set in the range of 1.7 to 10.0. However, since the pH on the alkali side broadens the particle size distribution of the formed nuclei, the preferred pH is from 2 to 6. Further, the pBr during nuclei formation is usually from about 0.05 to about 3.00, is preferably from 1.0 to 2.5, and is more preferably from 1.5 to 2.0.

The silver halide grains of the present invention may be incorporated in a photosensitive layer employing an optional method. In such a case, it is preferable that the aforesaid silver halide grains are arranged so as to be adjacent to reducible silver sources (being aliphatic carboxylic silver salts).

The silver halide of the present invention is previously prepared and the resulting silver halide is added to a solution which is employed to prepare aliphatic carboxylic acid silver salt particles. By so doing, since a silver halide preparation process and an aliphatic carboxylic acid silver salt particle preparation process are performed independently, production is preferably controlled. Further, as described in British Patent No. 1,447,454, when aliphatic carboxylic acid silver salt particles are formed, it is possible to almost simultaneously form aliphatic carboxylic acid silver salt particles by charging silver ions to a mixture consisting of halide components such as halide ions and aliphatic carboxylic acid silver salt particle forming components. Still further, it is possible to prepare silver halide grains utilizing conversion of aliphatic carboxylic acid silver salts by allowing halogen-containing components to act on aliphatic carboxylic acid silver salts. Namely, it is possible to convert some of aliphatic carboxylic acid silver salts to photosensitive silver halide by allowing silver halide forming components to act on the previously prepared aliphatic carboxylic acid silver salt solution or dispersion, or sheet materials comprising aliphatic carboxylic acid silver salts.

Silver halide grain forming components include inorganic halogen compounds such as ammonium halides, onium halides, halogenated hydrocarbons, N-halogen compounds, and other halogen-containing compounds. The specific examples are detailed in U.S. Pat. Nos. 4,009,039, 3,457,075, and 4,003,749; British Patent No. 1,498,956; and JP-A Nos. 53-27027 and 53-25420.

Specific examples include inorganic halides such as metal halides or ammonium halides; onium halides such as trimethylphenylammonium bromide, cetylethyldimethylammonium bromide, or trimethylbenzylamonium bromide; halogenated hydrocarbons such as iodoform, bromoform, carbon tetrachloride, or 2-bromo-2-methylpropane; N-halogen compounds such as N-bromosuccinimide, N-bromophthalylimide, or N-bromoacetoamide; and others such as triphenylmethyl chloride, triphenylmethyl bromide, 2-bromoacetic acid, 2-bromoethanol, or dicyclobenzophenone.

As noted above, it is also possible to prepare silver halides by converting some or all of the silver in organic silver salts to silver halide by allowing organic acid-silver salts to react with silver ions. Further, silver halide grains may be employed in combination which are produced by converting some part of separately prepared aliphatic carboxylic acid silver salts.

The aforesaid silver halide grains, which include separately prepared silver halide grains and silver halide grains prepared by partial conversion of aliphatic carboxylic acid silver salts, are employed commonly in an amount of 0.001 to 0.7 mol per mol of aliphatic carboxylic acid silver salts and preferably in an amount of 0.03 to 0.5 mol.

It is preferable that the silver halide grains contain ions of transition metals which belong to Groups 6 through 11 in the Periodic Table. Preferred as aforesaid transition metals are W, Fe, Co, Ni, Cu, Ru, Rh, Pd, Re, Os, Ir, Pt and Au.

These metal ions may be incorporated into silver halide in the form of salts. Further, they may be incorporated into silver halide in the form of metal complexes or complex ions. The content of these metal ions is preferably in the range of 1×10⁻⁹-1×10⁻² mol with respect to mol of silver, but is more preferably in the range of 1×10⁻⁸-1×10⁻⁴. In the present invention, preferred as transition metal complexes or complex ions are those represented by the following formula.
Formula [ML₆]^{m}
wherein M represents a transition metal selected from the elements of Groups 6 through 11 in the Periodic Table; L represents a ligand; and m represents 0, -, 2-, 3-, or 4-. Listed as specific examples of ligands represented by L are a halogen ion (a fluoride ion, a chloride ion, a bromide ion, or an iodide ion), a cyanide, a cyanate, a thiocyanate, a selenocyanate, a tellurocyanate, an azide, and an aqua ligand, and nitrosyl and thionitrosyl. Of these, aqua, nitrosyl, and thionitrosyl are preferred. When the aqua ligand is present, one or two ligands are preferably occupied by the aqua ligand. L may be the same or different.

It is preferable that compounds, which provide ions of these metals or complex ions, are added during formation of silver halide grains so as to be incorporated in the silver halide grains. The compounds may be added at any stage of, prior to or after, silver halide grain preparation, namely nuclei formation, grain growth, physical ripening or chemical ripening. However, they are preferably added at the stage of nuclei formation, grain growth, physical ripening, are more preferably added at the stage of nuclei formation and growth, and are most preferably added at the stage of nuclei formation. They may be added over several times upon dividing them into several portions. Further, they may be uniformly incorporated in the interior of silver halide grains. Still further, as described in JP-A Nos. 63-29603, 2-306236, 3-167545, 4-76534, 6-110146, and 5-273683, they may be incorporated so as to result in a desired distribution in the interior of the grains.

These metal compounds may be dissolved in water or suitable organic solvents (for example, alcohols, ethers, glycols, ketones, esters, and amides) and then added. Further, addition methods include, for example, a method in which either an aqueous solution of metal compound powder or an aqueous solution prepared by dissolving metal compounds together with NaCl and KCl is added to a water-soluble halide solution, a method in which silver halide grains are formed by a silver salt solution, and a halide solution together with a the compound solution as a third aqueous solution employing a triple-jet precipitation method, a method in which, during grain formation, an aqueous metal compound solution in a necessary amount is charged into a reaction vessel, or a method in which, during preparation of silver halide, other silver halide grains which have been doped with metal ions or complex ions are added and dissolved. Specifically, a method is preferred in which either an aqueous solution of metal compound powder or an aqueous solution prepared by dissolving metal compounds together with NaCl and KCl is added to a water-soluble halide solution. When added onto the grain surface, an aqueous metal compound solution in a necessary amount may be added to a reaction vessel immediately after grain formation, during or after physical ripening, or during chemical ripening.

The separately prepared photosensitive silver halide particles are subjected to desalting employing desalting methods known in the photographic art, such as a noodle method, a flocculation method, an ultrafiltration method, and an electrophoresis method, while they may be employed without desalting.

<Light-Insensitive Aliphatic Carboxylic Acid Silver Salt>

The light-insensitive aliphatic carboxylic acid silver salts according to the present invention are reducible silver sources which are preferably silver salts of long chain aliphatic carboxylic acids.

Employed as organic acids in the present invention are aliphatic carboxylic acids, carbon ring type carboxylic acids, heterocyclic carboxylic acids, and heterocyclic compounds.

Examples of non-photosensitive organic acid silver salts are described in Research Disclosure, 17029 and 29963.

Specific examples include the following: Silver salts of aliphatic carboxylic acids such as gallic acid, oxalic acid, behenic acid, arachidic acid, stearic acid, palmitic acid, and lauric acid; Silver carboxylalkylthiourea salts (such as 1-(3-carboxypropyl)thiourea or 1-(3-carboxypropyl)-3,3-dimethylthiourea); silver complexes of polymerization reaction products of aldehyde with hydroxyl substituted aromatic carboxylic acid (such silver complexes of polymerization reaction products of aldehyde (such as formaldehyde, acetaldehyde, or butylaldehyde) with hydroxyl substituted aromatic carboxylic acids (such as salicylic acid, benzoic acid, 3,5-dihydroxybanzoic acid, or 5,5-thiodisalyclic acid); silver salts or complexes of thiones (such as 3-(2-carboxyethyl)-4-hydroxymethyl-4-thiazoline-2-thione or 3-caboxymethyl-4-thazoline-2-thione); complexes or salts of silver with nitrogen acids selected from the group consisting of imidazole, pyrazole, urazole, 1,2,4-thiazole, and 1H-tetrazole, 3-amino-5-benzylthio-1,2,4-triazole, and benzotriazole; silver salts of saccharine and 5-chlorosalycylaloxime; and sliver salts of mercaptides.

Among the above-listed organic acids, silver salts of aliphatic carboxylic acids are preferably used. Silver salts of aliphatic carboxylic acids, having from 10 to 30 carbon atoms are preferable and from 15 to 25 carbon atoms are more preferable. Listed as examples of appropriate silver salts are those described below.

For example, listed are silver salts of gallic acid, oxalic acid, behenic acid, stearic acid, arachidic acid, palmitic acid, and lauric acid. Of these, listed as preferable silver salts are silver behenate, silver arachidate, and silver stearate.

Further, in the present invention, it is preferable that at least two types of aliphatic carboxylic acid silver salts are mixed since the resulting developing ability is enhanced and high contrast silver images are formed. Preparation is preferably carried out, for example, by mixing a mixture consisting of at least two types of aliphatic carboxylic acid with a silver ion solution.

Aliphatic carboxylic acid silver salts are prepared by mixing water-soluble silver compounds with compounds which form complexes with silver. When mixed, a normal precipitation method, a reverse precipitating method, a double-jet precipitation method, or a controlled double-jet precipitation method, described in JP-A No. 9-127643, are preferably employed. For example, after preparing a metal salt soap (for example, sodium behenate and sodium arachidate) by adding alkali metal salts (for example, sodium hydroxide and potassium hydroxide) to organic-acids, crystals of aliphatic carboxylic acid silver salts are prepared by mixing the soap with silver nitrate. In such a case, silver halide grains may be mixed together with them.

In order to achieve transparency of the image after thermal development and to improve stability of the formed image, it is preferable that aliphatic carboxylic acid silver salts of the present have an average circle equivalent diameter is from 0.05 to 0.80 μm. And, in order to achieve appropriate supply of silver ions, and further in order to improve stability of the formed image, it is preferable that aliphatic carboxylic acid silver salts of the present have an average thickness of 0.005 to 0.07 μm. It is more preferable that the average circle equivalent diameter is from 0.2 to 0.5 μm and the average thickness is from 0.01 to 0.05 μm.

The average circle equivalent diameter can be determined as follows. Aliphatic carboxylic acid silver salts, which have been subjected to dispersion, are diluted, are dispersed onto a grid covered with a carbon supporting layer, and imaged at a direct magnification of 5,000, employing a transmission type electron microscope (Type 2000FX, manufactured by JEOL, Ltd.). The resultant negative image is converted to a digital image employing a scanner. Subsequently, by employing appropriate software, the grain diameter (being a circle equivalent diameter) of at least 300 grains is determined and an average grain diameter is calculated.

It is possible to determine the average thickness, employing a method utilizing a transmission electron microscope (hereinafter referred to as a TEM) as described below.

First, a photosensitive layer, which has been applied onto a support, is adhered onto a suitable holder, employing an adhesive, and subsequently, cut in the perpendicular direction with respect to the support plane, employing a diamond knife, whereby ultra-thin slices having a thickness of 0.1 to 0.2 μm are prepared. The ultra-thin slice is supported by a copper mesh and transferred onto a hydrophilic carbon layer, employing a glow discharge. Subsequently, while cooling the resultant slice at less than or equal to −130° C. employing liquid nitrogen, a bright field image is observed at a magnification of 5,000 to 40,000, employing TEM, and images are quickly recorded employing either film, imaging plates, or a CCD camera. During the operation, it is preferable that the portion of the slice in the visual field is suitably selected so that neither tears nor distortions are imaged.

The carbon layer, which is supported by an organic layer such as extremely thin collodion or Formvar, is preferably employed. The more preferred carbon layer is prepared as follows. The carbon layer is formed on a rock salt substrate which is removed through dissolution. Alternately, the organic layer is removed employing organic solvents and ion etching whereby the carbon layer itself is obtained. The acceleration voltage applied to the TEM is preferably from 80 to 400 kV, and is more preferably from 80 to 20.0 kV.

Other items such as electron microscopic observation techniques, as well as sample preparation techniques, may be obtained while referring to either “Igaku-Seibutsugaku Denshikenbikyo Kansatsu Gihoh (Medical-Biological Electron Microscopic Observation Techniques”, edited by Nippon Denshikembikyo Gakkai Kanto Shibu (Maruzen) or “Denshikembikyo Seibutsu Shiryo Sakuseihoh (Preparation Methods of Electron Microscopic Biological Samples”, edited by Nippon Denshikenbikyo Gakkai Kanto Shibu (Maruzen).

It is preferable that a TEM image, recorded in a suitable medium, is decomposed into preferably at least 1,024×1,024 pixels and subsequently subjected to image processing, utilizing a computer. In order to carry out the image processing, it is preferable that an analogue image, recorded on a film strip, is converted into a digital image, employing any appropriate means such as scanner, and if desired, the resulting digital image is subjected to shading correction as well as contrast-edge enhancement. Thereafter, a histogram is prepared, and portions, which correspond to aliphatic carboxylic acid silver salts, are extracted through a binarization processing.

At least 300 of the thickness of aliphatic carboxylic acid silver salt particles, extracted as above, are manually determined employing appropriate software, and an average value is then obtained.

Methods to prepare aliphatic carboxylic acid silver salt particles, having the shape as above, are not particularly limited. It is preferable to maintain a mixing state during formation of an organic acid alkali metal salt soap and/or a mixing state during addition of silver nitrate to the soap as desired, and to optimize the proportion of organic acid to the soap, and of silver nitrate which reacts with the soap.

It is preferable that, if desired, the planar aliphatic carboxylic acid silver salt particles (referring to aliphatic carboxylic acid silver salt particles, having an average circle equivalent diameter of 0.05 to 0.80 μm as well as an average thickness of 0.005 to 0.070 μm) are preliminarily dispersed together with binders as well as surface active agents, and thereafter, the resultant mixture is dispersed employing a media homogenizer or a high pressure-homogenizer. The preliminary dispersion may be carried out employing a common anchor type or propeller type stirrer, a high speed rotation centrifugal radial type stirrer (being a dissolver), and a high speed rotation shearing type stirrer (being a homomixer).

Further, employed as the aforesaid media homogenizers may be rotation mills such as a ball mill, a planet ball mill, and a vibration ball mill, media stirring mills such as a bead mill and an attritor, and still others such as a basket mill. Employed as high pressure homogenizers may be various types such as a type in which collision against walls and plugs occurs, a type in which a liquid is divided into a plurality of portions which are collided with each other at high speed, and a type in which a liquid is passed through narrow orifices.

Preferably employed as ceramics, which are used in ceramic beads employed during media dispersion are, for example: Al₂O₃, BaTiO₃, SrTiO₃, MgO, ZrO, BeO, Cr₂O₃, SiO₂, SiO₂—Al₂O₃, Cr₂O₃—MgO, MgO—CaO, MgO—C, MgO—Al₂O₃ (Spinel), SIC, TiO₂, K₂O, Na₂O, BaO, PbO, B₂O₃, BeAl₂O₄, Y₃Al₅O₁₂, ZrO₃—Y₂O₃ (cubic zirconia) 3BeO—Al₂O₃-6 SiO₂, (synthetic emerald), C (synthetic diamond), Si₂O-nH₂O, silicon nitride, yttrium-stabilized zirconia, and zirconia-reinforced alumina. By the reason of low amount of impurity formation due to friction with beads as well as with the homogenizer during dispersion, it is preferably used yttrium-stabilized zirconia, and zirconia-reinforced alumina (hereafter ceramics containing zirconia are abbreviated to as zirconia).

In apparatuses which are employed to disperse the planar aliphatic carboxylic acid silver salt particles of the present invention, preferably employed as materials of the members which come into contact with the aliphatic carboxylic acid silver salt particles are ceramics such as zirconia, alumina, silicon nitride, and boron nitride, or diamond. Of these, zirconia is preferably employed. During the dispersion, the concentration of added binders is preferably from 0.1 to 10.0 percent by weight with respect to the weight of aliphatic carboxylic acid silver salts. Further, temperature of the dispersion during the preliminary and main dispersion is preferably maintained at less than or equal to 45° C. The examples of the preferable operation conditions for the main dispersion are as follows. When a high pressure homogenizer is employed as a dispersion means, preferable operation conditions are from 29 to 100 MPa, and at least double operation frequency. Further, when the media homogenizer is employed as a dispersion means, the peripheral rate of 6 to 13 m/second is cited as the preferable condition.

In the present invention, compounds, which are described herein as crystal growth retarding agents or dispersing agents for aliphatic carboxylic acid silver salt particles, refer to compounds which, in the production process of aliphatic carboxylic acid silver salts, exhibit more functions and greater effects to decrease the grain diameter, and to enhance monodispersibility when the aliphatic carboxylic acid silver salts are prepared in the presence of the compounds, compared to the case in which the compounds are not employed. Listed as examples are monohydric alcohols having 10 or fewer carbon atoms, such as preferably secondary alcohol and tertiary alcohol; glycols such as ethylene glycol and propylene glycol; polyethers such as polyethylene glycol; and glycerin. The preferable addition amount is from 10 to 200 percent by weight with respect to aliphatic carboxylic acid silver salts.

On the other hands, preferred are branched aliphatic carboxylic acids, each containing an isomer, such as isoheptanic acid, isodecanoic acid, isotridecanoic acid, isomyristic acid, isopalmitic acid, isostearic acid, isoarachidinic acid, isobehenic acid, or isohexaconic acid. Listed as preferable side chains are an alkyl group or an alkenyl group having 4 or fewer carbon atoms. Further, listed are aliphatic unsaturated carboxylic acids such as palmitoleic acid, oleic acid, linoleic acid, linolenic acid, moroctic acid, eicosenoic acid, arachidonic acid, eicosapentaenoic acid, erucic acid, docosapentaenoic acid, and selacholeic acid. The preferable addition amount is from 0.5 to 10.0 mol percent of aliphatic carboxylic acid silver salts.

Preferable compounds include glycosides such as glucoside, galactoside, and fructoside; trehalose type disaccharides such as trehalose and sucrose; polysaccharides such as glycogen, dextrin, dextran, and alginic acid; cellosolves such as methyl cellosolve and ethyl cellosolve; water-soluble organic solvents such as sorbitan, sorbitol, ethyl acetate, methyl acetate, and dimethylformamide; and water-soluble polymers such as polyvinyl alcohol, polyacrylic acid, acrylic acid copolymers, maleic acid copolymers, carboxymethyl cellulose, hydroxypropyl cellulose, hydroxypropyl methyl cellulose, polyvinylpyrrolidone, and gelatin. The preferable addition amount is from 0.1 to 20.0 percent by weight with respect to aliphatic carboxylic acid silver salts.

Alcohols having 10 or fewer carbon atoms, being preferably secondary alcohols and tertiary alcohols, increase the solubility of sodium aliphatic carboxylates in the emulsion preparation process, whereby the viscosity is lowered so as to enhance the stirring efficiency and to enhance monodispersibility as well as to decrease particle size. Branched aliphatic carboxylic acids, as well as aliphatic unsaturated carboxylic acids, result in higher steric hindrance than straight chain aliphatic carboxylic acid silver salts as a main component during crystallization of aliphatic carboxylic acid silver salts to increase the distortion of crystal lattices whereby the particle size decreases due- to non-formation of over-sized crystals.

<Antifoggant and Image Stabilizer>

As mentioned above, being compared to conventional silver halide photosensitive photographic materials, the greatest different point in terms of the structure of silver salt photothermographic dry imaging materials is that in the latter materials, a large amount of photosensitive silver halide, organic silver salts and reducing agents is contained which are capable of becoming causes of generation of fogging and printout silver, irrespective of prior and after photographic processing. Due to that, in order to maintain storage stability before development and even after development, it is important to apply highly effective fog minimizing and image stabilizing techniques to silver salt photothermographic dry imaging materials. Other than aromatic heterocyclic compounds which retard the growth and development of fog specks, heretofore, mercury compounds, such as mercury acetate, which exhibit functions to oxidize and eliminate fog specks, have been employed as a markedly effective storage stabilizing agents. However, the use of such mercury compounds may cause problems regarding safety as well as environmental protection.

(Antifoggants and Image Stabilizers)

Antifoggants and image stabilizers employed in the photothermographic materials of the present invention will now be described.

In the photothermographic materials of the present invention, bisphenols are employed as a silver ion reducing agent. Consequently, it is preferable that compounds are incorporated which are capable of deactivating the reducing agents by generating active species capable of pulling out these hydrogen atoms. Compounds are preferred which are capable of forming free radicals as a reaction active species in the form of colorless photo-oxidizing substances during exposure.

Accordingly, any compound is acceptable as long as it exhibits such functions, but organic free radicals are preferred which are composed of a plurality of atoms. Compounds having any structure are acceptable as long as they exhibit such functions and result in no specific adverse effects to the photothermographic materials.

Further, preferred as such free radical generating compounds are those having a carbon ring or a heterocyclic aromatic group to allow any generated free radical to exhibit stability so that they react with reducing agents, and the contact time allows deactivating them.

Listed as these representative compounds are the biimidazolyl compounds and iodonium compounds described below.

As an imidazolyl compound, preferably employed are the compounds represented by following Formula (I). 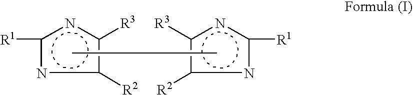
wherein R¹, R², and R³ each represent an alkyl group (methyl, ethyl, or hexyl), an alkenyl group (vinyl or allyl), an alkoxy group (methoxy, ethoxy, or octyloxy), an aryl group (phenyl, naphthyl or tolyl), a hydroxyl group, a halogen atom, an aryloxy group (phenoxy), an alkylthio group (methylthio or butylthio), an arylthio group (phenylthio), an acyl group (acetyl, propionyl, butylyl, or valeryl), a sulfonyl group (methylsulfonyl or phenylsulfonyl), an acylamino group, a sulfonylamino group, an acyloxy group (acetoxy or benzoxy), a carboxyl group, a cyano group, a sulfo group, or an amino group. Of these, more appropriate substituents include an aryl group, an alkenyl group, or a cyano group.

It is possible to produce the above biimidazolyl compounds employing a production method or the sub-method described in U.S. Pat. No. 3,734,733 and British Patent No. 1,271,177. Listed as preferred specific examples are the exemplified compounds described, for example, in JP-A No. 2000-321711.

Further listed as similarly appropriate compounds are the iodonium compounds represented by following Formula (2). 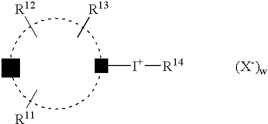
wherein Q₁ includes atoms necessary to complete a 5-, 6-, or 7-membered ring, and the above necessary atoms are selected from a carbon atom, a nitrogen atom, an oxygen atom, and a sulfur atom. R¹¹, R¹², and R¹³ each represent a hydrogen atom, an alkyl group (methyl, ethyl, or hexyl), an alkenyl group (vinyl or allyl), an alkoxy group (methoxy, ethoxy, or octyloxy), an aryl group (phenyl, naphthyl, or tolyl), a hydroxyl group, a halogen atom, an aryloxy group (phenoxy), an alkylthio group (methylthio or butylthio), an arylthio group (phenylthio), an acyl group (acetyl, propionyl, butylyl, or valeryl), a sulfonyl group (methylsulfonyl or phenylsulfonyl), an acylamino group, a sulfonylamino group, an acyloxy group (acetoxy or benzoxy), a carboxyl group, a cyano group, a sulfo group, and an amino group. Of these the more appropriate substituents are the aryl group, the alkenyl group, and the cyano group.

R¹⁴ represents a carboxylate group such as acetate, benzoate, or trifluoroacetate and O⁻, while w represents 0 or 1.

X⁻ represents an anionic counter-ion, appropriate examples of which include CH₃COO⁻, CH₃SO₃⁻, and PF₆⁻.

When R¹³ represents a sulfo group or a carboxyl group, w represents 0 and R¹⁴ represents O⁻. Further, any two of R¹¹, R¹², and R¹³ may bond to each other to form a ring.

Of these, particularly preferred compounds are those represented by following Formula (3). 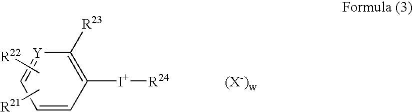
wherein R²¹, R²², R²³, R²⁴, X⁻ and w each are as defined for R¹¹, R¹², R¹³, R¹⁴ and X⁻ in above Formula (2), while Y represents either a carbon atom (—CH═; benzene ring) or a nitrogen atom (—N═; pyridine ring).

It is possible to synthesize the above iodonium compounds employing the production method described in Org. Syn., 1961 and Fieser, Advanced organic Chemistry (Reinhold, N.Y., 1961) or the methods based on the above method.

Preferable examples are listed in JP-A 2000-321711.

The added amount of the compounds represented by above Formulas (1) and (2) is commonly 10⁻³-10⁻¹ mol/m², but is preferably 5×10⁻³-5×10⁻² mol/m². It is possible to incorporate the above compounds in any constituted layer of the photosensitive materials of the present invention, but it is preferable that they are incorporated near the reducing agents.

Further preferred as compounds, which deactivate reducing agents so that it is not possible for the above reducing agent to reduce carboxylic acid silver salts to silver, are those in which reaction active species are not halogen atoms. However, it is possible to employ compounds which release a halogen atom as an active species by simultaneously employing compounds which release atoms other than the halogen atom. Many compounds are known which are capable of releasing a halogen atom as an active species, and their simultaneous use results in the desired effects.

Specific examples of compounds which generate such active halogen atoms include the compounds represented by following Formula (4).

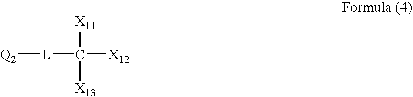

In Formula, Q₂ represents an aryl group or a heterocyclic group; X₁₁, X₁₂, and X₁₃ each represent a hydrogen atom, a halogen atom, an acyl group, an alkoxycarbonyl group, an aryloxycarbonyl group, a sulfonyl group, or an aryl group, at least one of which is a halogen atom; and L represents —C(═O)—, —SO— or —SO₂—.

The aryl group represented by Q₂ may be in the form of a single ring or a condensed ring, and is preferably a single ring or double ring aryl group having 6-30 carbon atoms (for example, phenyl and naphthyl) and is more preferably a phenyl group and a naphthyl group, and is still more preferably a phenyl group.

The heterocyclic group represented by Q₂ is a 3- to 10-membered saturated or unsaturated heterocyclic group containing at least one of N, O, or S, which may be a single ring or may form a condensed ring with another ring.

The heterocyclic group is preferably a 5- to 6-membered unsaturated heterocyclic group which may have a condensed ring, is more preferably a 5- to 6-membered aromatic heterocyclic group which may have a condensed ring, and is most preferably a 5- to 6-membered aromatic heterocyclic group which may have a condensed ring containing 1 to 4 nitrogen atoms. Heterocycles in such heterocyclic groups are preferably imidazole, pyrazole, pyridine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzthiazole, indolenine, and tetraazaindene; are more preferably imidazole, pyridine, pyrimidine, pyrazine, pyridazine, triazole, triazine, thiadiazole, oxadiazole, quinoline, phthalazine, naphthyridine, quinoxaline, quinazoline, cinnoline, tetrazole, thiazole, oxazole, benzimidazole, benzoxazole, benzthiazole, and tetraazaindene; are still more preferably imidazole, pyridine, pyrimidine, pyrazine, pyridazine, triazole, triazine, thiadiazole, quinoline, phthalazine, naphthyridine, quinoxaline, quinazoline, cinnoline, tetrazole, triazole, benzimidazole, and benzthiazole; and are most preferably pyridine, thiadiazole, quinoline, and benzthiazole.

The aryl group and heterocyclic group represented by Q₂ may have a substituent other than —YU—C(X₁)(X₂)(X₃). Substituents are preferably an alkyl group, an alkenyl group, an aryl group, an alkoxy group, an aryloxy group, an acyloxy group, an acyl group, an alkoxycarbonyl group, an aryloxycarbonyl group, an acyloxy group, an acylamino group, an alkoxycarbonylamino group, an aryloxycarbonylamino group, a sulfonylimino group, a sulfamoyl group, a carbamoyl group, a sulfonyl group, a ureido group, a phosphoric acid amide group, a halogen atom, a cyano group, a sulfo group, a carboxyl group, a nitro group, and a heterocyclic group; are more preferably an alkyl group, an aryl group, an alkoxy group, an aryloxy group, an acyl group, an acylamino group, an alkoxycarbonylamino group, an aryloxycarbonylamino group, a sulfonylamino group, a sulfamoyl group, a carbamoyl group, a ureido group, a phosphoric acid amide group, a halogen atom, a cyano group, a nitro group, and a heterocyclic group; are more preferably an alkyl group, an aryl group, an alkoxy group, an aryloxy group, an acyl group, an acylamino group, a sulfonylimino group, a sulfamoyl group, a carbamoyl group, a halogen atom, a cyano group, a nitro group, and a heterocyclic group; and are most preferably an alkyl group, an aryl group, are a halogen atom.

Each of X₁, X₂, and X₃ is preferably a halogen atom, a haloalkyl group, an acyl group, an alkoxycarbonyl group, an aryloxycarbonyl group, a carbamoyl group, a sulfamoyl group, a sulfonyl group, or a heterocyclic group; is more preferably a halogen atom, a haloalkyl group, an acyl group, an alkoxycarbonyl group, an aryloxycarbonyl group, or a sulfonyl group; is still more preferably a halogen atom or a trihalomethyl group; and is most preferably a halogen atom. Of halogen atoms preferred are a chlorine atom, a bromine atom and an iodine atom. Of these, a chlorine atom and a bromine atom are more preferred and a bromine atom is particularly preferred.

L represents —C(═O)— or —SO₂—, and is preferably —SO₂—.

The added amount of these compounds is preferably in the range in which an increase in print-out silver due to the formation of silver halide result in no problem. The ratio with respect to the above compounds which form no active halogen radicals is preferably at most 150 percent, but is more preferably at most 100 percent.

Incidentally, other than the above-mentioned compounds, compounds which are conventionally known as an antifogging agent may be incorporated in the present photothermographic material. They may be the compounds which can produce the same reactive species or they may the compounds which have a different antifogging mechanism.

In the present invention, reducing agents for silver ions are preferably bis-phenol derivatives represented by Formula (1).

The amount of silver ion reducing agents employed in the photothermographic imaging materials of the present invention varies depending on the types of organic silver salts, reducing agents, and other additives. However, the aforesaid amount is customarily 0.05-10 mol per mol of organic silver salts and is preferably 0.1-3 mol. Further, in this amount range, silver ion reducing agents of the present invention may be employed in combinations of at least two types. Namely, in view of achieving images exhibiting excellent storage stability, high image quality, and high CP, it is preferable to simultaneously employ reducing agents which differ in reactivity due to different chemical structure.

In the present invention, preferred cases occasionally occur in which when the aforesaid reducing agents are added to and mixed with a photosensitive emulsion comprised of photosensitive silver halide, organic silver salt particles, and solvents just prior to coating, and then coated, variation of photographic performance during standing time is minimized.

The photosensitive silver halide of the present invention may undergo chemical sensitization. For instance, it is possible to create chemical sensitization centers (being chemical sensitization nuclei) utilizing compounds which release chalcogen such as sulfur, as well as noble metal compounds which release noble metals ions, such as gold ions, while employing methods described in, for example, Japanese Patent Application Nos. 2000-057004 and 2000-061942.

The chemical sensitization nuclei is capable of trapping an electron or a hole produced by a photo-excitation of a sensitizing dye.

It is preferable that the aforesaid silver halide is chemically sensitized employing organic sensitizers containing chalcogen atoms, as described below.

It is preferable that the aforesaid organic sensitizers, comprising chalcogen atoms, have a group capable of being adsorbed onto silver halide grains as well as unstable chalcogen atom positions.

Employed as the aforesaid organic sensitizers may be those having various structures, as disclosed in JP-A Nos. 60-150046, 4-109240, and 11-218874. Of these, the aforesaid organic sensitizer is preferably at least one of compounds having a structure in which the chalcogen atom bonds to a carbon atom, or to a phosphorus atom, via a double bond.

The employed amount of chalcogen compounds as an organic sensitizer varies depending on the types of employed chalcogen compounds, silver halide grains, and reaction environments during performing chemical sensitization, but is preferably from 10⁻⁸ to 10⁻² mol per mol of silver halide, and is more preferably from 10⁻⁷ to 10⁻³ mol. The chemical sensitization environments are not particularly limited. However, it is preferable that in the presence of compounds which diminish chalcogenized silver or silver nuclei, or decrease their size, especially in the presence of oxidizing agents capable of oxidizing silver nuclei, chalcogen sensitization is performed employing organic sensitizers, containing chalcogen atoms. The sensitization conditions are that the pAg is preferably from 6 to 11, but is more preferably from 7 to 10, while the pH is preferably from 4 to 10, but is more preferably from 5 to 8. Further, the sensitization is preferably carried out at a temperature of lass than or equal to 30° C.

Accordingly, in the photothermographic materials of the present invention, it is preferable to employ photosensitive emulsions which are prepared as described below. Photosensitive silver halide undergoes chemical sensitization at 30° C. or less in the simultaneous presence of oxidizing agents capable of oxidizing silver nuclei on grains of the above silver halide, employing organic sensitizers incorporating chalcogen atoms, and further the resulting silver halide is blended with aliphatic carboxylic acid silver salts, and then dispersed. Subsequently, the resulting dispersion is dehydrated and dried.

Further, it is preferable that chemical sensitization, employing the aforesaid organic sensitizers, is carried out in the presence of either spectral sensitizing dyes or compounds containing heteroatoms, which exhibit the adsorption onto silver halide grains. By carrying out chemical sensitization in the presence of compounds which exhibit adsorption onto silver halide grains, it is possible to minimize the dispersion of chemical sensitization center nuclei, whereby it is possible to achieve higher speed as well as lower fogging. Though spectral sensitizing dyes will be described below, the compounds comprising heteroatoms, which result in adsorption onto silver halide grains, as descried herein, refer to, as preferable examples, nitrogen containing heterocyclic compounds described in JP-A No. 3-24537. Listed as heterocycles in nitrogen-containing heterocyclic compounds may be a pyrazole ring, a pyrimidine ring, a 1,2,4-triazine ring, a 1,2,3-triazole ring, a 1,3,4-thiazole ring, a 1,2,3-thiazole ring, a 1,2,4-thiadiazole ring, a 1,2,5-thiadiazole ring, 1,2,3,4-tetrazole ring, a pyridazine ring, and a 1,2,3-triazine ring, and a ring which is formed by combining 2 or 3 of the rings such as a triazolotriazole ring, a diazaindene ring, a triazaindene ring, and a pentaazaindenes ring. It is also possible to employ heterocyclic rings such as a phthalazine ring, a benzimidazole ring, an indazole ring and a benzthiazole ring, which are formed by condensing a single heterocyclic ring and an aromatic ring.

Of these, preferred is an azaindene ring. Further, preferred are azaindene compounds having a hydroxyl group, as a substituent, which include compounds such as hydroxytriazaindene, tetrahydroxyazaindene, and hydroxypentaazaindene.

The aforesaid heterocyclic ring may have substituents other than a hydroxyl group. As substituents, the aforesaid heterocyclic ring may have, for example, an alkyl group, a substituted alkyl group, an alkylthio group, an amino group, a hydroxyamino group, an alkylamino group, a dialkylamino group, an arylamino group, a carboxyl group, an alkoxycarbonyl group, a halogen atom, and a cyano group.

The added amount of these heterocyclic compounds varies widely depending on the size and composition of silver halide grains, and other conditions. However, the amount is in the range of about 10⁻⁶ to 1 mol per mol with respect to silver halide, and is preferably in the range of 10⁻⁴ to 10⁻¹ mol.

The photosensitive silver halide of the present invention may undergo noble metal sensitization utilizing compounds which release noble metal ions such as gold ions. For example, employed as gold sensitizers may be chloroaurates and organic gold compounds disclosed in JP-A No. 11-194447.

Further, other than the aforesaid sensitization methods, it is possible to employ a reduction sensitization method. Employed as specific compounds for the reduction sensitization may be ascorbic acid, thiourea dioxide, stannous chloride, hydrazine derivatives, boron compounds, silane compounds, and polyamine compounds. Further, it is possible to perform reduction sensitization by ripening an emulsion while maintaining a pH higher than or equal to 7 or a pAg less than or equal to 8.3.

Silver halide which undergoes the chemical sensitization, according to the present invention, includes one which has been formed in the presence of organic silver salts, another which has been formed in the absence of organic silver salts, or still another which has been formed by mixing those above.

It is preferable that photosensitive silver halide in the present invention is adsorbed by spectral sensitizing dyes so as to result in spectral sensitization. Employed as spectral sensitizing dyes may be cyanine dyes, merocyanine dyes, complex cyanine dyes, complex merocyanine dyes, homopolar cyanine dyes, styryl dyes, hemicyanine dyes, oxonol dyes, and hemioxonol dyes. For example, employed may be sensitizing dyes described in JP-A Nos. 63-159841, 60-140335, 63-231437, 63-259651, 63-304242, and 63-15245, and U.S. Pat. Nos. 4,639,414, 4,740,455, 4,741,966, 4,751,175, and 4,835,096.

Useful sensitizing dyes, employed in the present invention, are described in, for example, Research Disclosure, Item 17645, Section IV-A (page 23, December 1978) and Item 18431, Section X (page 437, August 1978) and publications further cited therein. It is specifically preferable that those sensitizing dyes are used which exhibit spectral sensitivity suitable for spectral characteristics of light sources of various types of laser imagers, as well as of scanners. For example, preferably employed are compounds described in JP-A Nos. 9-34078, 9-54409, and 9-80679.

Useful cyanine dyes include, for example, cyanine dyes having basic nuclei such as a thiazoline nucleus, an oxazoline nucleus, a pyrroline nucleus, a pyridine nucleus, an oxazole nucleus, a thiazole nucleus, a selenazole nucleus, and an imidazole nucleus. Useful merocyanine dyes, which are preferred, comprise, in addition to the basic nuclei, acidic nuclei such as a thiohydantoin nucleus, a rhodanine nucleus, an oxazolizinedione nucleus, a thiazolinedione nucleus, a barbituric acid nucleus, a thiazolinone nucleus, a marononitryl nucleus, and a pyrazolone nucleus.

In the present invention, it is possible to employ sensitizing dyes which exhibit spectral sensitivity, specifically in the infrared region. Listed as preferably employed infrared spectral sensitizing dyes are infrared spectral sensitizing dyes disclosed in U.S. Pat. Nos. 4,536,473, 4,515,888, and 4,959,294. Regarding infrared spectral sensitizing dyes, preferable dyes are long chain polymethine dyes having a benzazole ring substituted with a sulfinyl group on the benzene ring.

It is possible to easily synthesize the aforesaid infrared sensitizing dyes, employing the method described in F. M. Harmer, “The Chemistry of Heterocyclic Compounds, Volume 18, The Cyanine Dyes and Related Compounds (A. Weissberger ed., published by Interscience, New York, 1964).

These infrared sensitizing dyes may be added at any time after preparing the silver halide. For example, the dyes may be added to solvents, or the dyes, in a so-called solid dispersion state in which the dyes are dispersed into minute particles, may be added to a photosensitive emulsion comprising silver halide grains or silver halide grains/aliphatic carboxylic acid silver salts. Further, in the same manner as the aforesaid heteroatoms containing compounds which exhibit adsorption onto silver halide grains, the dyes are adsorbed onto silver halide grains prior to chemical sensitization, and subsequently, undergo chemical sensitization, whereby it is possible to minimize the dispersion of chemical sensitization center nuclei so at to enhance speed, as well as to decrease fogging.

In the present invention, the aforesaid spectral sensitizing dyes may be employed individually or in combination. Combinations of sensitizing dyes are frequently employed when specifically aiming for supersensitization, for expanding or adjusting a spectral sensitization range.

An emulsion comprising photosensitive silver halide as well as aliphatic carboxylic acid silver salts, which are employed in the silver salt photothermographic dry imaging material of the present invention, may comprise sensitizing dyes together with compounds which are dyes having no spectral sensitization or have substantially no absorption of visible light and exhibit supersensitization, whereby the aforesaid silver halide grains may be supersensitized.

Useful combinations of sensitizing dyes and dyes exhibiting supersensitization, as well as materials exhibiting supersensitization, are described in Research Disclosure Item 17643 (published December 1978), page 23, Section J of IV; Japanese Patent Publication Nos. 9-25500 and 43-4933; and JP-A Nos. 59-19032, 59-192242, and 5-431432. Preferred as supersensitizers are hetero-aromatic mercapto compounds or mercapto derivatives.
Ar—SM
wherein M represents a hydrogen atom or an alkali metal atom, and Ar represents an aromatic ring or a condensed aromatic ring, having at least one of a nitrogen, sulfur, oxygen, selenium, or tellurium atom. Hetero-aromatic rings are preferably benzimidazole, naphthoimidazole, benzimidazole, naphthothiazole, benzoxazole, naphthooxazole, benzoselenazole, benztellurazole, imidazole, oxazole, pyrazole, triazole, triazine, pyrimidine, pyridazine, pyrazine, pyridine, purine, quinoline, or quinazoline. On the other hand, other hetero-aromatic rings are also included.

Incidentally, mercapto derivatives, when incorporated in the dispersion of aliphatic carboxylic acid silver salts and/or a silver halide grain emulsion, are also included which substantially prepare the mercapto compounds. Specifically, listed as preferred examples are the mercapto derivatives described below.
Ar—S—S—Ar
wherein Ar is the same as the mercapto compounds defined above.

The aforesaid hetero-aromatic rings may have a substituent selected from the group consisting of, for example, a halogen atom (for example, Cl, Br, and I), a hydroxyl group, an amino group, a carboxyl group, an alkyl group (for example, an alkyl group having at least one carbon atom and preferably having from 1 to 4 carbon atoms), and an alkoxy group (for example, an alkoxy group having at least one carbon atom and preferably having from 1 to 4 carbon atoms).

Other than the aforesaid supersensitizers, employed as supersensitizers may be compounds represented by Formula (5), shown below, which is disclosed in Japanese Patent Application No. 2000-070296 and large ring compounds containing a hetero atom. 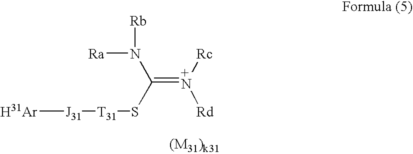
wherein H³¹Ar represents an aromatic hydrocarbon group or an aromatic heterocyclyl group, T₃₁ represents a divalent linking group composed of an aliphatic hydrocarbon group or a linking group, J₃₁ represents a divalent linking group incorporating an oxygen atom as well as at least one of sulfur atom or a nitrogen atom or a linking group. Ra, Rb, Rc, and Rd each represent a hydrogen atom, an acyl group, an aliphatic hydrocarbon group, an aryl group, or a heterocyclyl group. Ra and Rb, Rc and Rd, Ra and Rc, or Rb and Rd may bond to each other to form a nitrogen containing heterocyclyl group, M₃₁ represents an ion which is necessary for neutralizing the electrical charges in the molecule, while k represents the number of ions which are necessary for neutralizing charges in the molecule.

Divalent linking groups composed of an aliphatic hydrocarbon group represented by T₃₁ include a straight or branched chain, or a cyclic alkylene group (having preferably 1-20 carbon atoms, more preferably 1-16, but still more preferably 1-12), an alkenylene (having preferably 2-20 carbon atoms, more preferably 2-16, but still more preferably 2-12), an alkynylene group (having preferably 2-20 carbon atoms, more preferably 2-16, but still more preferably 2-12). These may have a substituent. Examples of the aliphatic hydrocarbon group include a straight or branched chain, or a cyclic alkyl group (having preferably 1-20 carbon atoms, more preferably 1-16, but still more preferably 1-12), an alkenyl group (having preferably 2-20 carbon atoms, more preferably 2-16, but still more preferably 2-12), an alkynyl group (having preferably 2-20 carbon atoms, more preferably 2-16, but still more preferably 2-12). Examples of the aryl group include a single or condensed ring aryl group (phenyl and naphthyl are listed and phenyl is preferred). Examples of the heterocyclyl group include a 3- to 10-membered saturated or unsaturated heterocyclyl group (2-thiazolyl, 1-piperadinyl, 3-pyridyl, 2-furyl, 2-thienyl, 2-benzimidazoyl, or carbazolyl), and the heterocycle in these groups may be a single ring or may form a condensed ring with other rings. Each of these groups may have a substituent at any position. Examples of the substituents include an alkyl group (such as a cycloalkyl group or an aralkyl group, having preferably 1-20 carbon atoms, more preferably 1-12 carbon atoms, but still more preferably 1-8 carbon atoms, such as methyl, ethyl, propyl, i-propyl, butyl, t-butyl, heptyl, octyl, decyl, undecyl, hexadecyl, cyclopropyl, cyclopentyl, cyclohexyl, benzyl or phenetyl), an alkenyl group (having preferably 2-20 carbon atoms, more preferably 2-12 carbon atoms, but still more preferably 2-8 carbon atoms, such as vinyl, allyl, 2-butenyl or 3-pentenyl), an alkynyl group (having preferably 2-20 carbon atoms, more preferably 2-12 carbon atoms, but still more preferably 2-8 carbon atoms, such as propargyl or 3-pentynyl), an aryl group (having preferably 6-30 carbon atoms, more preferably 6-20 carbon atoms, but still more preferably 6-12 carbon atoms, such as phenyl, tolyl, o-aminophenyl, or naphthyl), an amino group (having preferably 0-20 carbon atoms, more preferably 0-10 carbon atoms, but still more preferably 0-6 carbon atoms, such as amino, methylamino, ethylamino, dimethylamino, diethylamino, diphenylamino, or dibenzylamino), an imino group (having preferably 1-20 carbon atoms, more preferably 1-18 carbon atoms, but still more preferably 1-12 carbon atoms, such as amino, methylimino, ethylimino, propylamino, or phenylimino), an alkoxy group (having preferably 1-20 carbon atoms, more preferably 1-12 carbon atoms, but still more preferably 1-8 carbon atoms, such as methoxy, ethoxy, or butoxy), an aryloxy group (having preferably 6-20 carbon atoms, more preferably 6-16 carbon atoms, but still more preferably 6-12 carbon atoms, such as phenyloxy or 2-naphthyloxy), an acyl group (having preferably 1-20 carbon atoms, more preferably 1-16 carbon atoms, but still more preferably 1-12 carbon atoms, such as acetyl, benzoyl, formyl, or pivaloyl), an alkoxycarbonyl group (having preferably 2-20 carbon atoms, more preferably 2-16 carbon atoms, but still more preferably 2-12 carbon atoms, such as methoxycarbonyl or ethoxycarbonyl), an aryloxycarbonyl group (having preferably 7-20 carbon atoms, more preferably 7-16 carbon atoms, but still more preferably 7-10 carbon atoms, such as phenyloxycarbonyl), an acyloxy group (having preferably 1-20 carbon atoms, more preferably 1-16 carbon atoms, but still more preferably 1-10 carbon atoms, such as acetoxy or benzoyloxy), an acylamino group (having preferably 1-20 carbon atoms, more preferably 1-16 carbon atoms, but still more preferably 1-10 carbon atoms, such as an acetylamino group or a benzoylamino group), an alkoxycarbonylamino group (having preferably 2-20 carbon atoms, more preferably 2-16 carbon atoms, but most preferably 2-12 carbon atoms, such methoxycarbonylamino), an aryloxycarbonylamino group (having preferably 7-20 carbon atoms, more preferably 7-16 carbon atoms, but still more preferably 7-12 carbon atoms, such as phenyloxycarbonylamino), a sulfonylamino group (having preferably 1-20 carbon atoms, more preferably 1-16 carbon atoms, but still more preferably 1-12 carbon atoms, such as methanesulfonylamino or benzenesulfonylamino), a sulfamoyl group (having preferably 0-20 carbon atoms, more preferably 0-16 carbon atoms, but most preferably 0-12 carbon atoms, such as sulfamoyl, methylsulfamoyl, dimethylsulfamoyl, or phenylsulfamoyl), a carbamoyl group (having preferably 1-20 carbon-atoms, more preferably 1-16 carbon atoms, but most preferably 1-12 carbon atoms, such as carbamoyl, methylcarbamoyl, diethylcarbamoyl, or phenylcarbamoyl), an alkylthio group (having preferably 1-20 carbon atoms, more preferably 1-16 carbon atoms, but most preferably 1-12 carbon atoms, such as methylthio or ethylthio), an arylthio group (having preferably 6-20 carbon atoms, more preferably 6-16 carbon atoms, but most preferably 6-12 carbon atoms, such as phenylthio), a sulfonyl group (having preferably 1-20 carbon atoms, more preferably 1-16 carbon atoms, but most preferably 1-12 carbon atoms, such as methanesulfonyl or tosyl), a sulfinyl group (having preferably 1-20 carbon atoms, more preferably 1-16 carbon atoms, but most preferably 1-12 carbon atoms, such as methanesulfinyl) or benzenesulfinyl), a ureido group (having preferably 1-20 carbon atoms, more preferably 1-16 carbon atoms, but most preferably 1-12 carbon atoms, such as ureido, methylureido, or phenylureido), a phosphoric acid amido group (having preferably 1-20 carbon atoms, more preferably 1-16 carbon atoms, but most preferably 1-12 carbon atoms, such as diethyl phosphoric acid amido or phenyl phosphoric acid amido), a hydroxyl group, a mercapto group, a halogen atom (such as fluorine, chlorine, bromine, or iodine), a cyano group, a sulfo group, a sulfino group, a carboxyl group, a phosphono group, a nitro group, a hydroxamic acid group, a hydrazino group, a heterocyclyl, group (imidazolyl, benzimidazolyl, thiazolyl, benzothiazolyl, carbazoyl, pyridyl, furyl, piperidyl, or morpholino).

Of the above groups, those capable of forming salts such as a hydroxyl group, a mercapto group, a sulfo group, a sulfino group, a carboxyl group, a phosphono group, or a phosphino group may be in the form of salts. These substituents may be further substituted. In the case of the presence of at least two substituents, they may be the same or different. Listed as preferred substituents are an alkyl group, an aralkyl group, an alkoxy group, an aryl group, an alkylthio group, an acyl group, an acylamino group, an imino group, a sulfamoyl group, a sulfonyl group, a sulfonylamino group, a ureido group, an amino group, a halogen atom, a nitro group, a heterocyclyl group, an alkoxycarbonyl group, a hydroxy group, a sulfo group, a carbamoyl group, and a carboxyl group. Of these, more preferred are the alkyl group, the alkoxy group, the aryl group, the alkylthio group, the acyl group, the acylamino group, the imino group, the sulfonylamino group, the ureido group, the amino group, the halogen atom, the nitro group, the heterocyclyl group, the alkoxycarbonyl group, the hydroxyl group, the sulfo group, the carbamoyl group, and the carboxyl group. Of these, further more preferred are the alkyl group, the alkoxy group, the aryl group, the alkylthio group, the acylamino group, the imino group, the ureido group, the amino group, the heterocyclyl group, the alkoxycarbonyl group, the hydroxyl group, the sulfo group, the carbamoyl group, and the carboxyl group. The amidino group includes ones having a substituent. Listed as the substituents are, for example, an alkyl group (such as a methyl group, an ethyl group, a pyridylmethyl group, a benzyl group, a phenetyl group, a carboxybenzyl group, or an aminophenylmethyl group), an aryl group (such as a phenyl group, a p-tolyl group, a naphthyl group, an o-aminophenyl group, or an o-methoxyphenyl group), and a heterocyclyl group (such as 2-thiazolyl group, a 2-pyridyl group, a 3-pyridyl group, a 2-furyl group, a 3-furyl group, 2-thieno group, a 2-imidazolyl group, a benzothiazolyl group, or a carbazoyl group.

Listed as linking groups represented by J₃₁, which incorporate at least one of an oxygen atom, a sulfur atom, or a nitrogen atom are, for example, the following. They may be employed in combination.

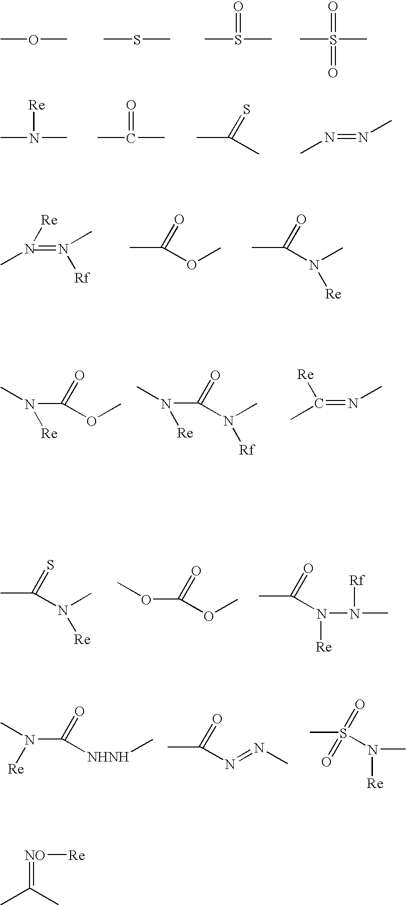

Herein, Re and Rf each are as defined for Ra-Rf in above Formula (5) in terms of content. Aromatic hydrocarbon groups represented by H³¹Ar preferably are those having 6-30 carbon atoms, but are more preferably a single ring or a condensed ring aryl group having 6-20 carbon atoms. Examples include a phenyl group and a naphthyl group, of which the phenyl group is particularly preferred. The aromatic heterocyclyl group refers to a 5- to 10-membered unsaturated heterocyclyl group containing at least one of N, O and S, and the heterocyclic ring in these groups may be a single ring or may form a condensed ring with other rings. The heterocyclic ring in such a heterocyclyl group is preferably a 5- to 6-membered aromatic cyclic ring and a benzo condensed ring thereof, is more preferably a 5- to 6-membered aromatic heterocyclic ring containing a nitrogen atom and a benzo condensed ring thereof, but is still more preferably a 5- to 6-membered heterocyclic ring containing 1-2 nitrogen atoms and a benzo condensed ring thereof.

Specific examples of the heterocyclyl group include groups which are derived, for example, from thiophene, furan, pyrrole, imidazole, pyrazole, pyridine, pyrazine, pyridazine, triazole, triazine, indole, indazole, purine, thiadiazole, oxadiazole, quinoline, phthalazine, naphthyridine, quinazoline, cinnoline, pteridine, phenanthroline, phenazine, thiazole, oxazole, benzimidazole, benzoxazole, benzothiazole, benzothiazoline, benzotriazole, tetraazaindene, or carbazole. Listed as preferred heterocyclyl groups are the groups derived from imidazole, pyrazole, pyridine, pyrazine, indole, indazole, thiadiazole, oxadiazole, quinoline, phenazine, tetrazole, thiazole, oxazole, benzimidazole, benzoxazole, benzothiazole, benzothiazoline, benzotriazole, tetraazaindene, and carbazole. Listed as more preferred groups are those derived from imidazole, pyridine, pyrazine, quinoline, phenazine, tetrazole, thiazole, benzoxazole, benzimidazole, benzothiazole, benzothiazoline, benzotriazole, and carbazole.

The aromatic hydrocarbon group represented by H³¹Ar and the aromatic heterocyclyl group may have substituents. Listed as the above substituents may be those similar to the group listed, for example, as the substituent of T₃₁, while the preferred range is also the same. These substituents may further be substituted. In the case of the presence of at least two substituents, they may be the same or different. The group represented by H³¹Ar is preferably an aromatic heterocyclyl group.

Listed as the aliphatic hydrocarbon groups represented by Ra, Rb, Rc, and Rd, aryl groups, and heterocyclyl groups may be those which are similar to specific examples of aromatic hydrocarbon groups in above T₃₁, aryl groups, and heterocyclyl group, and the preferred range is also the same. The acyl group represented by Ra-Rd includes aliphatic and aromatic groups having 1-12 carbon atoms. Specific examples include an acetyl group, a benzoyl group, a formyl group, and a pivaloyl group. Listed as nitrogen containing heterocyclyl groups which are formed by bonding between Ra and Rb, Rc and Rd, Ra and Rc or Rb and Rd are 3- to 10-membered saturated or unsaturated heterocyclyl groups (piperidyl, piperazinyl, acrydinyl, pyrrolidinyl, pyrrolyl, morpholino, or morpholinyl).

Listed as specific examples of required acid anions represented by M₃₁, which neutralize charges in the molecules, are a halogen ion (a chlorine ion, a bromine ion, or an iodine ion), a p-toluenesulfonate acid ion, a perchlorate ion, a tetrafluoroborate ion, a sulfuric acid ion, a methyl sulfate ion, an ethyl sulfate ion, a methanesulfonate ion, and a trifluoromethanesulfate ion.

Supersensitizers are employed in an amount of preferably 0.001-1.0 mol per mol of silver in a photosensitive layer incorporating organic silver salts and silver halide grains, but most preferably of 0.01-0.5 mol per mol of silver.

Suitable binders for the silver salt photothermographic material of the present invention are to be transparent or translucent and commonly colorless, and include natural polymers, synthetic resin polymers and copolymers, as well as media to form film. The binders include, for example, gelatin, gum Arabic, casein, starch, poly(acrylic acid), poly(methacrylic acid), poly(vinyl chloride), poly(methacrylic acid), copoly(styrene-maleic anhydride), coply(styrene-acrylonitrile), coply(styrene-butadiene), poly(vinyl acetals) (for example, poly(vinyl formal) and poly(vinyl butyral), poly(esters), poly(urethanes), phenoxy resins, poly(vinylidene chloride), poly(epoxides), poly(carbonates), poly(vinyl acetate), cellulose esters, poly(amides). The binders may be hydrophilic or hydrophobic.

Preferable binders for the photosensitive layer of the silver salt photothermographic dry imaging material of the present invention are poly(vinyl acetals), and a particularly preferable binder is poly(vinyl butyral), which will be detailed hereunder. Polymers such as cellulose esters, especially polymers such as triacetyl cellulose, cellulose acetate butyrate, which exhibit higher softening temperature, are preferable for an overcoating layer as well as an undercoating layer, specifically for a light-insensitive layer such as a protective layer and a backing layer. Incidentally, if desired, the binders may be employed in combination of at least two types.

Such binders are employed in the range of a proportion in which the binders function effectively. Skilled persons in the art can easily determine the effective range. For example, preferred as the index for maintaining aliphatic carboxylic acid silver salts in a photosensitive layer is the proportion range of binders to aliphatic carboxylic acid silver salts of 15:1 to 1:2 and most preferably of 8:1 to 1:1. Namely, the binder amount in the photosensitive layer is preferably from 1.5 to 6 g/m², and is more preferably from 1.7 to 5 g/m². When the binder amount is less than 1.5 g/m², density of the unexposed portion markedly increases, whereby it occasionally becomes impossible to use the resultant material.

In the present invention, it is preferable that thermal transition point temperature, after development is at higher or equal to 100° C., is from 46 to 200° C. and is more preferably from 70 to 105° C. Thermal transition point temperature, as described in the present invention, refers to the VICAT softening point or the value shown by the ring and ball method, and also refers to the endothermic peak which is obtained by measuring the individually peeled photosensitive layer which has been thermally developed, employing a differential scanning calorimeter (DSC), such as EXSTAR 6000 (manufactured by Seiko Denshi Co.), DSC220C (manufactured by Seiko Denshi Kogyo Co.), and DSC-7 (manufactured by Perkin-Elmer Co.). Commonly, polymers exhibit a glass transition point, Tg. In silver salt photothermographic dry imaging materials, a large endothermic peak appears at a temperature lower than the Tg value of the binder resin employed in the photosensitive layer. The inventors of the present invention conducted diligent investigations while paying special attention to the thermal transition point temperature. As a result, it was discovered that by regulating the thermal transition point temperature to the range of 46 to 200° C., durability of the resultant coating layer increased and in addition, photographic characteristics such as speed, maximum density and image retention properties were markedly improved. Based on the discovery, the present invention was achieved.

The glass transition temperature (Tg) is determined employing the method, described in Brandlap, et al., “Polymer Handbook”, pages from III-139 through III-179, 1966 (published by Wiley and Son Co.). The Tg of the binder comprised of copolymer resins is obtained based on the following formula.

Tg of the copolymer (in ° C.)=v₁Tg₁+v₂Tg₂+ . . . +vₙTgₙ wherein v₁, v₂, . . . vₙ each represents the mass ratio of the monomer in the copolymer, and Tg₁, Tg₂, . . . Tgₙ each represents Tg (in ° C.) of the homopolymer which is prepared employing each monomer in the copolymer. The accuracy of Tg, calculated based on the formula calculation, is ±5° C.

In the silver salt photothermographic dry imaging material of the present invention, employed as binders, which are incorporated in the photosensitive layer, on the support, comprising aliphatic carboxylic acid silver salts, photosensitive silver halide grains and reducing agents, may be conventional polymers known in the art. The polymers have a Tg of 70 to 105° C., a number average molecular weight of 1,000 to 1,000,000, preferably from 10,000 to 500,000, and a degree of polymerization of about 50 to about 1,000. Examples of such polymers include polymers or copolymers comprised of constituent units of ethylenic unsaturated monomers such as vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, and vinyl acetal, as well as vinyl ether, and polyurethane resins and various types of rubber based resins.

Further listed are phenol resins, epoxy resins, polyurethane hardening type resins, urea resins, melamine resins, alkyd resins, formaldehyde resins, silicone resins, epoxy-polyamide resins, and polyester resins. Such resins are detailed in “Plastics Handbook”, published by Asakura Shoten. These polymers are not particularly limited, and may be either homopolymers or copolymers as long as the resultant glass transition temperature, Tg is in the range of 70 to 105° C.

Listed as homopolymers or copolymers which comprise the ethylenic unsaturated monomers as constitution units are alkyl acrylates, aryl acrylates, alkyl methacrylates, aryl methacrylates, alkyl cyano acrylate, and aryl cyano acrylates, in which the alkyl group or aryl group may not be substituted. Specific alkyl groups and aryl groups include a methyl group, an ethyl group, an n-propyl group, an isopropyl group, an n-butyl group, an isobutyl group, a sec-butyl group, a tert-butyl group, an amyl group, a hexyl group, a cyclohexyl group, a benzyl-group, a chlorophenyl group, an octyl group, a stearyl group, a sulfopropyl group, an N-ethyl-phenylaminoethyl group, a 2-(3-phenylpropyloxy)ethyl group, a dimethylaminophenoxyethyl group, a furfuryl group, a tetrahydrofurfuryl group, a phenyl group, a cresyl group, a naphthyl group, a 2-hydroxyethyl group, a 4-hydroxybutyl group, a triethylene glycol group, a dipropylene glycol group, a 2-methoxyethyl group, a 3-methoxybutyl group, a 2-actoxyethyl group, a 2-acetacttoxyethyl group, a 2-methoxyethyl group, a 2-iso-proxyethyl group, a 2-butoxyethyl group, a 2-(2-methoxyethoxy)ethyl group, a 2-(2-ethoxyetjoxy)ethyl group, a 2-(2-bitoxyethoxy)ethyl group, a 2-diphenylphsophorylethyl group, an ω-methoxypolyethylene glycol (the number of addition mol n=6), an ally group, and dimethylaminoethylmethyl chloride.

In addition, employed may be the monomers described below. Vinyl esters: specific examples include vinyl acetate, vinyl propionate, vinyl butyrate, vinyl isobutyrate, vinyl corporate, vinyl chloroacetate, vinyl methoxyacetate, vinyl phenyl acetate, vinyl benzoate, and vinyl salicylate; N-substituted acrylamides, N-substituted methacrylamides and acrylamide and methacrylamide: N-substituents include a methyl group, an ethyl group, a propyl group, a butyl group, a tert-butyl group, a cyclohexyl group, a benzyl group, a hydroxymethyl group, a methoxyethyl group, a dimethylaminoethyl group, a phenyl group, a dimethyl group, a diethyl group, a β-cyanoethyl group, an N-(2-acetacetoxyethyl) group, a diacetone group; olefins: for example, dicyclopentadiene, ethylene, propylene, 1-butene, 1-pentane, vinyl chloride, vinylidene chloride, isoprene, chloroprene, butadiene, and 2,3-dimethylbutadiene; styrenes; for example, methylstyrene, dimethylstyrene, trimethylstyrene, ethylstyrene, isopropylstyrene, tert-butylstyrene, chloromethylstryene, methoxystyrene, acetoxystyrene, chlorostyrene, dichlorostyrene, bromostyrene, and vinyl methyl benzoate; vinyl ethers: for example, methyl vinyl ether, butyl vinyl ether, hexyl vinyl ether, methoxyethyl vinyl ether, and dimethylaminoethyl vinyl ether; N-substituted maleimides: N-substituents include a methyl group, an ethyl group, a propyl group, a butyl group, a tert-butyl group, a cyclohexyl group, a benzyl group, an n-dodecyl group, a phenyl group, a 2-methylphenyl group, a 2,6-diethylphenyl group, and a 2-chlorophenyl group; others include butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methyl vinyl ketone, phenyl vinyl ketone, methoxyethyl vinyl ketone, glycidyl acrylate, glycidyl methacrylate, N-vinyl oxazolidone, N-vinyl pyrrolidone, acrylonitrile, metaacrylonitrile, methylene malonnitrile, vinylidene chloride.

Of these, listed as preferable examples are alkyl methacrylates, aryl methacrylates, and styrenes. Of such polymers, those having an acetal group are preferably employed because they exhibit excellent compatibility with the resultant aliphatic carboxylic acid, whereby an increase in flexibility of the resultant layer is effectively minimized.

Particularly preferred as polymers having an acetal group are the compounds represented by Formula (6) described below.

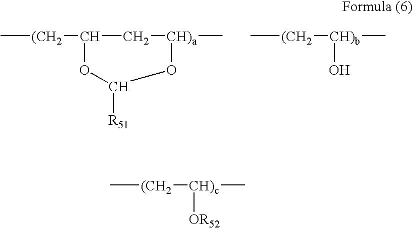

wherein R₅₁ represents a substituted or unsubstituted alkyl group, and a substituted or unsubstituted aryl group, however, groups other than the aryl group are preferred; R₅₂ represents a substituted or unsubstituted alkyl group, a substituted or unsubstituted aryl group, —COR₅₃ or —CONHR₅₃, wherein R₅₃ represents the same as defined above for R₅₁.

Alkyl groups represented by R₅₁, R₅₂, and R₅₃ preferably have from 1 to 20 carbon atoms and more preferably have from 1 to 6 carbon atoms. The alkyl groups may have a straight or branched chain, but preferably have a straight chain. Listed as such unsubstituted alkyl groups are, for example, a methyl group, an ethyl group, an n-propyl group, an isopropyl group, an n-butyl group, an isobutyl group, a t-butyl group, an n-amyl group, a t-amyl group, an n-hexyl group, a cyclohexyl group, an n-heptyl group, an n-octyl group, a t-octyl group, a 2-ethylhexyl group, an n-nonyl group, an n-decyl group, an n-dodecyl group, and an n-octadecyl group. Of these, particularly preferred is a methyl group or a propyl group. Preferred aryl groups are those having 6 to 20 carbon atoms, such as a phenyl group and a naphtyl group.

Listed as groups which can be substituted for the alkyl groups as well as the aryl groups are an alkyl group (for example, a methyl group, an n-propyl group, a t-amyl group, a t-octyl group, an n-nonyl group, and a dodecyl group), an aryl group (for example, a phenyl group), a nitro group, a hydroxyl group, a cyano group, a sulfo group, an alkoxy group (for example, a methoxy group), an aryloxy group (for example, a phenoxy group), an acyloxy group (for example, an acetoxy group), an acylamino group (for example, an acetylamino group), a sulfonamido group (for example, methanesulfonamido group), a sulfamoyl group (for example, a methylsulfamoyl group), a halogen atom (for example, a fluorine atom, a chlorine atom, and a bromine atom), a carboxyl group, a carbamoyl group (for example, a methylcarbamoyl group), an alkoxycarbonyl group (for example, a methoxycarbonyl group), and a sulfonyl group (for example, a methylsulfonyl group). When at least two of the substituents are employed, they may be the same or different. The number of total carbons of the substituted alkyl group is preferably from 1 to 20, while the number of total carbons of the substituted aryl group is preferably from 6 to 20.

R₅₂ is preferably —COR₅₃ (wherein R₅₃ represents an alkyl group or an aryl group) and —CONHR₅₃ (wherein R₅₃ represents an aryl group). “a”, “b”, and “c” each represents the value in which the weight of repeated units is shown utilizing mol percent; “a” is in the range of 40 to 86 mol percent; “b” is in the range of from 0 to 30 mol percent; “c” is in the range of 0 to 60 mol percent, so that a+b+c=100 is satisfied. Most preferably, “a” is in the range of 50 to 86 mol percent, “b” is in the range of 5 to 25 mol percent, and “c” is in the range of 0 to 40 mol percent. The repeated units having each composition ratio of “a”, “b”, and “c” may be the same or different.

Employed as polyurethane resins usable in the present invention may be those, known in the art, having a structure of polyester polyurethane, polyether polyurethane, polyether polyester polyurethane, polycarbonate polyurethane, polyester polycarbonate polyurethane, or polycaprolactone polyurethane. It is preferable that, if desired, all polyurethanes described herein are substituted, through copolymerization or addition reaction, with at least one polar group selected from the group consisting of —COOM, —SO₃M, —OSO₃M, —P═O(OM)₂, —O—P═O(OM)₂ (wherein M represents a hydrogen atom or an alkali metal salt group), —N(R₅₄)₂, —N⁺(R₅₄)₃ (wherein R₅₄ represents a hydrocarbon group, and a plurality of R₅₄ may be the same or different), an epoxy group, —SH, and —CN. The amount of such polar groups is commonly from 10⁻¹ to 10⁻⁸ mol/g, and is preferably from 10⁻² to 10⁻⁶ mol/g. Other than the polar groups, it is preferable that the molecular terminal of the polyurethane molecule has at least one OH group and at least two OH groups in total. The OH group cross-links with polyisocyanate as a hardening agent so as to form a 3-dimensinal net structure. Therefore, the more OH groups which are incorporated in the molecule, the more preferred. It is particularly preferable that the OH group is positioned at the terminal of the molecule since thereby the reactivity with the hardening agent is enhanced. The polyurethane preferably has at least three OH groups at the terminal of the molecules, and more preferably has at least four OH groups. When polyurethane is employed, the polyurethane preferably has a glass transition temperature of 70 to 105° C., a breakage elongation of 100 to 2,000 percent, and a breakage stress of 0.5 to 100 M/mm².

Polymers represented by aforesaid Formula (V) of the present invention can be synthesized employing common synthetic methods described in “Sakusan Binihru Jushi (Vinyl Acetate Resins)”, edited by Ichiro Sakurada (Kohbunshi Kagaku Kankoh Kai, 1962).

These polymer compounds may be employed individually as a binder or employed by blending of at least two types. The above-mentioned polymers are employed as a major binder in the photosensitive silver salt containing layer (being preferably a photosensitive layer) according to the present invention. The major binder, as described herein, is in such a state in which the above polymer shares at least 50 percent by weight of the entire polymers of the photosensitive silver salt containing layer. Consequently, the other polymers may be blended and then employed in an amount of less than 50 percent by weight of the entire binders.

These polymers are not particularly limited as long as polymers according to the present invention are soluble in solvents. Listed as more preferred polymers are polyvinyl acetate, polyacryl resins, and urethane resins.

In the present invention, it is known that by employing cross-linking agents in the aforesaid binders, uneven development is minimized due to the improved adhesion of the layer to the support. In addition, it results in such effects that fogging during storage is minimized and the creation of printout silver after development is also minimized.

Employed as cross-linking agents used in the present invention may be various conventional cross-linking agents, which have been employed for silver halide photosensitive photographic materials, such as aldehyde based, epoxy based, ethyleneimine based, vinylsulfone based sulfonic acid ester based, acryloyl based, carbodiimide based, and silane compound based cross-linking agents, which are described in Japanese Patent Application Open to Public Inspection No. 50-96216. Of these, preferred are isocyanate based compounds, silane compounds, epoxy compounds or acid anhydrides, as shown below.

As one of preferred cross-linking agents, isocyanate based and thioisocyanate based cross-linking agents represented by Formula (7), shown below, will now be described.
V═C═N-L-(N═C═X)ᵥ Formula (7)
wherein v represents 1 or 2; L represents an alkyl group, an aryl group, or an alkylaryl group which is a linking group having a valence of v+1; and V represents an oxygen atom or a sulfur atom.

Incidentally, in the compounds represented by aforesaid Formula (7), the aryl ring of the aryl group may have a substituent. Preferred substituents are selected from the group consisting of a halogen atom (for example, a bromine atom or a chlorine atom), a hydroxyl group, an amino group, a carboxyl group, an alkyl group and an alkoxy group.

The aforesaid isocyanate based cross-linking agents are isocyanates having at least two isocyanate groups and adducts thereof. More specifically, listed are aliphatic isocyanates, aliphatic isocyanates having a ring group, benzene diisocyanates, naphthalene diisocyanates, biphenyl isocyanates, diphenylmethane diisocyanates, triphenylmethane diisocyanates, triisocyanates, tetraisocyanates, and adducts of these isocyanates and adducts of these isocyanates with dihydric or trihydric polyalcohols.

Employed as specific examples may be isocyanate compounds described on pages 10 through 12 of JP-A No. 56-5535.

Incidentally, adducts of isocyanates with polyalcohols are capable of markedly improving the adhesion between layers and further of markedly minimizing layer peeling, image dislocation, and air bubble formation. Such isocyanates may be incorporated in any portion of the silver salt photothermographic dry imaging material. They may be incorporated in, for example, a support (particularly, when the support is paper, they may be incorporated in a sizing composition), and optional layers such as a photosensitive layer, a surface protective layer, an interlayer, an anti-halation layer, and a subbing layer, all of which are placed on the photosensitive layer side of the support, and may be incorporated in at least two of the layers.

Further, as thioisocyanate based cross-linking agents usable in the present invention, compounds having a thioisocyanate structure corresponding to the isocyanates are also useful.

The amount of the cross-linking agents employed in the present invention is in the range of 0.001 to 2.000 mol per mol of silver, and is preferably in the range of 0.005 to 0.500 mol.

Isocyanate compounds as well as thioisocyanate compounds, which may be incorporated in the present invention, are preferably those which function as the cross-linking agent. However, it is possible to obtain the desired results by employing compounds which have a v of 0, namely compounds having only one functional group.

Listed as examples of silane compounds which can be employed as a cross-linking agent in the present invention are compounds represented by Formal (1) or Formula (2), described in JP-A No. 2002-22203.

In Formulas, R₁, to R₈ each represents a straight or branched chain or cyclic alkyl group having from 1 to 30 carbon atoms, which may be substituted, (such as a methyl group, an ethyl group, a butyl group, an octyl group, a dodecyl group, and a cycloalkyl group), an alkenyl group (such as a propenyl group, a butenyl group, and a nonenyl group), an alkynyl group (such as an acetylene group, a bisacetylene group, and a phenylacetylene group), an aryl group, or a heterocyclic group (such as a phenyl group, a naphthyl group, a tetrahydropyrane group, a pyridyl group, a furyl group, a thiophenyl group, an imidazole group, a thiazole group, a thiadiazole group, and an oxadiazole group, which may have either an electron attractive group or an electron donating group as a substituent.

At least one of substituents selected from R₁, to R₈ is preferably either a non-diffusive group or an adsorptive group. Specifically, R² is preferably either a non-diffusive group or an adsorptive group.

Incidentally, the non-diffusive group, which is called a ballast group, is preferably an aliphatic group having at least 6 carbon atoms or an aryl group substituted with an alkyl group having at least 3 carbon atoms. Non-diffusive properties vary depending on binders as well as the used amount of cross-linking agents. By introducing the non-diffusive groups, migration distance in the molecule at room temperature is retarded, whereby it is possible to retard reactions during storage.

Compounds, which can be used as a cross-linking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Preferred as epoxy compounds are those represented by Formula (8) described below.

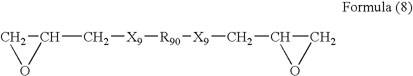

In Formula (8), the substituent of the alkylene group represented by R₉₀ is preferably a group selected from a halogen atom, a hydroxyl group, a hydroxyalkyl group, or an amino group. Further, the linking group represented by R₉₀ preferably has an amido linking portion, an ether linking portion, or a thioether linking portion. The divalent linking group, represented by X₉, is preferably —SO₂—, —SO₂NH—, —S—, —O—, or —NR₉₁—, wherein R₉₁ represents a univalent group, which is preferably an electron attractive group.

These epoxy compounds may be employed individually or in combinations of at least two types. The added amount is not particularly limited but is preferably in the range of 1×10⁻⁶ to 1×10⁻² mol/m², and is more preferably in the range of 1×10⁻⁵ to 1×10⁻³ mol/m².

The epoxy compounds may be incorporated in optional layers on the photosensitive layer side of a support, such as a photosensitive layer, a surface protective layer, an interlayer, an anti-halation layer, and a subbing layer, and may be incorporated in at least two layers. In addition, the epoxy compounds may be incorporated in optional layers on the side opposite the photosensitive layer on the support. Incidentally, when a photosensitive material has a photosensitive layer on both sides, the epoxy compounds may be incorporated in any layer.

Acid anhydrides are compounds which have at least one acid anhydride group having the structural formula:
—CO—O—CO—

The acid anhydrites are to have at least one such acid anhydride group. The number of acid anhydride groups, and the molecular weight are not limited, but the compounds represented by Formula (9) are preferred.

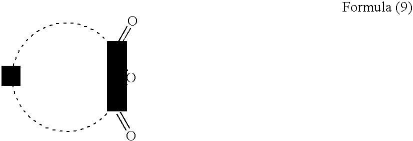

In Formula (9), Z represents a group of atoms necessary for forming a single ring or a polycyclic system. These cyclic systems may be unsubstituted or substituted. Example of substituents include an alkyl group (for example, a methyl group, an ethyl group, or a hexyl group), an alkoxy group (for example, a methoxy group, an ethoxy group, or an octyloxy group), an aryl group (for example, a phenyl group, a naphthyl group, or a tolyl group), a hydroxyl group, an aryloxy group (for example, a phenoxy group), an alkylthio group (for example, a methylthio group or a butylthio group), an arylthio group (for example, a phenylthio group), an acyl group (for example, an acetyl group, a propionyl group, or a butyryl group), a sulfonyl group (for example, a methylsulfonyl group, or a phenylsulfonyl group), an acylamino group, a sulfonylamino group, an acyloxy group (for example, an acetoxy group or a benzoxy group), a carboxyl group, a cyano group, a sulfo group, and an amino group. Substituents are preferably those which do not contain a halogen atom.

These acid anhydrides may be employed individually or in combinations of at least two types. The added amount is not particularly limited, but is preferably in the range of 1×10⁻⁶ to 1×10⁻² mol/m² and is more preferably in the range of 1×10⁻¹ to 1×10⁻³ mol/m².

In the present invention, the acid anhydrides may be incorporated in optional layers on the photosensitive layer side on a support, such as a photosensitive layer, a surface protective layer, an interlayer, an antihalation layer, or a subbing layer, and may be incorporated in at least two layers. Further, the acid anhydrides may be incorporated in the layer(s) in which the epoxy compounds are incorporated.

The photothermographic materials of the present invention form photographic images employing a heat development process and preferably incorporate, commonly in an (organic) binder matrix in a dispersed state, reducible silver sources (aliphatic carboxylic acid silver salts), photosensitive silver halide grains, silver ion reducing agents, and if desired, toners which control silver tone.

Examples of suitable toners are disclosed in RD 17029 as well as U.S. Pat. Nos. 4,123,282, 3,994,732, 3,846,136, and 4,021,249. Employed as a particularly preferred toner is phthalazinone or combination of phthalazine and phthalic acids or phthalic anhydrides. Heretofore, it has been stated that with regard to the tone of output images for medical diagnosis, for persons who read such radiographs, blue-black image tone tends to result in more accurate diagnosis of recorded images. “Blue-black image tone”, as described herein, means that images are pure black, or black images slightly tinted with blue to result in a blue-black tone. On the other hand, “warm-black image tone” means that black images are slightly tinted with brown to result in a warm-black tone.

In the present invention, in order to minimize image abrasion caused by handling prior to development as well as after thermal development, matting agents are preferably incorporated in the surface layer (on the photosensitive layer side, and also on the other side when the light-insensitive layer is provided on the opposite side across the support). The added amount is preferably from 0.1 to 30.0 percent by weight with respect to the binders.

Matting agents may be comprised of organic or inorganic materials. Employed as inorganic materials for the matting agents may be, for example, silica described in Swiss Patent No. 330,158, glass powder described in French Patent No. 1,296,995, and carbonates of alkali earth metals or cadmium and zinc described in British Patent No. 1,173,181. Employed as organic materials for the matting agents are starch described in U.S. Pat. No. 2,322,037, starch derivatives described in Belgian Patent No. 625,451 and British Patent No. 981,198, polyvinyl alcohol described in Japanese Patent Publication No. 44-3643, polystyrene or polymethacrylate described in Swiss Patent No. 330,158, acrylonitrile described in U.S. Pat. No. 3,079,257, and polycarbonate described in U.S. Pat. No. 3,022,169.

The average particle diameter of the matting agents is preferably from 0.5 to 10.0 μm, and is more preferably from 1.0 to 8.0 μm. Further, the variation coefficient of the particle size distribution of the same is preferably less than or equal to 50 percent, is more preferably less than or equal to 40 percent, and is most preferably from less than or equal to 30 percent.

Herein, the variation coefficient of the particle size distribution refers to the value expressed by the formula described below.
((Standard deviation of particle diameter)/(particle diameter average))×100

Addition methods of the matting agent according to the present invention may include one in which the matting agent is previously dispersed in a coating composition and the resultant dispersion is applied onto a support, and the other in which after applying a coating composition onto a support, a matting agent is sprayed onto the resultant coating prior to completion of drying. Further, when a plurality of matting agents is employed, both methods may be used in combination.

Listed as materials of the support employed in the silver salt photothermographic dry imaging material of the present invention are various kinds of polymers, glass, wool fabric, cotton fabric, paper, and metal (for example, aluminum). From the viewpoint of handling as information recording materials, flexible materials, which can be employed as a sheet or can be wound in a roll, are suitable. Accordingly, preferred as supports in the silver salt photothermographic dry imaging material of the present invention are plastic films (for example, cellulose acetate film, polyester film, polyethylene terephthalate film, polyethylene naphthalate film, polyamide film, polyimide film, cellulose triacetate film or polycarbonate film). Of these, in the present invention, biaxially stretched polyethylene terephthalate film is particularly preferred. The thickness of the supports is commonly from about 50 to about 300 μm, and is preferably from 70 to 180 μm.

In the present invention, in order to minimize static-charge buildup, electrically conductive compounds such as metal oxides and/or electrically conductive polymers may be incorporated in composition layers. The compounds may be incorporated in any layer, but are preferably incorporated in a subbing layer, a backing layer, and an interlayer between the photosensitive layer and the subbing layer. In the present invention, preferably employed are electrically conductive compounds described in columns 14 through 20 of U.S. Pat. No. 5,244,773.

The silver salt photothermographic dry imaging material of the present invention comprises a support having thereon at least one photosensitive layer. The photosensitive layer may only be formed on the support. However, it is preferable that at least one light-insensitive layer is formed on the photosensitive layer. For example, it is preferable that for the purpose of protecting a photosensitive layer, a protective layer is formed on the photosensitive layer, and in order to minimize adhesion between photosensitive materials as well as adhesion in a wound roll, a backing layer is provided on the opposite side of the support. As binders employed in the protective layer as well as the backing layer, polymers such as cellulose acetate, cellulose acetate butyrate, which has a higher glass transition point from the thermal development layer and exhibit abrasion resistance as well as distortion resistance are selected from the aforesaid binders. Incidentally, for the purpose of increasing latitude, one of the preferred embodiments of the present invention is that at least two photosensitive layers are provided on the one side of the support or at least one photosensitive layer is provided on both sides of the support.

In the silver salt photothermographic dry imaging material of the present invention, in order to control the light amount as well as the wavelength distribution of light which transmits the photosensitive layer, it is preferable that a filter layer is formed on the photosensitive layer side or on the opposite side, or dyes or pigments are incorporated in the photosensitive layer.

Employed as dyes may be compounds, known in the art, which absorb various wavelength regions according to the spectral sensitivity of photosensitive materials.

For example, when the silver salt photothermographic dry imaging material of the present invention is used as an image recording material utilizing infrared radiation, it is preferable to employ squarylium dyes having a thiopyrylium nucleus (hereinafter referred to as thiopyriliumsquarylium dyes) and squarylium dyes having a pyrylium nucleus (hereinafter referred to as pyryliumsquarylium dyes), as described in Japanese Patent Application No. 11-255557, and thiopyryliumcroconium dyes or pyryliumcroconium dyes which are analogous to the squarylium dyes.

Incidentally, the compounds having a squarylium nucleus, as described herein, refers to ones having 1-cyclobutene-2-hydroxy-4-one in their molecular structure. Herein, the hydroxyl group may be dissociated. Hereinafter, all of these dyes are referred to as squarylium dyes.

Incidentally, preferably employed as the dyes are compounds described in Japanese Patent Publication Open to Public Inspection No. 8-201959.

It is preferable to prepare the silver salt photothermographic dry imaging material of the present invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer (for example, a photosensitive layer and a protective layer) is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight, the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method. Of these, more preferred is the pre-weighing type coating system called an extrusion coating method. The aforesaid extrusion coating method is suitable for accurate coating as well as organic solvent coating because volatilization on a slide surface, which occurs in a slide coating system, does not occur. Coating methods have been described for coating layers on the photosensitive layer side. However, the backing layer and the subbing layer are applied onto a support in the same manner as above.

It is preferable that coated silver weight in the present invention is appropriately selected depending on the intended functions of the photosensitive materials. When the function is to produce medical images, the coated silver weight is preferably 0.1-2.5 g/m², but is more preferably 0.5-1.5 g/m². In the above coated silver weight, the weight derived from silver halide is preferably 2-18 percent with respect to the total silver weight, but is more preferably 3-15 percent.

Further, in the present invention, the number of coated silver halide grains, having a grain diameter (being a sphere equivalent grain diameter) of at least 0.01 μm, is preferably from 1×10¹⁴ to 1×10¹⁸ grains/m², and is more preferably from 1×10¹⁵ to 1×10¹⁷.

Further, the coated weight of aliphatic carboxylic acid silver salts of the present invention is from 10⁻¹⁷ to 10⁻¹⁵ g per silver halide grain having a diameter (being a sphere equivalent grain diameter) of at least 0.01 μm, and is more preferably from 10⁻¹⁶ to 10⁻¹⁴ g.

When coating is carried out under conditions within the aforesaid range, from the viewpoint of maximum optical silver image density per definite silver coverage, namely covering power as well as silver image tone, desired results are obtained.

In the present invention, development conditions vary depending on employed devices and apparatuses, or means. Typically, an imagewise exposed silver salt photothermographic dry imaging material is heated at optimal high temperature. It is possible to develop a latent image formed by exposure by heating the material at relatively high temperature (for example, from about 100 to about 200° C.) for a sufficient period (commonly from about 1 second to about 2 minutes). When heating temperature is less than or equal to 100° C., it is difficult to obtain sufficient image density within a relatively short period. On the other hand, at more than or equal to 200° C., binders melt so as to be transferred to rollers, and adverse effects result not only for images but also for transportability as well as processing devices. Upon heating the material, silver images are formed through an oxidation-reduction reaction between aliphatic carboxylic acid silver salts (which function as an oxidizing agent) and reducing agents. This reaction proceeds without any supply of processing solutions such as water from the exterior.

Heating may be carried out employing typical heating means such as hot plates, irons, hot rollers and heat generators employing carbon and white titanium. When the protective layer-provided silver salt photothermographic dry imaging material of the present invention is heated, from the viewpoint of uniform heating, heating efficiency, and workability, it is preferable that heating is carried out while the surface of the side provided with the protective layer comes into contact with a heating means, and thermal development is carried out during the transport of the material while the surface comes into contact with the heating rollers.

When the silver salt photothermographic dry imaging material of the present invention is exposed, it is preferable to employ an optimal light source for the spectral sensitivity provided to the aforesaid photosensitive material. For example, when the aforesaid photosensitive material is sensitive to infrared radiation, it is possible to use any radiation source which emits radiation in the infrared region. However, infrared semiconductor lasers (at 780 nm and 820 nm) are preferably employed due to their high power, as well as ability to make photosensitive materials transparent.

In the present invention, it is preferable that exposure is carried out utilizing laser scanning. Employed as the exposure methods are various ones. For example, listed as a firstly preferable method is the method utilizing a laser scanning exposure apparatus in which the angle between the scanning surface of a photosensitive material and the scanning laser beam does not substantially become vertical.

“Does not substantially become vertical”, as described herein, means that during laser scanning, the nearest vertical angle is preferably from 55 to 88 degrees, is more preferably from 60 to 86 degrees, and is most preferably from 70 to 82 degrees.

When the laser beam scans photosensitive materials, the beam spot diameter on the exposed surface of the photosensitive material is preferably at most 200 μm, and is more preferably at most 100 mm, and is more preferably at most 100 μm. It is preferable to decrease the spot diameter due to the fact that it is possible to decrease the deviated angle from the verticality of laser beam incident angle. Incidentally, the lower limit of the laser beam spot diameter is 10 μm. By performing the laser-beam scanning exposure, it is possible to minimize degradation of image quality according to reflection light such as generation of unevenness analogous to interference fringes.

Further, as the second method, exposure in the present invention is also preferably carried out employing a laser scanning exposure apparatus which generates a scanning laser beam in a longitudinal multiple mode, which minimizes degradation of image quality such as generation of unevenness analogous to interference fringes, compared to the scanning laser beam in a longitudinal single mode.

The longitudinal multiple mode is achieved utilizing methods in which return light due to integrated wave is employed, or high frequency superposition is applied. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

Incidentally, in the recording methods of the aforesaid first and second embodiments, it is possible to suitably select any of the following lasers employed for scanning exposure, which are generally well known, while matching the use. The aforesaid lasers include solid lasers such as a ruby laser, a YAG laser, and a glass laser; gas lasers such as a HeNe laser, an Ar ion laser, a Kr ion laser, a CO₂ laser a CO laser, a HeCd laser, an N₂ laser, and an excimer laser; semiconductor lasers such as an InGaP laser, an AlGaAs laser, a GaASP laser, an InGaAs laser, an InAsP laser, a CdSnP₂ laser, and a GaSb laser; chemical lasers; and dye lasers of these, from the viewpoint of maintenance as well as the size of light sources, it is preferable to employ any of the semiconductor lasers having a wavelength of 600 to 1,200 nm.

The beam spot diameter of lasers employed in laser imagers, as well as laser-image setters, is commonly in the range of 5 to 75 μm in terms of a short axis diameter and in the range of 5 to 100 μm in terms of a long axis diameter. Further, it is possible to set a laser beam scanning rate at the optimal value for each photosensitive material depending on the inherent speed of the silver salt photothermographic dry imaging material at laser transmitting wavelength and the laser power.

### EXAMPLES

The present invention will now be described with reference to examples, however embodiments are not limited thereto. Further, “%” in the examples is “% by weight” and “parts” are “parts by weight” unless otherwise specified.

### Example 1

<Preparation of Support>

A corona discharge treatment of 0.5 kV·A·min/m² was applied on one side of a PET film base (at a thickness of 175 μm) tinted with blue at a density of 0.170. Thereafter, by employing Subbing Layer Liquid Coating Composition A described below, Sublayer a was applied onto the resulting film base to result in a dried layer thickness of 0.2 μm. Further, after applying corona discharge of 0.5 kV·A·min/m² onto the other side, by employing Subbing Liquid Coating Composition B described below, Sublayer b was applied onto the resulting film base to result in a dried layer thickness of 0.1 μm.

Thereafter, the resulting coating was subjected to heat treatment at 130° C. for 15 minutes in a heat treating type oven.

(Subbing Liquid Coating Composition A)

A mixture of 270 g of a butyl acrylate/t-butyl acrylate/styrene/2-hidroxyethyl acrylate (at a ratio of 30/20/25/25%) copolymer latex liquid (solid 30%) was mixed with 0.6 g of a surface active agent (UL-1) and 0.5 g of methylcellulose. Separately, 1.3 g of silica particles (SILOID 350, produced by Fuji Silysia Chemical Ltd.) was added to 100 g of water, and the resulting mixture was dispersed for 30 minutes employing an ultrasonic homogenizer (ULTRASONIC GENERATOR, produced by ALEX Corporation, at a frequency of 25 kHz and 600 W). Subsequently, the resulting dispersion was added to the above mixture, and the volume of the resulting mixture was made to 1,000 ml by the addition of water, and designated as Subbing Liquid Coating Composition A.

(Colloidal Tin Oxide Dispersion)

A uniform solution was prepared by dissolving 65 g of stannic chloride hydrate in 2,000 ml of a water/ethanol mixture. Subsequently, the above solution was boiled, whereby co-precipitates were obtained. The resulting precipitates were collected via decantation and washed several times with distilled water. After confirming the absence of chloride ions by dripping silver nitrate into the distilled water which had been used to wash the precipitates, the total Volume was made to 2,000 ml by adding distilled water to the washed precipitates. Furthers 40 ml of 30 percent ammonia water was added and the resulting aqueous solution was concentrated by evaporation via heating so that the total volume was reduced to 470 ml, whereby a colloidal tin oxide dispersion was prepared. (Subbing Liquid Coating Composition B)

Mixed were 37.5 g of the above colloidal tin oxide dispersion, 3.7 g of a butyl acrylate/t-butyl acrylate/styrene/2-hydroxyethyl acrylate (20/30/27/28% respectively)) copolymer latex liquid (solids 30%), 14.8 g of a butyl acrylate/styrene/glycidyl methacrylate (40/20/20% respectively) copolymer latex liquid (solids 30%), and 0.1 g of Surface Active Agent UL-1, and the total volume was made to 1,000 ml by the addition of water. The resulting mixture was designated as Subbing Liquid Coating Composition B.

(Liquid Rear Side Coating Composition)

While stirring, added to 830 g of methyl ethyl ketone (MEK) were 84.2 g of cellulose acetate butyrate (CAB381-20, produced by Eastman Chemical Co.) and 4.5 g of a polyester resin (VITEL PE2200B, produced by Bostic Co.), and then dissolved. Subsequently, 0.30 g of Infrared Dye 1 was added. Further, 4.5 g of a fluorine based surface active agent (SURFRON KH40, produced by Asahi Glass Co., Ltd.) dissolved in 43.2 g of methanol and 2.3 g of a fluorine based surface active agent (MEGAFAG F120K, produced by Dainippon Ink and Chemicals, Inc.) were added, and the resulting mixture was stirred until dissolution was complete. Finally, 75 g of silica (SILOID 64X6000, produced by W. R. Grace Co.) which had been dispersed at a concentration of 1% in MEK, employing a dissolver type homogenizer, was added while stirring, whereby a liquid coating composition for the rear surface was prepared.

(Rear Surface Coating)

The rear surface liquid coating composition prepared as above was applied onto Subbing Layer b of the above support to result in a dried layer thickness of 3.5μ, employing an extrusion coater, and subsequently dried. Drying was performed over 5 minutes employing drying air at 100° C. and a dew point of 10° C.

<Preparation of Photosensitive Silver Halide Emulsion A>

| Solution (A1) | | |
|---|---|---|
| Phenylcarbamoylated gelatin | 88.3 | g |
| Compound AO (10% aqueous methanol solution) | 10 | ml |
| Potassium bromide | 0.32 | g |
| Water to make | 5429 | ml |
| Solution (B1) | | |
| 0.67 mol/L aqueous silver nitrate solution | 2635 | ml |
| Solution (C1) | | |
| Potassium bromide | 51.55 | g |
| Potassium iodide | 1.47 | g |
| Water to make | 660 | ml |
| Solution (D1) | | |
| Potassium bromide | 154.9 | g |
| Potassium iodide | 4.41 | g |
| Iridium chloride (1% solution) | 0.93 | ml |
| Water to make | 1982 | ml |
| Solution (E1) | | |
| 0.4 mol/L aqueous potassium bromide solution | amount to reach the | |
| | silver potential below | |
| Solution (F1) | | |
| Potassium hydroxide | 0.71 | g |
| Water to make | 20 | ml |
| Solution (G1) | | |
| 56% acetic acid | 18.0 | ml |
| Solution (H1) | | |
| Sodium carbonate anhydride | 1.72 | g |
| Water to make | 151 | ml |

AO: HO(CH₂CH₂O)ₙ(CH(CH₃)CH₂O)₁₇(CH₂CH₂O)ₘH (m + n = 5 − 7)

While employing the stirrer described in Japanese Patent Publication Nos. 58-58288 and 58-58289, one fourth of Solution (B1) and all Solution (C1) were added to Solution (A1) over 4 minutes and 45 seconds, employing a double-jet method, while controlling the total of amount, at a temperature of 30° C. and a pAg of 8.09, whereby nuclei were formed. After one minute, all of Solution (F1) was added. During the above addition, the pAg was appropriately controlled employing Aqueous Solution (E1). After an elapse of 6 minutes, the remaining three quarter of Solution (B1) and all of Solution (D1) were added over 14 minutes and 15 seconds employing a double-jet method, while controlling the temperature at 30° C. and the pAg at 8.09. After stirring for 5 minutes, the temperature was increased to 40° C., and all of Solution (G1) was added, whereby a silver halide emulsion was precipitated. Thereafter, the supernatant was removed while leaving 2,000 ml of the precipitate, and then 10 L of water was added. After stirring, the silver halide emulsion was re-precipitated. The supernatant was removed while leaving 1,500 ml of the precipitate, and then 10 L of water was added. After stirring, a silver halide emulsion precipitated. After removing the supernatant while leaving 1,500 ml of the precipitate, Solution (H1) was added. The resulting mixture was heated to 60° C. and stirred for an additional 120 minutes. Finally, the pH was controlled to 5.8 and water was added so that the total weight was 1,162 g per mol of silver, whereby an emulsion was prepared. The resulting emulsion was composed of monodispersed cubic silver iodobromide grains at an average grain size of 0.040 μm, a grain size variation coefficient of 12 percent, and a [100] plain ratio of 92 percent.

Subsequently, 240 ml of Sulfur Sensitizer S-5 (being a 0.5% methanol solution) was added and Au-5 was further added in an amount of 1/20 mol of the above sensitizer, and while stirring, chemical sensitization was performed at 55° C. for 120 minutes. The resulting emulsion was designated as Photosensitive Silver Halide Emulsion A.

<Preparation of Aliphatic Carboxylic Acid Salt Powder A>

At 80° C., dissolved in 4,720 ml of pure water were 130.8 g of behenic acid, 67.7 g of arachidic acid, 43.6 g of stearic acid, and 2.3 of palmitic acid. Subsequently, 540.2 ml of a 1.5 mol/L aqueous sodium hydroxide solution was added and 6.9 ml of concentrated nitric acid was added. Thereafter, the resulting mixture was cooled to 55° C., whereby a fatty acid sodium solution was obtained. Subsequently, while maintaining the temperature of the above fatty acid sodium solution at 55° C., 45.3 g of above Photosensitive Silver Halide Emulsion A and 450 ml of pure water were added and the resulting mixture was stirred for 5 minutes.

Subsequently, 702.6 ml of 1 mol/L silver nitrate solution was added over 2 minutes, and the resulting mixture was stirred for 10 minutes, whereby an aliphatic carboxylic acid silver salt dispersion was obtained. The resulting aliphatic carboxylic acid silver salt dispersion was placed in a water washing vessel. Deionized water was added while stirring. Thereafter, the resulting mixture was allowed to stand so that the aliphatic carboxylic acid silver salt dispersion was separated and floated up. Subsequently, the water-soluble salts in the lower portion were removed. Thereafter, washing with deionized water was repeated until the electrical conductivity of the effluent reached 50 μS/cm, and then centrifugal dehydration was conducted. The resulting cake-shaped aliphatic carboxylic acid silver salt was dried employing an air flow drier system, FLASH JET DRYER (produced by Seihin Kikaku Co.) while controlling operating conditions such as the nitrogen gas ambience and the hot air temperature at the inlet of the drier, until the moisture content reached 0.1%, whereby Aliphatic Carboxylic Acid Silver Salt Powder A was prepared. The water content of the aliphatic carboxylic acid silver salt composition was determined employing an infrared moisture meter.

<Preparation Preliminary Dispersion A>

Dissolved in 1,457 g of MEK was 14.57 g of a polyvinyl butyral resin (being B-79, produced by Solcia Co.). While stirring the resulting mixture employing dissolver type homogenizer DISPERMAT TYPE CA-40M (produced by VMA-GETZMANN Co.), 500 g of Aliphatic Carboxylic Acid Silver Salt Powder A was gradually added and thoroughly blended, whereby Preliminary Dispersion A was obtained.

<Preparation of Photosensitive Emulsion A>

Above Preliminary Dispersion A was fed to a media type homogenizer DISPERMAT TYPE SL-C12 (produced by VMA-GETZMANN Co.) in which 0.5 mm diameter zirconia beads (TORECERUM, produced by Toray Co.) were placed to fill 80% of the interior volume and dispersed at a peripheral rate of 8 m/second, whereby Photosensitive Emulsion A was obtained.

<Preparation of Stabilizer Solution>

Dissolved in 4.97 g of methanol were 1.0 g of a stabilizer and 0.31 g of potassium acetate, whereby a stabilizer solution was prepared.

<Preparation of Infrared Sensitizing Dye Solution A>

In a darkened place, dissolved in 31.3 ml of MEK were 19.2 mg of Infrared Sensitizing Dye 1, 1.488 g of 2-chlorobeinzoic acid, 2.779 g of Stabilizer 2, and 65 mg of 5-methyl-2-mercaptobenzimidazole, whereby Infrared Sensitizing Dye Solution A was prepared.

<Preparation of Additive Solution a>

Dissolved in 110 g of MEK were 1.5×10-2 mol of a silver ion reducing agent (being the compound described in Table 1), a leuco dye (in the amount described in Table 1), 1.54 g of 4-methylphthalic acid, and 0.48 g of Infrared Dye 1, and the resulting solution was designated as Additive Solution a.

<Preparation of Additive Solution b>

Dissolved in 40.9 g of MEK were 3.56 g of antifoggants 2 and 40.9 g of phthalazine, the resulting solution of which was designated as Additive Solution b.

<Preparation of Photosensitive Layer Liquid Coating Composition A>

While stirring, under an ambience of inert gas (97% of nitrogen), a mixture consisting of 50 g of above Photosensitive Emulsion A and 15.11 g of MEK was maintained at 21° C. Subsequently, 390 μl of Antifoggant 1 (being a 10% methanol solution) was added and the resulting mixture was stirred for one hour. Further, 494 μl of calcium bromide (being a 10% methanol solution) was added and stirring was conducted for 20 minutes. Subsequently, 167 ml of Stabilizer Solution was added and the resulting mixture was stirred for 10 minutes. Thereafter, 1.32 g of above Infrared Sensitizing Dye Solution A was added and the resulting mixture was stirred for one hour. Then, the temperature was decreased to 13° C. and stirring was performed for 30 minutes. While maintaining the resulting mixture at 13° C., 13.31 g of the polyvinyl butyral resin (being B-79, described above) was added and the resulting mixture was stirred for another 30 minutes. Thereafter, 1.084 g of tetrachlorophthalic acid (being a 9.4% MEK solution) was added and stirred was for 15 minutes. Further, while continuing stirring, Additive Solution a (weighed so that the silver ion reducing agent and the leuco dye reached the addition amount described in Table 1), 1.6 ml of a 10% MEK solution of DESMODULE N3300 (being an aliphatic isocyanate, produced by Mobay Co.), and 4.27 g of Additive Solution b were successively added and stirred, whereby Photosensitive Layer Liquid Coating Composition was obtained.

<Preparation of Matting Agent Dispersion>

Dissolved in 42.5 g of MEK was 7.5 g of cellulose acetate butyrate (CAB171-15, Produced by Eastman Chemical Co.), and 5 g of calcium carbonate (SUPER-PFLEX 200, produced by Speciality Mineral Co.) was added to the resulting solution. The resulting mixture was dispersed at 8,000 rpm for 30 minutes, employing a dissolver type homogenizer, whereby a matting agent dispersion was obtained.

<Preparation of Surface Protective Layer Liquid Coating Composition>

While stirring 865 g of MEK, 96 g of cellulose acetate butyrate (CAB171-15, produced by the company immediately above), 4.5 g of polymethyl methacrylic acid (PARALOID A-21, produced by Rohm & Haas Co.), 1.5 g of a vinylsulfone compound (VSC), 1.0 g of benzotriazole, and 30 g of a fluorine based surface active agent (SURFRON KH40, also produced by the company immediately above) were added and then dissolved. Subsequently, 30 g of the above matting agent dispersion was added and the resulting mixture was stirred, whereby a surface protective layer liquid coating composition was realized.

<Preparation of Photothermographic Material Samples>

Photosensitive Layer Liquid Coating Composition A and Surface Protective Later Liquid Coating Composition were subjected to simultaneously multilayered coating onto Subbing Layer a, employing a prior art extrusion type coater. The coating was performed so that the photosensitive layer resulted in a coated silver amount of 1.5 g/m² and the protective layer resulted in a dried layer thickness of 2.5 μm. Thereafter, drying was performed for 10 minutes employing drying air at a temperature of 75° C. and a dew point of 10° C., whereby Samples 101-120 were obtained.

The chemical structures of the compounds employed in Example 1 are shown below. 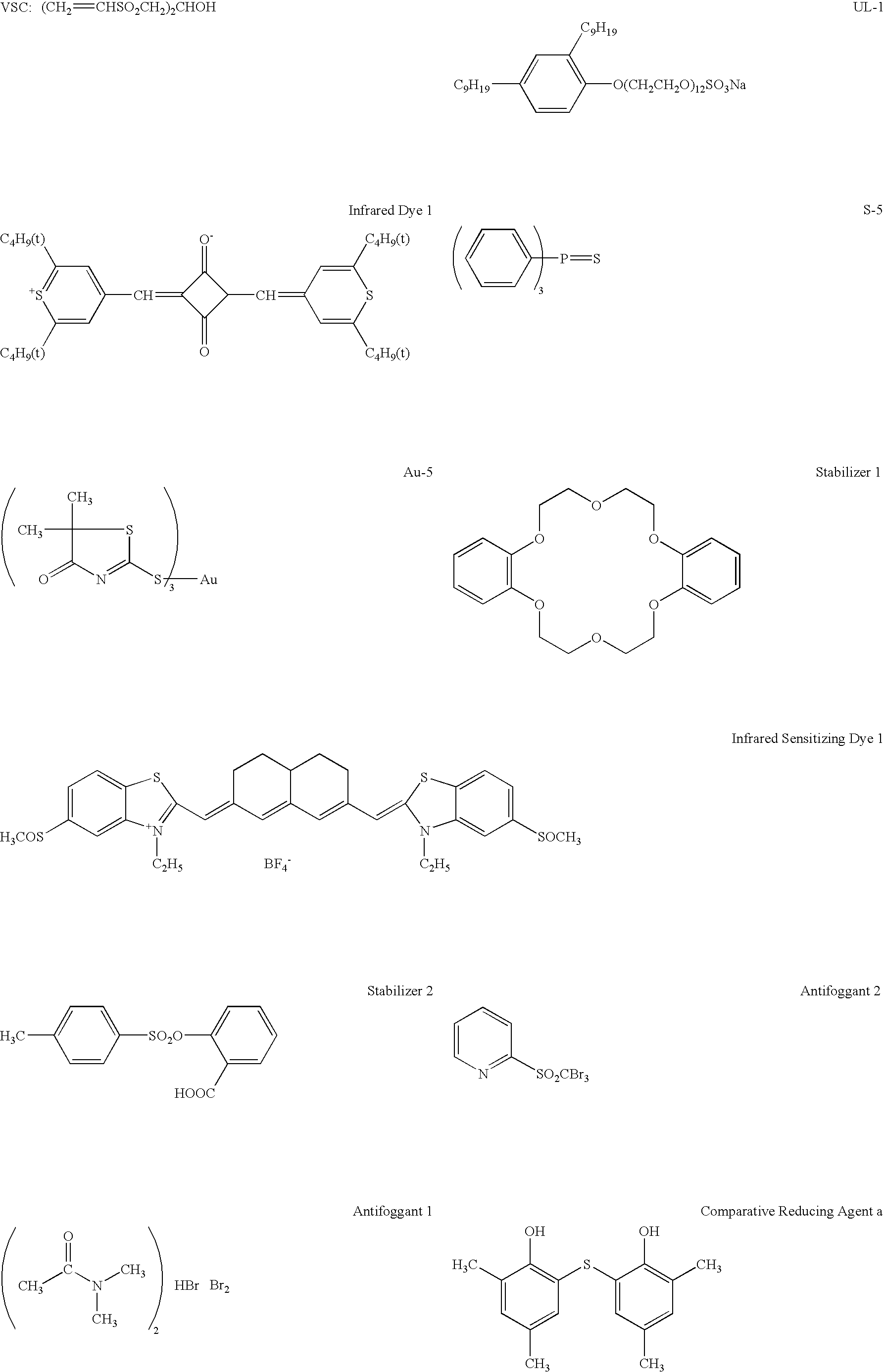 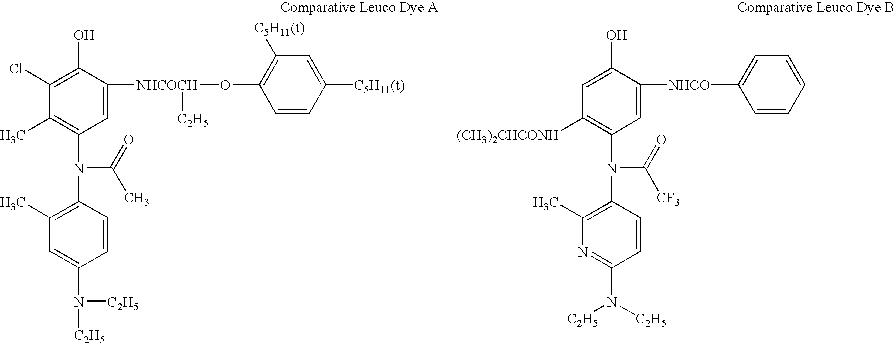
<Exposure to Light and Photographic Processing>

The emulsion side of each of the samples prepared as above was subjected to laser scanning exposure employing an exposure unit in which the exposure light source employing a semiconductor laser which was subjected to a longitudinal multimode at wavelengths of 810 nm and 814 nm at high frequency superposition. During the above exposure, the angle of the exposed surface of the sample to the exposure laser beam was set at 75 degrees, whereby images were formed. By such action, compared to the case in which the above angle was set at 90 degrees, images which exhibited more uniformity and unexpectedly, the desired sharpness, were obtained.

Thereafter, employing an automatic processor incorporating a heating drum, heat development was performed at 123° C. for 13.5 seconds so that the protective layer of samples was brought into contact with the drum surface. During the above operation, exposure and development was performed in a room maintained at 25° C. and 50 percent relative humidity.

<Performance Evaluation>

Images prepared as above were evaluated as follows.

<<Photographic Speed, Fog, and Maximum Density>>

Density of each image was determined employing a Macbeth densitometer (TD-904), and a characteristic curve was prepared in which the abscissa represented the exposure amount and the ordinate represented image density. The reciprocal of the ratio of the exposure amount, which was required to result in a density which was 1.0 higher than the unexposed portion, was defined as photographic speed. Further, minimum density (fog) and maximum density were determined. The photographic speed was represented by a relative value when the photographic speed of Sample 101 was 100.

<<Tone>>

Tone of each image was observed and a 5-rank evaluation was performed based on the criteria below. In terms of commercial viability, rank 4 or higher is preferred.

5: tone was blue-black and no redness was noted

4: tone was not blue-black, but redness was barely noted

3: partial redness was slightly noted

2: wholly, redness was slightly noted

1: on first viewing, redness was noted

<<Image Retention Property>>

Based on the method below, the image density variation ratio of the maximum and minimum density portions of each image was determined.

<<Image Retention Property of Minimum Density Portion>

Each sample, which had been subjected to heat development employing the same method which was applied to the determination method of the above photographic speed, fog, and maximum density, was arranged in an ambience of 45° C. and 55 percent relative humidity so that a commercially available fluorescent lamp resulted in an illuminance on the sample surface of 500 lux, and such exposure was continued for three days. Minimum density (D₂) of the sample which had been exposed to the fluorescent lamp and minimum density (D₁) of the sample which had not been exposed to the fluorescent lamp were determined respectively, and a minimum density variation ratio (in percent) was calculated based on the following formula. The resulting values were employed as a scale of image retention property. As the numerical value approached, 100, the image retention property was improved.
Minimum density variation ratio D₂/D₁×100 (in percent)<
<Image Retention Property of Maximum Density Portion>>

Each sample, which had been subjected to heat development employing the same method which was applied to the determination of the minimum density variation ratio, was allowed to stand at an ambience of 25° C. and 45° C. for three days. Thereafter, each of the maximum densities was determined, and the image density variation ratio was determined based on the following formula. The resulting values were employed as a scale of image retention property. As the value approached, the image retention property was improved.
Image density variation ratio=maximum density after storage at 45° C./maximum density after storage at 25° C.×100 (percent)

Table 1 shows the results.

TABLE 1

| | | | | | | | | Image Retention | | |
|---|---|---|---|---|---|---|---|---|---|---|
| Sample | Reducing | Leuco Dye | | | Maximum | Minimum | | Property | | |
| No. | Agent | (CL) | *3 | *4 | Density | Density | Tone | *5 | *6 | Tone Change |
| 101 *1 | 1-3 | — | — | 100 | 100 | 0.25 | 2 | 80 | 125 | 1 |
| 102 *1 | 1-5 | — | — | 98 | 97 | 0.27 | 2 | 75 | 130 | 2 |
| 103 *1 | 1-3 | Comparison A | 0.03 | 99 | 105 | 0.35 | 3 | 80 | 140 | 3 |
| 104 *1 | 1-5 | Comparison B | 0.03 | 98 | 102 | 0.38 | 4 | 85 | 155 | 2 |
| 105 *1 | Comparison a | 1 | 0.01 | 100 | 102 | 0.22 | 4 | 85 | 160 | 2 |
| 106 *2 | 1-1 | 1 | 0.01 | 115 | 100 | 0.14 | 5 | 100 | 120 | 5 |
| 107 *2 | 1-1 | 3 | 0.01 | 110 | 102 | 0.16 | 5 | 99 | 130 | 5 |
| 108 *2 | 1-1 | 5 | 0.03 | 111 | 101 | 0.15 | 5 | 98 | 123 | 5 |
| 109 *2 | 1-1 | 13 | 0.01 | 108 | 103 | 0.17 | 5 | 95 | 130 | 4 |
| 110 *2 | 1-3 | 1 | 0.01 | 109 | 100 | 0.16 | 5 | 96 | 125 | 5 |
| 111 *2 | 1-3 | 3 | 0.01 | 108 | 101 | 0.15 | 5 | 97 | 120 | 5 |
| 112 *2 | 1-3 | 5 | 0.01 | 110 | 102 | 0.16 | 5 | 95 | 130 | 5 |
| 113 *2 | 1-3 | 22 | 0.05 | 110 | 103 | 0.17 | 4 | 94 | 120 | 4 |
| 114 *2 | 1-5 | 1 | 0.01 | 101 | 101 | 0.15 | 5 | 97 | 120 | 5 |
| 115 *2 | 1-5 | 12 | 0.03 | 110 | 102 | 0.16 | 5 | 96 | 130 | 5 |
| 116 *2 | 1-5 | 27 | 0.05 | 105 | 101 | 0.18 | 5 | 95 | 125 | 4 |
| 117 *2 | 1-17 | 5 | 0.01 | 110 | 100 | 0.17 | 5 | 95 | 130 | 5 |
| 118 *2 | 1-17 | 15 | 0.03 | 115 | 101 | 0.16 | 5 | 96 | 130 | 5 |
| 119 *2 | 1-18 | 1 | 0.01 | 105 | 102 | 0.17 | 5 | 97 | 125 | 5 |
| 120 *2 | 1-18 | 15 | 0.20 | 110 | 103 | 0.20 | 5 | 98 | 138 | 4 |

*1: (Comparative Example),
*2: (Present Invention),
*3: CL/Reducing Agent (mol ratio),
*4: Photographic Speed,
*5: Image Density Variation Ratio,
*6: Minimum Density Variation Ratio

As is seen from Table 1, the photothermographic materials of the present invention resulted in preferable tone, as well as in desired photographic speed, higher maximum density and less fog, compared to the comparative examples, and further, when exposure is performed employing a laser scanning exposure device, the photographic speed and maximum density of output images were markedly more stable against variation of oscillating wavelengths.

### Example 2

<Preparation of PET Support>

By employing terephthalic acid and ethylene glycol, PET of an intrinsic viscosity IV of 0.66 (determined at 25° C. in phenol/tetrachloroethane at a 6/4 weight ratio) was prepared based on a conventional method. The resulting PET was pelletized and subsequently dried at 130° C. over 4 hours. The dried pellets were melted at 300° C., subsequently extruded from a T type die, rapidly cooled, and then heat-fixed, whereby a non-stretched film to result in a film thickness of 175 μm was prepared. The resulting film was subjected to longitudinal stretching by a factor of 3.3, employing rollers which differed the peripheral speed and subsequently was subjected to lateral stretching by a factor of 4.5, employing a tenter. During stretching, temperatures were 110° C. and 130° C., respectively. Thereafter, heat fixing was performed at 240° C. for 20 seconds, and subsequently, relaxation by 4 percent in the lateral direction was performed at the same temperature. Thereafter, the tenter chuck portion was trimmed and both edges were subjected to a knurling treatment. The resulting film was wound at 39.2×10⁴ Pa (4 kg/cm²), whereby a roll of the film, at a film thickness of 175 μm, was obtained.

<Surface Corona Treatment>

Both sides of a support were treated at room temperature at 20 m/minute, employing a solid state corona treatment device (Model 6KVA, produced by Pillar Co.). Based on reading values of electric current and voltage, it was found that a treatment of 0.375 kV·A·minute/m² was applied to the support. During this treatment, treatment frequency was 9.6 kHz and the gap between the electrode and the dielectric roller was 1.6 mm.

<Preparation of Subbed Support>

First, each liquid coating composition of the photosensitive layer side subbing layer, rear surface first layer, and rear surface second layer, having the compositions below was prepared.

The photosensitive layer side subbing layer liquid coating composition was applied onto one side (being the photosensitive layer-side) of the PET support subjected to the above corona discharge treatment to result in a wet coating amount of 6.6 ml/m², employing a wire bar, and then dried at 180° C. for 5 minutes. Thereafter, the first layer liquid coating compositing was applied onto the rear side (being the rear surface) to result in a wet coating amount of 5.7 ml/m², employing a wire bar and then dried at 180° C. for 5 minutes, and further, the second layer liquid coating composition was applied onto the resulting first layer to result in a wet coating amount of 7.7 ml/m², employing a wire bar and then dried at 180° C. for 6 minutes, whereby a subbed support was prepared.

(Photosensitive Layer Side Subbing Layer Liquid Coating Composition)

| | | |
|---|---|---|
| PESRESIN A-515GB (30% solution) produced | 234 | g |
| by Takamatsu Resin Co.) | | |
| 10% polyethylene glycol monononyl phenyl | 21.5 | g |
| ether (at an average ethylene oxide | | |
| number of 8.5) solution | | |
| Minute polymer particles (MP-1000 at an | 0.91 | g |
| average particle diameter of 0.4 μm, | | |
| produced by Soken Chemistry Co.) | | |
| Distilled water | 744 | ml |

(Rear Surface First Layer Liquid Coating Composition)

| | | |
|---|---|---|
| Styrene/butadiene (at a ratio of 68/32%) | 158 | g |
| copolymer latex (solids 40%) | | |
| 2,4-dichloro-6-hydroxy-s-triazine sodium salt | 20 | g |
| (8% aqueous solution) | | |
| Sodium laurylbenzenesulfonate (1% aqueous | 10 | ml |
| solution) | | |
| Distilled water | 854 | ml |

(Rear Surface Second Layer Liquid Coating Composition)

| | | |
|---|---|---|
| SnO₂/SbO (being a 17% dispersion at a weight | 84 | g |
| ratio of 9/1, an average particle | | |
| diameter of 0.038 μm | | |
| Gelatin (10% aqueous solution) | 89.2 | g |
| 2% aqueous METROSE TC-5 (produced by Shin-Etsu | 8.6 | g |
| Chemical Co.) solution | | |
| Minute polymer particles (MP-1000, produced by | 0.01 | g |
| Soken Chemistry Co.) | | |
| Sodium dodecylbenzenesulfate (1% aqueous | 10 | ml |
| solution) | | |
| Sodium hydroxide (1% aqueous solution) | 6 | ml |
| PROXEL (produced by ICI) | 1 | ml |
| Distilled water | 805 | ml |

<Preparation of Rear Surface Liquid Coating Composition>
<Preparation of Minute Basic Precursor Solid Particle Dispersion (a)>

Mixed with 220 ml of distilled water were 64 g of a basic precursor (Compound 11), 28 g of diphenylsulfone, and 10 g of surface active agent, DEMOL N (produced by Kao Corp.), and the resulting mixture was subjected to bead dispersion employing a sand mill (1/4 GALLON SAND GRINDER MILL, produced by Imex Co.), whereby Minute Basic Precursor Solid Particle Dispersion (a) at an average particle diameter of 0.2 μm was obtained.

<Preparation of Minute Solid Dye Particle Dispersion>

Mixed with 305 ml of distilled water were 9.6 g of a cyanine dye (Compound 13) and 8 g of sodium p-dodecybenzenesulfonate, and the resulting mixture was subjected to bead dispersion employing a sand mill (1/4 GALLON SAND GRINDER MILL, produced by the above company), whereby a minute solid dye particle dispersion at an average particle diameter of 0.2 μm was obtained.

<Preparation of Antihalation Layer Liquid Coating Composition>

Mixed with 844 ml of water were 17 g of gelatin, 9.6 g of polyacrylamide, 70 g of above Minute Basic Precursor Solid Particle Dispersion (a), 56 g of above minute solid dye particle dispersion, 1.5 g of minute monodispersed polymethyl methacrylate particles (at an average particle size of 8 μm and a particle diameter standard deviation of 0.4), 0.03 g of benzisothiazoline, 2.2 g of sodium polyethylene sulfonate, 0.2 g of a blue dye (Compound 14), 3.9 of a yellow dye (Compound 15), whereby an antihalation layer liquid coating composition was obtained.

<Preparation of Rear Surface Protective Layer Liquid Coating Composition>

Mixed in a vessel maintained at 40° C. were 50 g of gelatin, 0.2 g of sodium polystyrenesulfonate, 2.4 g of N,N-ethylenebis(vinylsufoneacetamide), 1 g of sodium t-octylphenoxyethoxyethanesulfonate, 30 mg of benzisothiazoline, 37 mg of fluorine based surface active agent (F-1), 0.15 g of fluorine based surface active agent (F-4), 8.8 g of acrylic acid/ethyl acrylate copolymer (copolymerization weight ratio 5/95), 0.6 g of AEROSOL OT (produced by American Cyanamid Co.), 1.8 g of fluid paraffin emulsion in terms of fluid paraffin, and 950 ml of water. The resulting mixture was designated as a rear surface protective layer liquid coating composition.

<Preparation of Silver Halide Emulsion 1>

In a stainless steel vessel, added to 1,421 ml of distilled water were 3.1 ml of a 1% potassium bromide solution, and further 3.5 ml of a 0.5 mol/L sulfuric acid and 31.7 g of phthalated gelatin. While stirring, added over 45 seconds to the resulting mixture maintained at 30° C. were, at a constant flow rate, Solution A prepared in such a manner that 22.22 g of silver nitrate was added to distilled water and the total volume was made to 95.4 ml and Solution B prepared by dissolving 15.3 g of potassium bromide and 0.8 g of potassium iodide in 97.4 ml of distilled water. Thereafter, 10 ml of a 3.5% aqueous hydrogen peroxide solution was added, and further, 10.8 ml of a 10% aqueous benzimidazole solution was added. Separately, Solution C was prepared in such a manner that 51.86 g of silver nitrate was dissolved in distilled water and the total volume was made to 317.5 ml and Solution D was prepared in such a manner that 44.2 g of potassium bromide and 2.2 g of potassium iodide were dissolved in distilled water and the total volume was made to 400 ml. All of Solution C was added to the above solution over 20 minutes at a constant flow rate, while Solution D was added employing a controlled double-jet method while maintaining the pAg at 8.1. Potassium iridium-(III) hexachloride salt was added to reach 1×10⁻⁴ mol per mol of silver 10 minutes after the initiation of addition of Solutions C and D. Further, an aqueous potassium iron(II) tetracyanide salt solution was added to reach 3×10⁻⁴ Mol per mol of silver 5 seconds after the completion of the addition of Solution C. The pH was controlled to 3.8 by employing 0.5 mol/L sulfuric acid, stirring was terminated, and a coagulation/desalting/washing process was performed. The pH was controlled to 5.9 employing 0.5 mol/L sodium hydroxide, whereby a silver halide dispersion at a pAg of 8.0 was prepared.

While stirring, added to the above silver halide dispersion was 5 ml of a 0.34% 1,2-benzisothiazoline-3-one methanol solution. After 40 minutes, Spectral Sensitizing Dyes A and B (at a mol ratio of 1:1) in the form of a methanol solution was added at a total amount of the spectral sanitizing dyes of 1.2×10⁻³ mol per mol of silver. After one minute, the resulting mixture was heated to 47° C., and 20 minute after raising the temperature, a sodium benzenesulfonate methanol solution was added in an amount of 7.6×10⁻⁵ mol per mol of silver, and further 5 minutes after, Tellurium Sensitizer C in the form of a methanol solution was added in an amount of 2.9×10⁻⁴ mol per mol of silver. The resulting mixture underwent ripening for 91 minutes. Thereafter, 1.3 ml of a 0.8% N,N′-dihydroxy-N″-diethylmelamine methanol solution was added, and further, after 4-minutes, a 5-methyl-2-mercaptobenzimidazole methanol solution was added in an amount of 4.8×10⁻³ mol per mol of silver and a 1-phenyl-2-heptyl-5-mercapto-1,3,4-triazole methanol solution was added in an amount of 4×10⁻³ mol per mol of silver, whereby Silver Halide Emulsion 1 was prepared. Grains in the prepared silver halide emulsion were iodobromide silver halide grains at an average sphere equivalent diameter of 0.042 μm, which uniformly incorporated 3.5 mol % of iodine of a sphere equivalent variation coefficient of 20%. The grain size was determined in such a manner that employing an electron microscope, the average size of 1,000 grains was obtained.

<Preparation of Silver Halide Emulsion 2>

Silver Halide Emulsion 2 was prepared in the same manner as silver Halide Emulsion 1, except that the liquid temperature during-grain formation was changed from 30° C. to 47° C., Solution B was changed in such a manner that 15.9 g of potassium bromide was dissolved in 97.4 ml of distilled water, Solution D was changed in such a manner that 45.8 g of potassium bromide was dissolved in 400 ml of distilled water, the addition duration of Solution C was changed to 30 minutes, and potassium iron(II) hexacyanate was omitted. Then coagulation/desalting/washing/dispersion was performed in the same manner as Silver Halide Emulsion 1. Further, spectral sensitization, chemical sensitization, and the addition of 1-phenyl-2-heptyl-5-mercapto-1,3,4-triazole were performed in the same manner as for Silver Halide Emulsion 1, except that the total added amount of Spectral Sensitizing Dyes A and B at a mol ratio of 1:1 in the form of a methanol solution was changed to 7.5×10-4 mol, the added amount of Tellurium Sensitizer C was changed to 1.1×10⁻⁴ mol per mol of silver, and the added amount of 1-phenyl-2-heptyl-5-mercapto-1,3,4-triazole was changed to 3.3×10⁻³ per mol of silver, whereby Silver Halide Emulsion 2 was obtained. The grains in Silver Halide Emulsion 2 were pure silver bromide cubic grains of an average sphere equivalent diameter of 0.080 μm and a sphere equivalent variation coefficient of 20%.

<Preparation of Silver Halide Emulsion 3>

Silver Halide Emulsion 3 was prepared in the same manner as for Silver Halide Emulsion 1, except that the temperature of the liquid composition during grain formation was changed from 30° C. to 27° C. Further, coagulation/desalting/washing/dispersion was performed in the same manner as for Silver Halide Emulsion 1. Silver Halide Emulsion 3 was obtained in the same manner as Silver Halide Emulsion 1, except that the total added amount of Sensitizing Dyes A and B at a mol ratio of 1:1 in the form of a solid dispersion (being an aqueous gelatin solution) was changed to 6×10⁻³ mol per mol of silver and the added amount of Tellurium Sensitizer C was changed to 5.2×10⁻⁴ mol per mol of silver. Silver Halide Emulsion 3 was formed of iodobromide silver halide grains of an average sphere equivalent diameter of 0.034 μm, which uniformly incorporated 3.5 mol % of iodine of a sphere equivalent variation coefficient of 20%.

<Preparation of Mixed Emulsion A for Liquid Coating Composition>

Mixed were 70% of Silver Halide Emulsion 1, 15% of Silver Halide Emulsion 2, and 15% Silver Halide Emulsion 3, and benzothiazolium iodide in the form of a 1% aqueous solution was added in an amount of 7×10-3 mol per mol of silver. Further, water was added so that the silver halide content per kg of the mixed emulsion for a liquid coating composition became 38.2 g in terms of silver.

<Preparation of Fatty Acid Silver Dispersion>.

Mixed were 87.6 kg of behenic acid (EDENOR C22-85R, produced by Henkel Co.), 423 L of distilled water, 49.2 L of a 5 mol/L aqueous sodium hydroxide solution, and 120 L of t-butanol, and the resulting mixture was then stirred at 75° C. for one hour, whereby a sodium behenate solution was prepared. Separately, 206.2 L of an aqueous solution (at a pH of 4.0) incorporating 40.4 kg of silver nitrate was prepared and maintained at 10° C. A reaction vessel, charged with 635 L of distilled water and 30 L of t-butanol, was maintained at 30° C., and while vigorously stirring, all the above sodium behenate solution and all the aqueous silver nitrate solution were added at a constant flow rate over 93 minutes 15 seconds and 90 minutes, respectively. During the above addition, only the aqueous silver nitrate solution was added over 11 minutes after the initiation of the addition of the aqueous silver nitrate solution, and thereafter, the addition of the sodium behenate solution was initiated. Subsequently, only the sodium behenate solution was added for 14 minutes 15 seconds after the addition of the aqueous silver nitrate solution. During the addition, the temperature in the reaction vessel was maintained at 30° C., and the exterior temperature was controlled so that the temperature of the liquid composition remained constant. Further, the piping path of the addition system of the sodium behenate solution was heated by circulating heated water in the outer portion of a double wall pipe, and the liquid temperature at the tip of the addition nozzle was controlled to 75° C. The temperature of the piping of the addition system of the aqueous silver nitrate solution was maintained by circulating cold water in the outer portion of the double wall pipe. The addition locations of the sodium behenate solution and the aqueous silver nitrate solution were arranged to be symmetrical with respect to the stirring shaft as a center, and the height was controlled to not come into contact with the liquid reaction composition.

After completion of the addition of the sodium behenate solution, the resulting mixture was stirred for 20 minutes at the same temperature, and then heated to 35° C. over 30 minutes. Thereafter, ripening was performed for 210 minutes. Immediately after ripening, solids were collected employing centrifugal filtration and washing was performed until the electrical conductivity of water, which was employed to filter the solids, reached 30 μS/cm, whereby a fatty acid silver salt was obtained. The resulting solids were stored without drying in the form of a wet cake.

The shape of silver behenate particles were evaluated based on images captured by an electron microscope and found to be scaly crystals of “a” of 0.14 μm, “b” of 0.4 μm, and “c” of 0.6 μm in terms of average values, as well as at an average aspect ratio of 5.2, an average sphere equivalent diameter of 0.5 μm, and a sphere equivalent diameter variation coefficient of 15%. Further, the above coefficients “a”, “b”, and “c” were determined as follows. When the shape of the organic acid silver salt particles approximated a rectangular, side lengths were designated as “a”, “b”, and “c”, in order from the shortest length.

To the wet cake, equivalent to 260 kg of dried solids, 19.3 kg of polyvinyl alcohol (PVA-217, produced by Kuraray Co.) and water were added. After bringing the total weight to 1,000 kg, the resulting mixture was subjected to form a slurry, employing dissolver blades and further subjected to preliminary dispersion, employing a pipe line mixer (Type PM-10, produced by Mizuho Industry Co.). Subsequently, the original liquid composition which had been subjected to preliminary dispersion was dispersed three times, employing a homogenizer (MICROFLUIDIZER M-610, produced by Microfluidex International Corporation, employing a Z type interaction chamber) while controlling the pressure to 123.6 MPa, whereby a silver behenate dispersion was obtained. The cooling operation was performed as follows. A hose type heat exchangers were mounted prior to and after the interaction chamber and a dispersion temperature 18° C. was maintained by controlling the temperature of the coolant.

<Preparation of Reducing Agent Dispersion>

Added to 26.0 mol of silver ion reducing agent (the compound described in Table 2) and 10 kg of a 20% aqueous modified polyvinyl alcohol (POVAL MP203, produced by Kuraray Co.) was 16 kg of water. The resulting mixture was stirred vigorously and was subjected to form a slurry. The resulting slurry was transported employing a diaphragm pump and was dispersed for 3 hours and 30 minutes, employing a horizontal bead mill (UVM-2, produced by Imex Co.) loaded with zirconia beads at an average diameter 0.5 mm. Thereafter, 0.2 g of benzisothiazolinone sodium salt and water were added to result in a concentration of the reducing agent of 25%, whereby a reducing agent dispersion was prepared. The reducing agent particles incorporated in the reducing agent dispersion prepared as above exhibited a median diameter of 0.42 μm and a maximum particle diameter of at most 2.0 μm. The resulting reducing agent dispersion was filtered employing a polypropylene filter at a pore diameter 10.0 μm to remove foreign matter such as dust, and was then stored.

<Preparation of Leuco Dye (CL) Dispersion>

Added to the leuco dye (the amount and compound described in Table 2) and 150 g of a 10% aqueous modified polyvinyl alcohol (POVAL MP-203, produced by the company immediately above) solution was 75 g of water. The resulting mixture was stirred vigorously and was subjected to form a slurry. The resulting slurry was subjected to bead dispersion at 1,500 rpm for 10 hours, employing 0.5 mm zirconia beads and a sand mill (1/4 GALLON SAND GRINDER, produced by the company described above), whereby minute solid particle dispersion at a median diameter of 0.4 μm were obtained. The resulting dispersion was filtered employing a polypropylene filter at a pore diameter of 3.0 μm to remove foreign matter such as dust, and was then stored.

<Preparation of Development Accelerator-1 Dispersion>

Added to 75 g of Development Accelerator-1 and 150 g of a 1-0% aqueous modified polyvinyl alcohol (POVAL MP-203, produced by the above) solution was 75 g of water. The resulting mixture was stirred vigorously and was subjected to form a slurry. The resulting slurry was subjected to bead dispersion at 1,500 rpm for 10 hours, employing 0.5 mm zirconia beads and a sand mill (1/4 GALLON SAND GRINDER, produced by the company described above), whereby a minute solid particle dispersion at a median diameter of 0.35 μm was obtained. The resulting dispersion was filtered employing a polypropylene filter at a pore diameter 3.0 μm to remove foreign matter such as dust, and was then stored.

<Preparation of Hydrogen Bonding Compound-2 Dispersion>

Added to 10 kg of Hydrogen Bonding Compound-1 (tri(4-t-butylphenyl)phosphine oxide) and 20 kg of a 10% aqueous modified polyvinyl alcohol (POVAL MP203, produced by the company described above) was 10 kg of water. The resulting mixture was stirred vigorously and was subjected to form a slurry. The resulting slurry was transported employing a diaphragm pump and was dispersed for 3 hours and 30 minutes, employing a horizontal bead mill (UVM-2, produced by Imex Co.) loaded with zirconia beads at an average diameter 0.5 mm. Thereafter, 0.2 g of benzisothiazolinone sodium salt and water were added to result in a concentration of Hydrogen Bonding Compound-2 of 22%, whereby Hydrogen Bonding Compound-2 dispersion was prepared. The particles incorporated in the Hydrogen Bonding Compound-2 dispersion exhibited a median diameter of 0.35 μm and a maximum particle diameter of at most 1.5 μm. The resulting dispersion was filtered employing a polypropylene filter at a pore diameter 3.0 μm to remove foreign matter such as dust, and was then stored.

<Preparation of Organic Polyhalogen Compound-1 Dispersion>

Added to 10 kg of Organic Polyhalogen Compound-1 (being 2-tribromomethanesulfonylnaphthalene), 10 kg of a 20% aqueous modified polyvinyl alcohol (POVAL MP203, produced by the company described above), and 0.4 kg of a 20% aqueous sodium tri-i-propylnaphthalenesulfonate solution, was 16 kg of water. The resulting mixture was stirred vigorously and was subjected to form a slurry. The resulting slurry was transported employing a diaphragm pump and was dispersed for 5 hours, employing a horizontal bead mill (UVM-2, produced by the company described above) loaded with zirconia beads at an average diameter 0.5 mm. Thereafter, 0.2 g of benzisothiazolinone sodium salt and water were added to result in a 23.5% concentration of Organic Polyhalogen Compound-1, whereby an Organic Polyhalogen Compound-1 dispersion was prepared. The Organic Polyhalogen Compound-1 particles incorporated in the resulting dispersion, prepared as above, exhibited a median diameter of 0.36 μm and a maximum particle diameter of at most 2.0 μm. The resulting dispersion was filtered employing a polypropylene filter at a pore diameter 10.0 μm to remove foreign matter such as dust, and was then stored.

<Preparation of Organic Polyhalogen Compound-2 Dispersion>

Added to 10 kg of Organic Polyhalogen Compound-1 (being tribromomethane sulfonylbenzene), 10 kg of a 20% aqueous modified polyvinyl alcohol (POVAL MP203, produced by the company described above), and 0.4 kg of a 20% aqueous sodium tri-i-propylnaphthalenesulfonate solution, was 14 kg of water. The resulting mixture was stirred vigorously and was subjected to form a slurry. The resulting slurry was transported employing a diaphragm pump and dispersed for 5 hours, employing a horizontal bead mill (UVM-2, produced by the company described above) loaded with zirconia beads at an average diameter 0.5 mm. Thereafter, 0.2 g of benzisothiazolinone sodium salt and water were added to result in a 26% concentration of Organic Polyhalogen Compound-2, whereby an Organic Polyhalogen Compound-2 dispersion was prepared. The Organic Polyhalogen Compound-2 particles incorporated in the resulting dispersion prepared as above exhibited a median diameter of 0.41 μm and a maximum particle diameter of at most 2.0 μm. The resulting Organic Polyhalogen Compound-2 dispersion was filtered employing a polypropylene filter at a pore diameter 10.0 μm to remove foreign matter such as dust, and was then stored.

<Preparation of Phthalazine Compound-1 Solution>

Dissolved in 174.57 kg of water was 8 kg of modified polyvinyl alcohol (MP203, produced by the company described above). Subsequently, added to the resulting solution were 3.15 kg of a 20% aqueous sodium tri-i-propylnaphthalenesulfonate solution and 14.28 kg of a 70% aqueous Phthalazine Compound-1 (being 6-i-propylphthalazine) solution, whereby a 5% Phthalizine Compound-1 solution was obtained.

<Preparation of Aqueous Mercapto Compound-1 Solution>

Dissolved in 993 g of water was 7 g of Mercapto Compound-1 (1-(3-sulfophenyl)-5-mercaptotetrazole sodium salt) and a 0.7% aqueous solution was prepared.

<Preparation of Pigment-1 Dispersion>

Added to 250 g of water were 64 g of Pigment-1 (C.I. Pigment Blue 60) and 6.4 g of DEMOL N, produced by Kao Corp. The resulting mixture was stirred vigorously and was subjected to form a slurry. Subsequently, 8.00 g of 0.5 mm average diameter zirconia beads were prepared and were charged into a vessel together with the slurry. Dispersion was performed for 25 hours, employing a homogenizer (1/4 G SAND GRINDER MILL, produced by the company described above), whereby Pigment-1 dispersion was prepared. The average diameter of the pigment particles incorporated in the pigment dispersion was 0.21 μm.

<Preparation of SBR Latex Liquid Composition>

SBR latex (at a Tg of 23° C.) was prepared as follows. By employing ammonium persulfate as a polymerization initiator and an anionic surface active agent as an emulsifier, 70.5 parts of styrene, 26.5 parts of butadiene, and 3 parts of acrylic acid underwent emulsion polymerization. Subsequently, the resulting product was subjected to aging at 80° C. for 8 hours. Thereafter, the temperature was lowered to 40° C., and the pH was adjusted to 7.0 by the addition of ammonia water. Further, SANDET BL, produced by Sanyo Chemical Co. was added to result in a 0.22% concentration. Subsequently, the pH was controlled to 8.3 by the addition of a 5% aqueous sodium hydroxide solution and further, the pH was controlled to 8.4 by the addition of ammonia water. During such addition, the mol ratio of Na⁺ and NH₄⁺, both employed, was 1:2.3. In addition, 0.15 ml of a 7% aqueous benzisothiazolinone sodium salt was added, whereby an SBR latex liquid composition was prepared.

The resulting latex was styrene/butadiene/acrylic acid (70.5/26.5/3 respectively) exhibiting characteristics of a Tg of 23° C., an average particle diameter of 0.1 μm, a concentration of 43%, a moisture content of 0.6% at 25° C. and 60% relative humidity, an ionic conductivity of 4.2 mS/cm (determined at 25° C. by an electrical conductivity meter CM-30S produced by DKK-TOA Corp., employing the latex stock composition (43%)), and a pH of 8.4. SBR latexes which differed in Tg were prepared employing the above method while appropriately varying the ratio of styrene and butadiene.

<Preparation of Emulsion Layer (Photosensitive Layer) Liquid Coating Composition>

Successively added to 1,000 g of the fatty acid silver dispersion, prepared as above, were 125 ml of water, 204 g of a reducing agent dispersion, a leuco dye dispersion (the type and amount are described in Table 2), 27 g of Pigment-1 Dispersion, 82 g of Organic Polyhalogen Compound Dispersuion-1, 40 g of Organic Polyhalogen Compound-2, 173 g of Phthalazine Compound-1,1,82 g of the SBR latex (at a Tg of 20.5° C.) liquid composition, and then 158 g of Mixed Silver Halide Emulsion A was added immediately prior to coating. The resulting mixture was stirred a vigorously and the resulting mixture was fed without any modification to a coating die for coating. The viscosity of the above emulsion layer liquid coating composition was determined via TYPE B VISCOSIMETER available from Tokyo Keiki Co., Ltd., resulting in 40 mPa·s at 40° C. (No. 1 rotor 60 rpm). The viscosities of the liquid coating composition at 25° C. and shear rates of 0.1, 1, 10, 100, and 1,000 (1/second) were 1, 500, 220, 70, 40, and 20 mPa·s, respectively.

Added to 772 g of a 10% aqueous polyvinyl alcohol (PVA A-205, produced by Kurary Co., Ltd.), 5.3 g of a 20% pigment dispersion, and 226 g of a 27% methyl methacrylate/butyl acrylate/hydroxyethyl methacrylate/acrylic acid copolymer (at a ratio of 64/9/20/5/2% respectively) latex liquid composition were 2 ml of 5% aqueous AEROSOL OT (produced by the company described above) solution, and 10.5 ml a 20% aqueous diammonium phthalate solution, and then water was added so that the total weight reached 880 g. Further, the pH was controlled to 7.5 by the addition of sodium hydroxide, whereby an interlayer liquid coating composition was prepared. The above interlayer liquid coating composition was fed to a coating die to result in 10 ml/m². The viscosity of the liquid coating composition at 40° C. was determined employing TYPE B VISCOSIMETER (No. 1 rotor at 60 rpm), resulting in 21 mPa·s.

<Preparation of Emulsion Surface Protective Layer First Layer Liquid Coating Composition>

Dissolved in water was 64 g of an inert gelatin, and added to the resulting solution were 80 g of a 27.5% methyl acrylate/styrene/butyl acrylate/hydroxyethyl methacrylate/acrylic acid copolymer (at a ratio of 64/9/20/5/2% respectively), 23 ml of a 10% phthalic acid methanol solution, 23 ml of a 10% aqueous methylphthalic acid solution, 28 ml of a 0.5 mol/L sulfuric acid, 5 ml of a 5% aqueous AEROSOL OT (produced by the company described above), 0.5 g of phenoxyethanol, and 0.1 g of benzisothiazolinone. Subsequently, the total weight was made to 750 g by the addition of water, whereby a liquid coating composition was prepared. Just prior to coating, 26 ml of a 4% aqueous chromium alum solution was added and stirred employing a static mixer. The resulting mixture was fed to a coating die to result in 18.6 ml/m². The viscosity of the liquid coating composition was determined at 40° C., employing TYPE B. VISCOSIMETER (No. 1 rotor, 60 rpm), resulting in 17 mPa·s.

(Preparation of Photothermographic Materials>

The antihalation layer liquid coating composition and the rear surface protective layer liquid coating composition were simultaneously multilayer-coated onto the rear surface of the above subbed support to result in a coated weight of minute solid dye particles of 0.04 g/m², and a gelatin coated weight of 1.7 g/m², respectively, and subsequently dried, whereby a rear layer was prepared. Onto the surface opposite to the rear surface, simultaneous multilayer-coated employing a slide bead coating system were an emulsion layer, an interlayer, a protective layer first layer and a protective layer second layer, in the above order from the subbed surface, and the resulting coating was dried, whereby Samples 201-215 were prepared. During the above operation, the emulsion layer and the interlayer were maintained at 31° C., the protective layer first layer at 36° C., and the protective layer second layer at 37° C. The coated amount (in g/m²) of each compound in the emulsion layer is described below.

| | |
|---|---|
| Silver behenate | 6.19 |
| Reducing agent | type and amount described in Table 2 |
| Leuco dye | type and amount described in Table 2 |
| Pigment (C.I. Pigment Blue 60) | 0.032 |
| Polyhalogen Compound-1 | 0.46 |
| Polyhalogen Compound-2 | 0.25 |
| Phthalazone Compound-1 | 0.21 |
| SBR latex | 11.1 |
| Mercapto Compound-1 | 0.002 |
| Silver Halide (in terms of Ag) | 0.145 |

Coating and drying conditions were as follows. Coating was performed at a rate of 160 m/minute, the gap between the tip of the coating die and the support was set to 0.10-0.30 mm, and the pressure in the pressure-lowered room was set to 196-992 Pa lower than atmospheric pressure. The support was subjected to charge elimination employing an ionic air flow. In the following chilling zone, the coating was chilled employing an air flow at a dry bulb temperature of 10-20° C. Thereafter, non-contact conveyance was performed and drying was performed in a helically floating dryer employing air flow at a dry bulb temperature of 23-45° C. and a wet bulb temperature of 15-21° C. After drying, the coating was rehumidified at 25° C. and 40-60% relative humidity. Thereafter, the layer surface was heated to 70-90° C., and after heating, the layer surface was cooled to 25° C.

The degree of matting of the resulting photothermographic materials resulted in 550 seconds on the photosensitive layer surface and 130 seconds on the rear surface in terms of Bekk smoothness. The determination of the pH on the surface on the photosensitive layer side resulted in 6.0.

Chemical structures of the compounds employed in Example 2 are shown below. 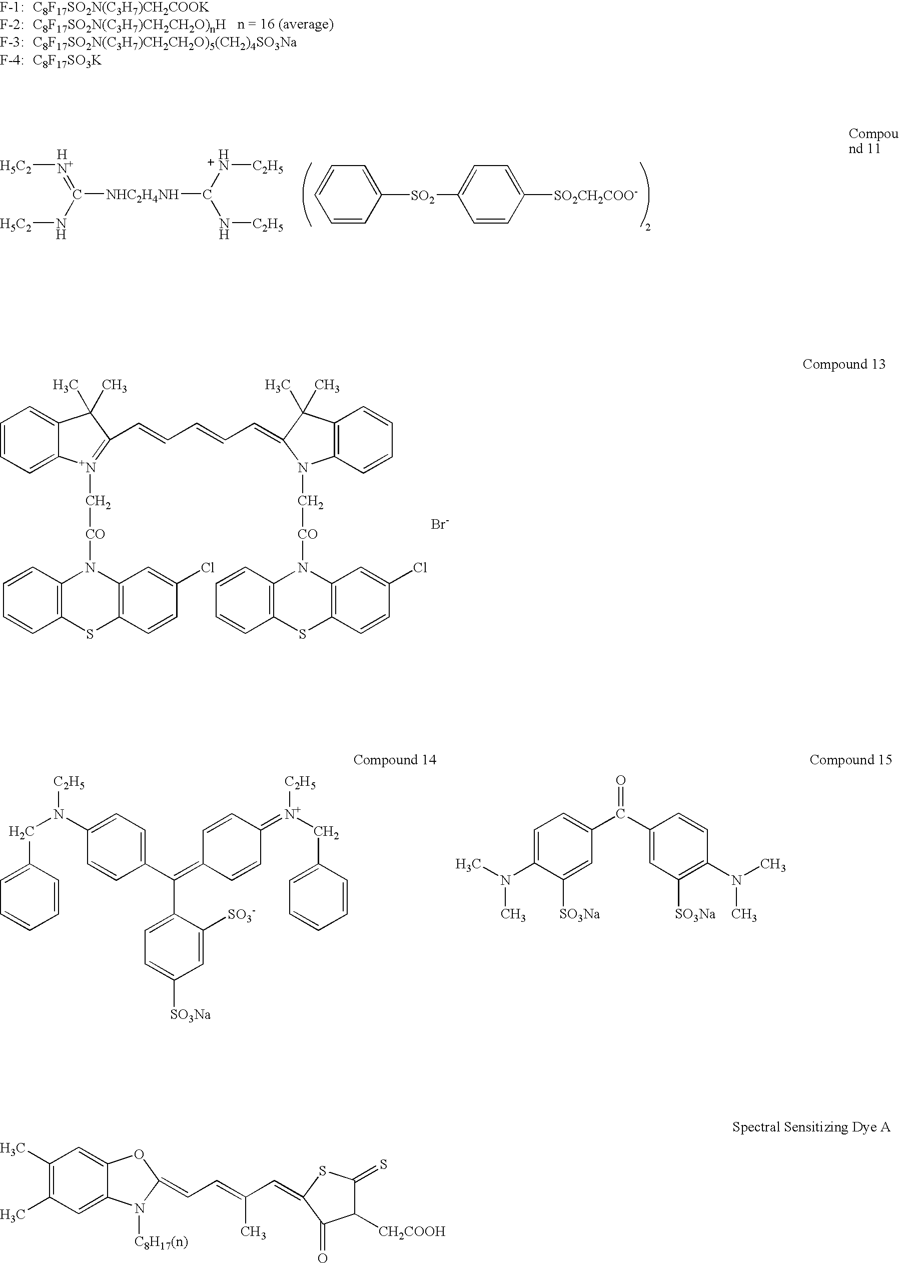 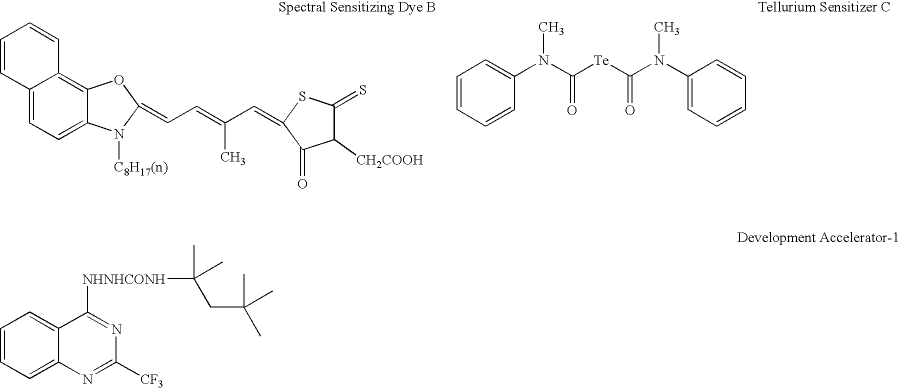
<Exposure and Photographic Processing>

Photographic materials were exposed employing. FUJI MEDICAL DRY LASER IMAGER FM-DP L (carrying a 660 nm semiconductor laser at a maximum output of 60 mW (IIIB). After exposure, the exposed materials were subjected to heat development (for a total of 24 seconds, which was a standard duration, employing four panel heaters set at 112° C.-119° C.-121° C.-121° C.), employing a modified FM-DPL in which the heat development section unit had been modified).

<Performance Evaluation>

Images prepared as above were evaluated as follows.

<<Photographic Speed, Fog, and Maximum Density>>

Density of each image was determined employing Macbeth densitometer (TD-904), and a characteristic curve was prepared in which the abscissa represented the exposure amount and the ordinate represented image density. The Reciprocal of the ratio of the exposure amount, which was required to result in a density which was 1.0 higher than the unexposed portion, was defined as photographic speed. Further, minimum density (fog) and maximum density were determined. The photographic speed was represented by a relative value when the photographic speed of Sample 201 was 100.

<<Tone>>

Tone of each image was observed and a 5-rank evaluation was performed based on the criteria below. In terms of commercial viability, rank 4 or higher is preferred.

5: tone was blue-black and no redness was noted

4: tone was not blue-black, but redness was barely noted

3: partial redness was slightly noted

2: wholly, redness was slightly noted

1: on first-viewing, redness was noted

<<Image Retention Property>>

In the same manner as Example 1, the image density variation ratio of the minimum density portion and the maximum density portion of each of the resulting images were determined and image retention-property was evaluated.

<<Image Retention Property of Minimum Density Portion>>

Each sample, which had been subjected to heat development employing the same method which was applied to the determination method of the above photographic speed, fog, and maximum density, was arranged in an ambience of 45° C. and 55 percent relative humidity so that a commercially available fluorescent lamp resulted in an illuminance on the sample surface of 500 lux, and such exposure was continued for three days. Minimum density (D₂) of the sample which had been exposed to the fluorescent lamp and minimum density (D₁) of the sample which had not been exposed to the fluorescent lamp were determined respectively, and a minimum density variation ratio (in percent) was calculated based on the formula below. The resulting values were employed as a scale of image retention property. As the numerical value approached 100, the image retention property was improved.
Minimum density variation ratio=D₂/D₁×100 (in percent)
<<Image Retention Property of Maximum Density Portion>>

Each sample, which had been subjected to heat development employing the same method which was applied to the determination of the minimum density variation ratio was allowed to stand at an ambience of 25° C. and 45° C. for three days. Thereafter, each of the maximum densities was determined, and the image density variation ratio was determined based on the formula below. The resulting values were employed as a scale of image retention property. The value approaching 100 means that the image retention property is improved.
Image density variation ratio=maximum density after storage at 45° C./maximum density after storage at 25° C.×100 (percent)

Table 1 shows the results.

TABLE 2

| | | | | | | | | Image Retention | | |
|---|---|---|---|---|---|---|---|---|---|---|
| Sample | Reducing | Leuco Dye | | | Maximum | Minimum | | Property | | |
| No. | Agent | (CL) | *3 | *4 | Density | Density | Tone | *5 | *6 | Tone Change |
| 201 *1 | 1-3 | — | — | 100 | 100 | 0.25 | 2 | 80 | 125 | 1 |
| 202 *1 | 1-3 | Comparison A | 0.04 | 99 | 105 | 0.35 | 2 | 80 | 145 | 2 |
| 203 *1 | 1-5 | Comparison B | 0.05 | 98 | 102 | 0.38 | 4 | 85 | 158 | 3 |
| 204 *1 | Comparison a | 1 | 0.03 | 100 | 102 | 0.22 | 4 | 85 | 162 | 2 |
| 205 *2 | 1-1 | 1 | 0.02 | 113 | 100 | 0.15 | 5 | 100 | 125 | 5 |
| 206 *2 | 1-1 | 3 | 0.03 | 105 | 102 | 0.17 | 5 | 98 | 125 | 5 |
| 207 *2 | 1-1 | 5 | 0.03 | 110 | 101 | 0.15 | 5 | 97 | 120 | 5 |
| 208 *2 | 1-3 | 1 | 0.04 | 108 | 100 | 0.16 | 5 | 96 | 130 | 5 |
| 209 *2 | 1-3 | 3 | 0.04 | 105 | 102 | 0.17 | 5 | 96 | 125 | 5 |
| 210 *2 | 1-3 | 5 | 0.05 | 112 | 102 | 0.17 | 5 | 97 | 138 | 5 |
| 211 *2 | 1-5 | 1 | 0.06 | 115 | 101 | 0.16 | 5 | 95 | 125 | 5 |
| 212 *2 | 1-5 | 12 | 0.08 | 105 | 102 | 0.16 | 5 | 94 | 135 | 5 |
| 213 *2 | 1-5 | 27 | 0.20 | 110 | 110 | 0.19 | 5 | 99 | 145 | 4 |
| 214 *2 | 1-17 | 5 | 0.01 | 115 | 100 | 0.18 | 5 | 97 | 135 | 5 |
| 215 *2 | 1-18 | 1 | 0.01 | 108 | 102 | 0.17 | 5 | 98 | 130 | 5 |

*1: (Comparative Example),
*2: (Present Invention),
*3: CL/Reducing Agent (mol ratio),
*4: Photographic Speed,
*5: Image Density Variation Ratio,
*6: Minimum Density Variation Ratio

As is seen from Table 2, Samples according the present invention resulted in higher photographic speed, lower fog and desired tone compared to the Comparative Examples. Further, image retention property of the Samples of the present invention was found to be much superior to the comparative Examples.

What is claimed is:

1. A photothermographic materials,
comprising a support having thereon an image forming layer comprising:
light-insensitive organic silver salt grains;
photosensitive silver halide grains;
a binder;
a reducing agent for silver ions represented by Formula (1); and
a leuco dye represented by Formula (2): 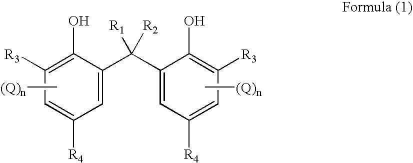
wherein R₁ and R₂ each respectively represents a hydrogen atom, an aliphatic group or an aryl group; R₃ and R₄ each respectively represents a hydrogen atom, an aliphatic group, an aryl group or a heterocylic group; Q represents a group capable of substituting a hydrogen atom on a benzene ring; and n represents an integer of 0 to 2, provided that when n is 2, a plurality of Q may be the same or different, 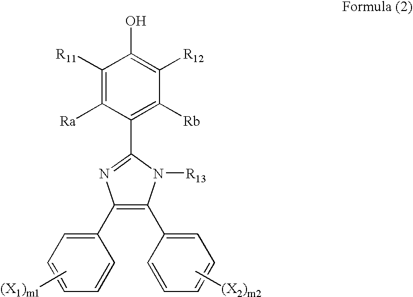
wherein R₁₁, R₁₂, Ra and Rb each respectively represents a hydrogen atom, an aliphatic group, an aryl group, an alkoxy group, an aryloxy group, an acylamino group, a sulfonamide group, a carbamoyl group or a halogen atom; R₁₃ represents a hydrogen atom, an aliphatic group, an aryl group, an acyl group, an alkoxycarbonyl group, an aryloxycarbonyl group, a carbamoyl group, a sulfamoyl group or a sulfonyl group; X₁ and X₂ each represents a group capable of substituting a hydrogen atom on a benzene ring; m1 and m2 each respectively represents an integer of 0 to 5, provided that when m1 or m2 is 2 or more, a plurality of X₁ or X₂ each respectively may be the same or different.

2. The photothermographic materials of claim 1, wherein the leuco dye represented by Formula (2) is further represented by Formula (3): 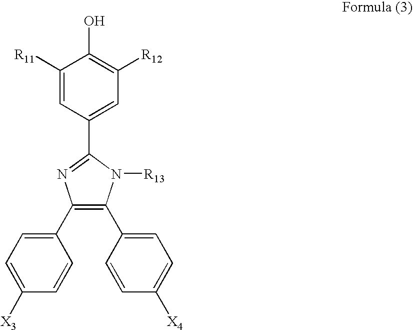
wherein X₃ and X₄ each respectively represents an aliphatic group, an aryl group, an amino group, an alkoxy group or an aryloxy group; and R₁₁, R₁₂ and R₁₃ each respectively represents the same as R₁₁, R₁₂ and R₁₃ in Formula (2).

3. The photothermographic materials of claim 1, wherein the leuco dye represented by Formula (2) is further represented by Formula (4): 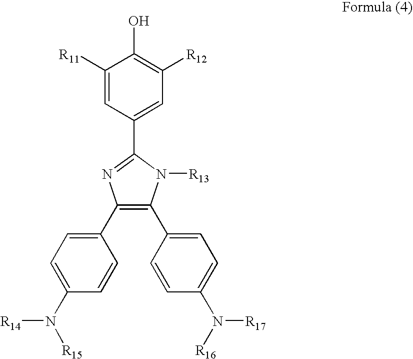
wherein R₁₄, R₁₅, R₁₆ and R₁₇ each respectively represents a hydrogen atom, an alkyl group; and R₁₂ and R₁₃ each respectively represents the same as R₁₁, R₁₂ and R₁₃ in Formula (2).

4. The photothermographic materials of claim 1, wherein R₁₁ and R₁₂ in Formula (2) each respectively represents an aliphatic group or an alkoxy group.

5. The photothermographic materials of claim 1, wherein a molar ratio of the leuco dye represented by Formula (2) to the reducing agent represented by Formula (1) is between 0.001:1 and 0.15:1.

6. The photothermographic materials of claim 5, wherein a molar ratio of the leuco dye represented by Formula (2) to the reducing agent represented by Formula (1) is between 0.005:1 and 0.1:1.

7. The photothermographic materials of claim 1, wherein R₃ in Formula (1) represents a secondary alkyl group or a tertiary alkyl group.

8. The photothermographic materials of claim 1, wherein R₄ in Formula (1) represents an alkyl group of 2 or more carbon atoms.

9. The photothermographic materials of claim 1, wherein the photosensitive silver halide grains contain silver iodide in an amount of 5 to 100 mol %.

10. The photothermographic materials of claim 1, wherein the light-insensitive organic silver salt grains contain silver behenate in an amount of not less than 70 to less than 100 weight % based on the total weight of the light-insensitive organic silver salt grains.
